(19) United States
(12) Patent Application Publication
(10) Pub. No.: US 2020/0348627 A1
(43) Pub. Date: Nov. 5, 2020

(54) Wrist-Worn Device with One or More Cameras and a Comfortable Arm Posture During Imaging

(71) Applicant: Robert A. Connor, St. Paul, MN (US)

(72) Inventor: Robert A. Connor, St. Paul, MN (US)

(73) Assignee: Medibotics LLC, St. Paul, MN (US)

(21) Appl. No.: 16/926,748

(22) Filed: Jul. 12, 2020

Related U.S. Application Data
(63) Continuation-in-part of application No. 15/431,769, filed on Feb. 14, 2017.
Application No. 15/431,769 is a continuation-in-part of application No. 15/206,215, filed on Jul. 8, 2016, now abandoned.
Application No. 15/206,215 is a continuation-in-part of application No. 14/330,649, filed on Jul. 14, 2014, now abandoned.
Application No. 15/206,215 is a continuation-in-part of application No. 14/948,308, filed on Nov. 21, 2015, now abandoned.
Application No. 14/948,308 is a continuation-in-part of application No. 13/901,099, filed on May 23, 2013, now Pat. No. 9,254,099.
Application No. 14/330,649 is a continuation-in-part of application No. 13/523,739, filed on Jun. 14, 2012, now Pat. No. 9,042,596.
(60) Provisional application No. 62/876,213, filed on Jul. 19, 2019.

(51) Int. Cl. G04G 9/00; H04N 5/225; H04N 5/247; G04B 47/06; G04G 21/08

(52) U.S. Cl. CPC G04G 9/007; H04N 5/2252; G04G 21/08; G04B 47/06; H04N 5/247

(57) ABSTRACT

This invention is a smart watch or other wrist-worn device with one or more cameras and a display which enables a person wearing the device to aim the focal direction of imaging while keeping with their arm in a comfortable, non-contorted configuration. The display can serve as a view finder for a camera. An arcuate array of cameras can be distributed around a portion of the circumference of the person's wrist and one camera from the array can be selected to record images from a particular angle at a particular time.

### CROSS-REFERENCE TO RELATED APPLICATIONS

This application claims the priority benefit of provisional application 62/876,213 “Incorporating One or More Cameras into a Wrist-Worn Device” filed on 2019 Jul. 19. This application is a continuation-in-part of U.S. patent application Ser. No. 15/431,769 “Wearable Technology for Non-Invasive Glucose Monitoring” filed on 2017 Feb. 14. U.S. patent application Ser. No. 15/431,769 was a continuation-in-part of application Ser. No. 15/206,215 “Finger Ring with Electromagnetic Energy Sensor for Monitoring Food Consumption” filed on 2016 Jul. 8. U.S. patent application Ser. No. 15/206,215 was a continuation-in-part of application Ser. No. 14/948,308 “Spectroscopic Finger Ring for Compositional Analysis of Food or Other Environmental Objects” filed on 2015 Nov. 21. U.S. patent application Ser. No. 14/948,308 was a continuation-in-part of application Ser. No. 13/901,099 “Smart Watch and Food-Imaging Member for Monitoring Food Consumption” filed on 2013 May 23 which issued as U.S. Pat. No. 9,254,099 on 2016 Feb. 9. U.S. patent application Ser. No. 15/431,769 was a continuation-in-part of application Ser. No. 14/330,649 “Eyewear System for Monitoring and Modifying Nutritional Intake” filed on 2014 Jul. 14. U.S. patent application Ser. No. 14/330,649 was a continuation-in-part of application Ser. No. 13/523,739 “The Willpower Watch[TM]: A Wearable Food Consumption Monitor” filed on 2012 Jun. 14 which issued as U.S. Pat. No. 9,042,596 on 2015 May 26. The entire contents of these related applications are incorporated herein by reference.

### FEDERALLY SPONSORED RESEARCH

Not Applicable

### SEQUENCE LISTING OR PROGRAM

Not Applicable

### BACKGROUND

### Field of Invention

This invention relates to wrist-worn devices with cameras.

### INTRODUCTION

There are many potential applications for incorporating one or more cameras into a wrist-worn device such as a smart watch, watch band, wrist band, sleeve, or cuff. For example, a wrist-worn camera can record images of food in a relatively subtle manner to help a person monitor their nutritional intake. As another example, a wrist-worn camera can record images during activities (such as sports or driving) in which it can be cumbersome or dangerous for a person to hold a mobile imaging device such as a cellphone or camera in their hands. In the years to come, wearable computing devices may largely replace handheld computing devices for most communication and connectivity applications. In this case, good designs for incorporating one or more cameras in a wrist-worn device will be clearly required.

However, there are design challenges which must be addressed in order to incorporate a camera in a wrist-worn device. Many of these design challenges were not issues for handheld imaging devices such as cellphones and handheld cameras. For example, since a wrist-worn device is actually attached to a person's body, a person has less freedom to move the device to different locations and to position the device at different angles as compared to handheld devices such as cellphones and handheld cameras. A person can easily hold a cellphone up and tilt it at different angles to point it at desired objects in their environment. However, there are anatomic limits to how a person can move their arm and wrist. Continually raising and twisting one's arm to take pictures at different angles would get old quickly. Also, a wrist-worn device is that relatively flat against a person's wrist may be good for avoiding snagging it on external objects, but may not provide a good device location from which to take pictures. This disclosure describes novel designs for a smart watch, watch band, or other wrist-worn device which can help to solve of many of the design challenges which arise when trying to incorporate one or more cameras into wrist-worn devices.

### REVIEW OF THE RELEVANT ART

U.S. Pat. No. 8,725,842 (Al-Nasser, May 13, 2014, “Smart Watch”) discloses a wrist-worn device with a display and an image capturing device. U.S. Pat. No. 9,740,906 (Al-Nasser et al., Aug. 22, 2017, “Wearable Device”) discloses a wrist-worn device with a display and a barcode reader or radio frequency identification (RFID) component. U.S. Patent Application Publication 20180020193 (Blum et al., Jan. 18, 2018, “Wearable Band”) discloses a wearable band with a camera, a base plate with a channel, a member which is rotatably coupled with the band, and a base coupling member attached to the camera assembly which engages the channel.

U.S. Patent Application Publication 20130163390 (Gossweiler et al., Jun. 27, 2013, “Smart-Watch Including Flip Up Display”) and U.S. Pat. No. 8,279,716 (Gossweiler et al., Oct. 2, 2012, “Smart-Watch Including Flip Up Display”), U.S. Pat. No. 8,379,488 (Gossweiler et al., Feb. 19, 2013, “Smart-Watch Including Flip Up Display”), and U.S. Pat. No. 8,902,714 (Gossweiler et al., Dec. 2, 2014, “Smart-Watch Including Flip Up Display”) disclose a smart-watch with a band, a base, a flip up portion, and a camera, wherein the flip up portion is a viewfinder for the camera. U.S. Patent Application Publication 20170188668 (Watterson et al., Jul. 6, 2017, “Smart Watch Band”) discloses a wrist band with a display and at least one replaceable module on the band.

U.S. Pat. No. 8,994,827 (Mistry et al., Mar. 31, 2015, “Wearable Electronic Device”) and U.S. Pat. No. 9,030,446 (Mistry et al., May 12, 2015, “Placement of Optical Sensor on Wearable Electronic Device”) disclose a device body with a display, a band, and an optical sensor in or on the band. U.S. Pat. No. 9,477,313 (Mistry et al., Oct. 25, 2016, “User Gesture Input to Wearable Electronic Device Involving Outward-Facing Sensor of Device”) discloses a wearable apparatus with a gesture recognizing sensor. U.S. patent Ser. No. 10/331,083 (Ness et al., Jun. 25, 2019, “Watch Band with Optical Sensor”) discloses a camera optical sensor at a distal end portion of a camera watch band that attaches to a user's wrist. U.S. Patent Application Publication 20180364557 (Park et al., Dec. 20, 2018, “Smart Watch and Method for Controlling Same”) discloses a smart watch with a camera which can be moved so as to be precisely oriented to a subject.

U.S. Patent Application Publication 20200073336 (Seo et al., Mar. 5, 2020, “Electronic Device for Controlling Watch Face of Smart Watch and Operation Method Therefor”) discloses an electronic device with a camera module, a communication module for communicating with a second electronic device, and a processor for photographing a first screen displayed on a display of the second electronic device. U.S. Patent Application Publication 20200012324 (Sung et al., Jan. 9, 2020, “Electronic Device and Method for Changing Location of Preview Image According to Direction of Camera”) discloses an electronic device with a first housing including a first face and a second face, a second housing including a third face and a fourth face, a folding part rotatably connecting the first housing and the second housing.

### SUMMARY OF THE INVENTION

This invention is an innovative smart watch, watch band, or other wrist-worn device with one or more cameras and a display which enables a person to direct the focal direction of imaging while keeping their arm in a comfortable (non-contorted) configuration. The display of the device can serve as a view finder for the one or more cameras. In an example, the device can have a camera at a fixed location (such as the 3 o'clock location or the 6 o'clock location) on the circumference of the person's wrist. Clock locations around a person's wrist are defined relative to the 12 o'clock location being at the middle of the dorsal side and the 6 o'clock location being at the middle of the ventral side (as viewed from a finger-to-elbow perspective).

In another example, a smart watch, watch band, or other wrist-worn device can comprise an arcuate array of cameras which is distributed around (at least a portion of) the circumference the device and the person's wrist, wherein a particular camera in the array is selected to record images from a particular angle at a particular time. This enables images to be recorded from different angles—independently from the orientation of the device. In another example, the device can comprise a camera which can be moved around (at least a portion of) the circumference of the device and the person's wrist. This also enables images to be recorded from different angles—independently from the orientation of the device. These designs enable a person to control the focal direction of imaging while keeping with their arm in a comfortable (non-contorted) configuration.

### BRIEF DESCRIPTION OF THE FIGURES

FIG. 1 shows a wrist-worn device with a display at the 12 o'clock location and a camera at the 3 o'clock location on a wrist.

FIG. 2 shows a wrist-worn device with a display at the 12 o'clock location and a camera at the 6 o'clock location on a wrist.

FIGS. 3 and 4 show sequential views of a wrist-worn device with a display and an arcuate array of cameras around at least a portion of a circumference of a wrist, wherein a particular camera in the array is selected to record images at a given time.

FIGS. 5 and 6 show sequential views of a wrist-worn device with a display and a camera which is moved around at least a portion of the circumference of a wrist in order to capture images from different angles.

### DETAILED DESCRIPTION OF THE FIGURES

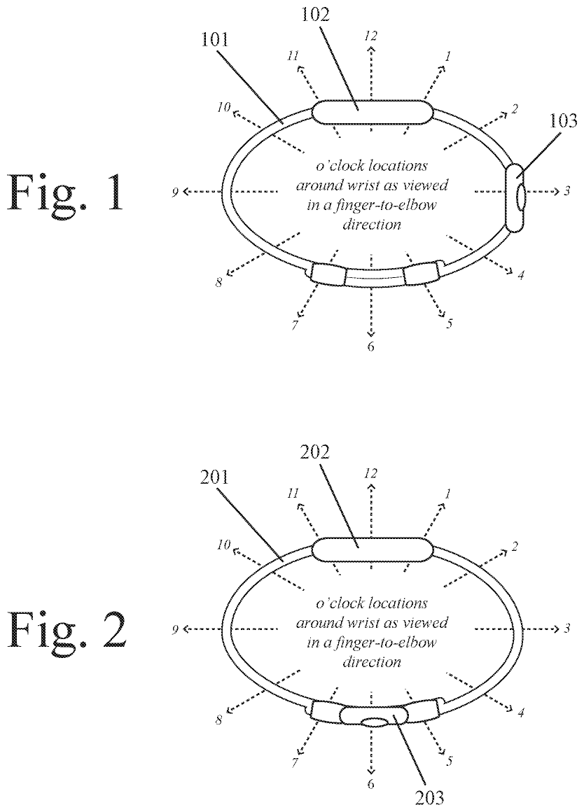

FIGS. 1 and 2 show side views (viewed from a finger-to-elbow perspective) of two examples of a smart watch, watch band, or other wrist-worn device with a camera comprising: (a) a display which is centered on the 12 o'clock location of a person's wrist, wherein clock locations around the person's wrist are defined relative to 12 o'clock being at the middle of the dorsal side and 6 o'clock being at the middle of the ventral side as viewed in a finger-to-elbow direction; and (b) an outward-facing camera on a location other than the 12 o'clock location. In addition to showing components of the physical device, these figures also show virtual o'clock locations (with dotted lines and italicized numbers) around the person's wrist (as viewed from a finger-to-elbow perspective). These virtual o'clock locations are useful for specifying the locations of device components in different embodiments of this invention.

FIG. 1 shows a side view (viewed from a finger-to-elbow perspective) of an example of a smart watch, watch band, or other wrist-worn device with a camera comprising: (a) a display which is centered on the 12 o'clock location on a person's wrist, wherein clock locations around the person's wrist are defined relative to 12 o'clock being at the middle of the dorsal side and 6 o'clock being at the middle of the ventral side as viewed in a finger-to-elbow direction; and (b) an outward-facing camera which is centered on the 3 o'clock location on the person's wrist. Specifically, FIG. 1 shows: wrist-worn band 101; display 102 which is centered on the 12 o'clock location on a person's wrist; and outward-facing camera 103 which is centered on the 3 o'clock location on the person's wrist. In an example, images viewed by the camera can be shown on the display so that the display acts a “view finder” for the camera. In another example, images viewed by the camera can be shown on a cell phone with which the device is in wireless communication. In variations on this example, a camera can be located anywhere between the 2 o'clock and 4 o'clock locations on the person's wrist. In other variations on this example, a display can be located between the 8 o'clock and 10 o'clock locations on the person's wrist.

In this example, the focal direction of the camera is outward and perpendicular to the circumference of the device. In an example, the focal direction of the camera from this location can be changed by the person via a mechanism selected from the group consisting of: a touch screen (e.g. touching and/or swiping a touch-screen on the display); a motion sensor (e.g. a motion sensor which recognizes the orientation of the device and/or changes in this orientation); a gesture recognition sensor (e.g. an optical, electromagnetic radiation, or motion sensor which recognizes hand gestures); a rotating bezel or ring (e.g. a bezel which is rotated around a circular display); a rotating knob (e.g. a rotating knob which is perpendicular to the display surface); and voice command recognition (e.g. recognition of vocal commands recorded by a microphone).

In an example, the focal direction of the camera from a given location can be automatically adjusted to maintain focal direction toward an object in the camera's field of view. In an example, images from the camera can be analyzed by pattern recognition to recognize an object in the camera's field of view and to maintain a stabilized direct focal direction toward that object. In an example, a stabilized direct line of sight to an object in the camera's field of view can be maintained by adjusting the focal direction of the camera to compensate for motion of the device.

A smart watch, watch band, or other wrist-worn device with a display on the dorsal surface of the person's wrist and a camera on the distal lateral side of the person's wrist such as the one shown in FIG. 1 can enable the person wearing it to see forward-facing camera images in the display while their wrist is held below their eyes with the dorsal surface of the wrist facing upwards. This is a convenient wrist posture from which to record forward-facing images. This wrist posture enables the person's hand to be held close to their body as they record images, which can be especially useful in crowded or high-visibility situations. Relevant design variations discussed elsewhere in this or priority-linked disclosures can also be applied to this example.

FIG. 2 shows a side view (viewed from a finger-to-elbow perspective) of an example of a smart watch, watch band, or other wrist-worn device with a camera comprising: (a) a display which is centered on the 12 o'clock location on a person's wrist, wherein clock locations around the person's wrist are defined relative to 12 o'clock being at the middle of the dorsal side and 6 o'clock being at the middle of the ventral side as viewed in a finger-to-elbow direction; and (b) an outward-facing camera which is centered on the 6 o'clock location on the person's wrist. Specifically, FIG. 2 shows: wrist-worn band 201; display 202 which is centered on the 12 o'clock location on a person's wrist; and outward-facing camera 203 which is centered on the 6 o'clock location on the person's wrist. In an example, images viewed by the camera can be shown on the display so that the display acts a “view finder” for the camera. In another example, images viewed by the camera can be shown on a cell phone with which the device is in wireless communication. In variations on this example, a camera can be located anywhere between the 5 o'clock and 7 o'clock locations on the person's wrist. In other variations on this example, a display can be located between the 8 o'clock and 10 o'clock locations on the person's wrist.

In this example, the focal direction of the camera is outward and perpendicular to the circumference of the device. In an example, the focal direction of the camera from this location can be changed by the person via a mechanism selected from the group consisting of: a touch screen (e.g. touching and/or swiping a touch-screen on the display); a motion sensor (e.g. a motion sensor which recognizes the orientation of the device and/or changes in this orientation); a gesture recognition sensor (e.g. an optical, electromagnetic radiation, or motion sensor which recognizes hand gestures); a rotating bezel or ring (e.g. a bezel which is rotated around a circular display); a rotating knob (e.g. a rotating knob which is perpendicular to the display surface); and voice command recognition (e.g. recognition of vocal commands recorded by a microphone).

In an example, the focal direction of the camera from a give location can be automatically adjusted to maintain focal direction toward an object in the camera's field of view. In an example, images from the camera can be analyzed by pattern recognition to recognize an object in the camera's field of view and to maintain a stabilized direct focal direction toward that object. In an example, a stabilized direct line of sight to an object in the camera's field of view can be maintained by adjusting the focal direction of the camera to compensate for motion of the device. In an example, the selection of a particular camera in a circumferential array of cameras can be automatically changed to maintain focal direction toward an object in the camera's field of view.

A smart watch, watch band, or other wrist-worn device with a display on the dorsal surface of the person's wrist and a camera on the ventral surface of the person's wrist such as the one shown in FIG. 2 enables the person wearing it to see forward-facing camera images in the display while their wrist is held in front of their eyes with the dorsal surface of the wrist facing toward their eyes. This is a convenient wrist posture from which to record forward-facing images. This wrist posture is similar to the traditional wrist posture of taking pictures with a handheld camera and virtually enables the person to point the camera as if they were “looking right through their wrist.” Relevant design variations discussed elsewhere in this or priority-linked disclosures can also be applied to this example.

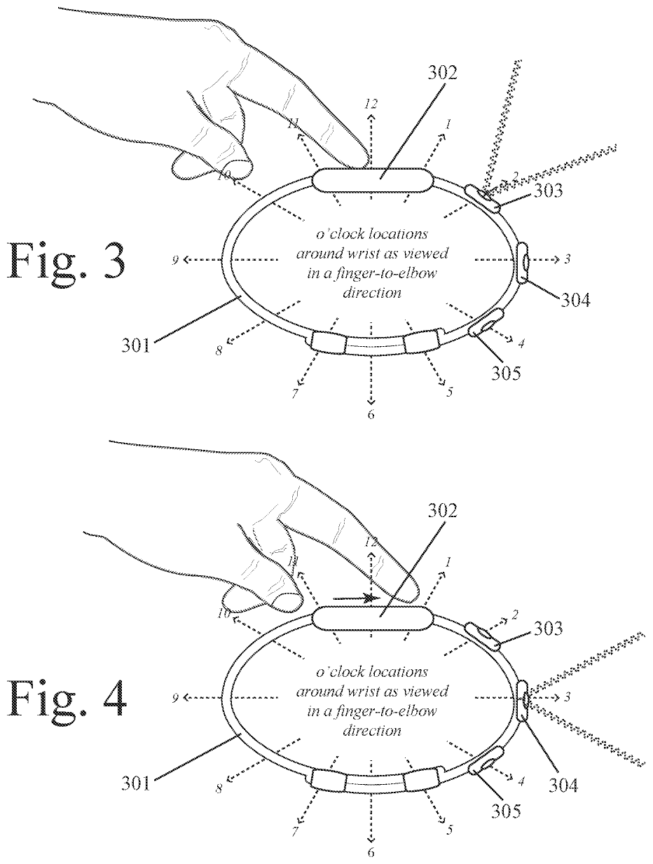

FIGS. 3 and 4 show two sequential side views (viewed from a finger-to-elbow perspective) of a smart watch, watch band, or other wrist-worn device with a camera comprising: (a) a display which is configured to be worn on a person's wrist; (b) a band which is configured to be worn on the person's wrist; and (c) an arcuate array of cameras which are distributed around at least a portion of a circumference of the band, wherein the arcuate array of cameras collectively spans at least 25% of the circumference of the person's wrist, and wherein a particular camera in the array is selected by the person to record images at a given time. Specifically, FIGS. 3 and 4 show: wrist-worn band 301; touch-screen display 202 which is centered on the 12 o'clock location on a person's wrist; and an arcuate array of outward-facing cameras (including cameras 303, 304, and 305) which are distributed around at least 25% of a circumference of the band.

FIG. 3 shows this device at a first point in time, wherein camera 303 has been selected by the person via touching and/or swiping the display in a first manner (or on a first display location) to record images (at a first angle) from a first location on the circumference of the device. In this example, selected camera 303 is located at the 2 o'clock location on the circumference of the device. FIG. 4 shows this device at a second point in time wherein camera 304 has been selected by the person by touching and/or swiping the display in a second manner (or on a second display location) to record images (at a second angle) from a second location on the circumference of the device.

In this example, camera 304 is located at the 3 o'clock location on the circumference of the device. In this example, the arcuate array of cameras is distributed along the distal lateral side of the circumference of the device. In this example, the arcuate array of cameras is distributed between (and including) the 2 o'clock location and the 4 o'clock location. In this example, the arcuate array of cameras collectively spans approximately 25% of the circumference of the person's wrist. In this example, the arcuate array of cameras comprises three cameras. In this example, cameras in the arcuate array of cameras are located at the 2 o'clock, 3 o'clock, and 4 o'clock locations. In this example, the cameras are evenly-distributed around a portion of the circumference of the device (and the person's wrist), with equal distances between cameras.

A smart watch, watch band, or other wrist-worn device with a display on the dorsal surface of the person's wrist and an arcuate array of selectable cameras around a portion of the circumference of the person's wrist enables the person to record images from a variety of focal angles. This gives the person flexibility to record images while having their arm in a comfortable configuration for extended periods of time. It also enables the person to record images from a variety of possible angles without having to contort their arm in an awkward manner.

In the example shown in FIGS. 3 and 4, a person selects a particular camera to record images at a given time by touching and/or swiping a touch-screen display in a particular manner or on a particular display location. In an example, moving a finger clockwise on a touch screen can change the selected camera around the circumference of the device. In an example, swiping a finger along a touch screen can change the selected camera around the circumference of the device. In variations on this example, a particular camera in the arcuate array of cameras can be selected by the person at a given time via a mechanism selected from the group consisting of: a touch screen (e.g. touching and/or swiping a touch-screen on the display); a motion sensor (e.g. a motion sensor which recognizes the orientation of the device and/or changes in this orientation); a gesture recognition sensor (e.g. an optical, electromagnetic radiation, or motion sensor which recognizes hand gestures); a rotating bezel or ring (e.g. a bezel which is rotated around a circular display); a rotating knob (e.g. a rotating knob which is perpendicular to the display surface); and voice command recognition (e.g. recognition of vocal commands recorded by a microphone).

In an example, a device can further comprise a motion sensor and selection of a camera can be controlled by the person moving the band (which is detected by the motion sensor). For example, a different camera around the circumference of the device can be selected when the person rotates their wrist in three-dimensional space. In another example, the device can further comprise a gesture sensor and selection of a camera can be controlled by the person making a gesture (which is detected by the gesture sensor). In another example, a device can further comprise a ring or bezel and selection of a camera can be controlled by the person rotating the ring or bezel. For example, rotating a ring or bezel around a circular display can change the selection of a camera from among an array of cameras around the circumference of the device. Alternatively, turning a knob on the side of a display can change the selection of camera from among an array of cameras around the circumference of the device.

In a variation on this example, an arcuate array of cameras can be distributed between the 1 o'clock location and the 5 o'clock location. In a variation on this example, an arcuate array of cameras can be distributed between the 12 o'clock location and the 6 o'clock location. In a variation on this example, an arcuate array of cameras can collectively span approximately one-third of the circumference of the person's wrist. In a variation on this example, an arcuate array of cameras can collectively span approximately half of the circumference of the person's wrist. In an example, an arcuate array of cameras span between 25% and 50% of the circumference of a person's wrist. In an example, an arcuate array of cameras span between 50% and 75% of the circumference of a person's wrist. In an example, an arcuate array of cameras can comprise four cameras. In an example, an arcuate array of cameras can comprise five or six cameras. In an example, an arcuate array of camera can comprise more than six cameras.

In an example, an arcuate array of cameras can be a circumferential or semi-circumferential array of cameras around the circumference of the band (and a person's wrist). In an example, cameras can be located at different locations around the circumference of the band (and a person's wrist). In an example, an arcuate array of cameras can comprise at least three cameras at three different locations, respectively, around the circumference of the band. In an example, cameras can be evenly distributed around at least a portion of the circumference of the band. Relevant design variations discussed elsewhere in this or priority-linked disclosures can also be applied to this example.

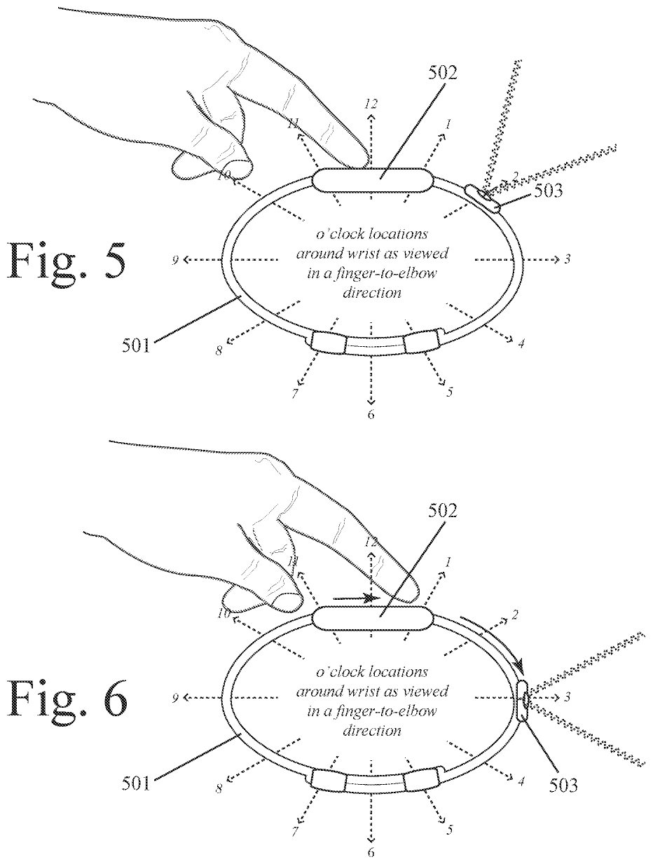

FIGS. 5 and 6 show two sequential side views (viewed from a finger-to-elbow perspective) of a smart watch, watch band, or other wrist-worn device with a camera comprising: (a) a display which is configured to be worn on a person's wrist; (b) a band which is configured to be worn on the person's wrist; and (c) a camera which is moved around at least a portion of the circumference of the band in order to capture images from different angles. Specifically, FIGS. 5 and 6 show: wrist-worn band 501; touch-screen display 502 which is centered on the 12 o'clock location on a person's wrist; and camera 503 which is moved around the distal lateral portion (e.g. between the 12 o'clock and 6 o'clock locations) of the circumference of the band in order to capture images from different angles.

FIG. 5 shows this device at a first point in time, wherein camera 503 is at a first location (e.g. the 2 o'clock location) in order to record images (at a first angle) from that first location on the circumference of the device. FIG. 6 shows this device at a second point in time, wherein camera 503 has been automatically moved to a second location (e.g. the 3 o'clock location) selected by the person via touching and/or swiping the display in a second manner in order to record images (at a second angle) from that second location on the circumference of the device. In this example, the camera is automatically moved from a first location to a second location by an actuator. In a variation on this example, a camera can be manually moved directly by the person by moving the camera along a (central) channel or track along a portion of the circumference of the band. In another example, a camera can be attached to a (central) ring which is manually rotated around the band by the person, thereby changing the location of the camera on the circumference of the person's wrist.

A smart watch, watch band, or other wrist-worn device with a camera which moves around a portion of the circumference of the device (either automatically or manually) enables the person wearing it to record images from a variety of focal angles. This gives the person flexibility to record images while having their arm in a comfortable configuration for extended periods of time. It also enables the person to record images from a variety of possible angles without having to contort their arm in an awkward manner.

In the example shown in FIGS. 5 and 6, a person moves a camera by touching and/or swiping a touch-screen display. In an example, moving a finger on a touch screen can move a camera around the circumference of the device. In an example, swiping a finger along a touch screen can move a camera around the circumference of the device. In variations on this example, a camera can be moved around the circumference of the person's wrist via a mechanism selected from the group consisting of: a touch screen (e.g. touching and/or swiping a touch-screen on the display); a motion sensor (e.g. a motion sensor which recognizes the orientation of the device and/or changes in this orientation); a gesture recognition sensor (e.g. an optical, electromagnetic radiation, or motion sensor which recognizes hand gestures); a rotating bezel or ring (e.g. a bezel which is rotated around a circular display); a rotating knob (e.g. a rotating knob which is perpendicular to the display surface); and voice command recognition (e.g. recognition of vocal commands recorded by a microphone).

In an example, a device can further comprise a motion sensor and movement of a camera can be controlled by the person moving the band (which is detected by the motion sensor). For example, a camera can move when a person rotates their wrist in three-dimensional space. In another example, the device can further comprise a gesture sensor and movement of a camera can be controlled by the person making a gesture (which is detected by the gesture sensor). In another example, a device can further comprise a ring or bezel and movement of a camera can be controlled by the person rotating the ring or bezel. Alternatively, turning a knob on the side of a display can move a camera around the circumference of the device.

In a variation on this example, a camera can be moved between the 1 o'clock location and the 5 o'clock location. In a variation on this example, a camera can be moved between the 12 o'clock location and the 6 o'clock location. In a variation on this example, a camera can be moved around approximately one-third of the circumference of the person's wrist. In a variation on this example, a camera can be moved around approximately half of the circumference of the person's wrist. In an example, a camera can be moved around between 25% and 50% of the circumference of a person's wrist. In an example, a camera can be moved around between 50% and 75% of the circumference of a person's wrist.

In an example, a camera can be moved around at least 25% of the circumference of the band. In an example, a camera can be moved around at least 50% of the circumference of the band. In an example, a smart watch, watch band, or other wrist-worn device can comprise an actuator which automatically moves a camera around the band. In an example, a smart watch, watch band, or other wrist-worn device can comprise a ring which rotates around at least a portion of the circumference of the band, wherein the camera is on the ring. In an example, a smart watch, watch band, or other wrist-worn device can comprise a track or channel around at least a portion of the circumference of the band, wherein the camera is moved along the track or channel. In an example, a smart watch, watch band, or other wrist-worn device can comprise a circumferential array of outlets, plugs, snaps, and/or ports to which one or more cameras can be removably attached at different circumferential locations. Relevant design variations discussed elsewhere in this or priority-linked disclosures can also be applied to this example.

In an example, this invention can be embodied in a smart watch, watch band, or other wrist-worn device with a camera comprising: a band (or sleeve) which is configured to be worn on a person's left wrist; a display on the band (or sleeve); a motion and/or gesture sensor on the band (or sleeve); a camera on the band (or sleeve); and an actuator on the band, wherein the focal distance and/or focal direction of the camera is automatically changed by the actuator based on movement of the band which is detected by the motion and/or gesture sensor in order to optically track (e.g. maintain imaging of) the person's right hand. In an alternative example, a smart watch, watch band, or other wrist-worn device with a camera can comprise: a band (or sleeve) which is configured to be worn on a person's wrist; a detachable housing which can be reversibly detached from the band (or sleeve) by sliding, popping, or pulling the housing out of an opening in the band (or sleeve); and a camera on the detachable housing; wherein the camera is in wireless communication with the band (or sleeve) when the housing is detached from the band (or sleeve) so that the camera can be used to record images even when the housing is detached from the band (or sleeve).

In another embodiment of this invention, a smart watch, watch band, or other wrist-worn device with a camera can comprise: a band (or sleeve) which is configured to be worn on a person's wrist; a display on the band (or sleeve); a first camera with a first focal distance range; and a second (“zoom”) camera with a second focal distance range, wherein the second focal distance range is at least twice the first focal distance range. Alternatively, a smart watch, watch band, or other wrist-worn device with an adjustable camera can comprise: a band (or sleeve) which is configured to be worn on a person's wrist; a display on the band (or sleeve); a motion and/or gesture sensor on the band (or sleeve); a camera on the band (or sleeve); and an actuator on the band, wherein the focal distance and/or focal direction of the camera is automatically changed by the actuator based on movement of the band which is detected by the motion and/or gesture sensor in order to optically track (e.g. maintain imaging of) a selected object in the environment. In another example, a smart watch, watch band, or other wrist-worn device with a camera can comprise: a band (or sleeve) which is configured to be worn on a person's wrist; a display on the band (or sleeve); and an (outward-facing) camera with a wide-angle lens located on a lateral side (between the ventral side and the dorsal side) of the band (or sleeve).

In yet another example, a smart watch, watch band, or other wrist-worn device with a camera can comprise: a band (or sleeve) which is configured to be worn on a person's wrist; a display on the band (or sleeve); and an arcuate array of (outward-facing) cameras, wherein the cameras and the display collectively are evenly distributed around at least three-quarters of the circumference of the band (or sleeve). In another example, a smart watch, watch band, or other wrist-worn electronic device with a camera can comprise: a band (or sleeve) which is configured to be worn on a person's wrist; a display on the band (or sleeve); and an arcuate array of (outward-facing) cameras, wherein the cameras and the display collectively are evenly distributed around at least three-quarters of the circumference of the person's wrist. Alternatively, a smart watch, watch band, or other wrist-worn device with an adjustable camera can comprise: a band (or sleeve) which is configured to be worn on a person's wrist; a display which is centered at a first clock-hour location around the circumference of band (or sleeve); and a camera which is centered at a second clock-hour location around the circumference of band (or sleeve), wherein the first clock-hour location differs from the second clock-hour location by 6 hours.

In one embodiment, a smart watch, watch band, or other wrist-worn device with a camera can comprise: a band (or sleeve) which is configured to be worn on a person's wrist; a display which is centered at a first location on the circumference of band (or sleeve) with a first polar coordinate; a first camera which is centered at a second location on the circumference of band (or sleeve) with a second polar coordinate; and a second camera which is centered at a third location on the circumference of band (or sleeve) with a third polar coordinate; wherein the angle of the second polar coordinate differs from the angle of the first polar coordinate by 90 degrees, wherein the angle of the third polar coordinate differs from the angle of the first polar coordinate by 90 degrees, and wherein the angle of the third polar coordinate differs from the angle of the second coordinate by 180 degrees. For example, a smart watch, watch band, or other wrist-worn device with a camera can comprise: a band (or sleeve) which is configured to be worn on a person's wrist; a display which is centered at a first location on the circumference of band (or sleeve) with a first polar coordinate; a first camera which is centered at the first location; and a second camera which is centered at a second location on the circumference of band (or sleeve) with a second polar coordinate; wherein the angle of the second polar coordinate differs from the angle of the first polar coordinate by 45 degrees. In an alternative embodiment, a smart watch, watch band, or other wrist-worn device with a camera can comprise: a band (or sleeve) which is configured to be worn on a person's wrist; a display which is centered at a first location on the circumference of band (or sleeve) with a first polar coordinate; and a camera which is centered at a second location on the circumference of band (or sleeve) with a second polar coordinate, wherein the angle of the second polar coordinate differs from the angle of the first polar coordinate by 90 degrees.

In an example, a smart watch, watch band, or other wrist-worn electronic device with an adjustable camera can comprise: a band (or sleeve) which is configured to be worn on a person's wrist; a display which is centered at a first location on the circumference of band (or sleeve) with a first polar coordinate; and a camera which is centered at a second location on the circumference of band (or sleeve) with a second polar coordinate, wherein the angle of the second polar coordinate differs from the angle of the first polar coordinate by 180 degrees. Alternatively, a smart watch, watch band, or other wrist-worn device with a camera can comprise: a band (or sleeve) which is configured to be worn on a person's wrist; a display which is centered at a first location on the circumference of band (or sleeve) with a first polar coordinate; and a camera which is centered at a second location on the circumference of band (or sleeve) with a second polar coordinate, wherein the angle of the second polar coordinate differs from the angle of the first polar coordinate by 135 degrees. In another example, a smart watch, watch band, or other wrist-worn device with a camera can comprise: a band (or sleeve) which is configured to be worn on a person's wrist; a first camera which is centered at a first location on the circumference of band (or sleeve) with a first polar coordinate; a display which is centered at a second location on the circumference of band (or sleeve) with a second polar coordinate; and a second camera which is centered at a third location on the circumference of band (or sleeve) with a third polar coordinate; wherein the angle of the second polar coordinate differs from the angle of the first polar coordinate by 45 degrees, wherein the angle of the third polar coordinate differs from the angle of the second polar coordinate by 45 degrees, and wherein the angle of the third polar coordinate differs from the angle of the first coordinate by 90 degrees.

In an example, a smart watch, watch band, or other wrist-worn device with a camera can comprise: a band (or sleeve) which is configured to be worn on a person's wrist; a housing on the band (or sleeve) on the dorsal side of the person's wrist; a transparent convex component on the housing which extends outward from the person's wrist; and a camera on the housing under the transparent convex component, wherein the camera can be rotated and/or tilted relative to the housing in order to change the camera's focal direction. Alternatively, a smart watch, watch band, or other wrist-worn device with an adjustable camera can comprise: a band (or sleeve) which is configured to be worn on a person's wrist; a housing on the band (or sleeve) on the dorsal side of the person's wrist; a transparent dome on the housing which extends outward from the person's wrist; and a camera on the housing under the transparent dome, wherein the camera is automatically rotated and/or tilted relative to the housing by an actuator in order to change the camera's focal direction. In another example, a smart watch, watch band, or other wrist-worn electronic device with a camera can comprise: a band (or sleeve) which is configured to be worn on a person's wrist; a housing on the band (or sleeve) which extends between 2 mm and 1 cm outward from the band (or sleeve); a display on the housing; and a plurality of cameras distributed around the lateral (narrow) perimeter of the housing.

In one embodiment, a smart watch, watch band, or other wrist-worn device with a camera can comprise: a band (or sleeve) which is configured to be worn on a person's wrist; a housing on the band (or sleeve) which extends between 5 mm and 2 cm outward from the band (or sleeve); a display on the housing; and a plurality of cameras which are distributed around the lateral (narrow) perimeter of the housing, wherein central focal vectors of the cameras are parallel to vectors which are tangential to the circumference of the band (or sleeve). In another example, a smart watch, watch band, or other wrist-worn device with a camera can comprise: a band (or sleeve) which is configured to be worn on a person's wrist; a housing on the band (or sleeve) which extends outward from the band (or sleeve); a display on the housing; and at least four cameras evenly (e.g. equidistantly) distributed around the lateral (narrow) perimeter of the housing. Alternatively, a smart watch, watch band, or other wrist-worn device with an adjustable camera can comprise: a band (or sleeve) which is configured to be worn on a person's wrist; a housing on the band (or sleeve) which extends outward from the band (or sleeve); a display on the housing; and a plurality of cameras evenly (e.g. equidistantly) distributed around the lateral (narrow) perimeter of the housing, wherein the person selects one of the plurality of cameras for imaging at a given time by making a gesture which is recognized by the device.

In an example, a smart watch, watch band, or other wrist-worn device with a camera can comprise: a band (or sleeve) which is configured to be worn on a person's wrist; a housing on the band (or sleeve) which extends outward from the band (or sleeve); a display on the housing; and at least four cameras distributed around the lateral (narrow) perimeter of the housing. In an alternative embodiment, a smart watch, watch band, or other wrist-worn electronic device with a camera can comprise: a band (or sleeve) which is configured to be worn on a person's wrist; a housing on the band (or sleeve) which extends outward from the band (or sleeve); a display on the housing; and a plurality of cameras distributed around the lateral (narrow) perimeter of the housing, wherein the person selects one of the plurality of cameras for imaging at a given time by making a gesture which is recognized by the device. For example, a smart watch, watch band, or other wrist-worn device with a camera can comprise: a band (or sleeve) which is configured to be worn on a person's wrist; a housing on the band (or sleeve) which extends outward from the band (or sleeve); a display on the housing; and four cameras on the lateral (narrow) perimeter of the housing, wherein central focal vectors of the cameras are parallel to vectors which are tangential to the circumference of the band (or sleeve).

In yet another example, a smart watch, watch band, or other wrist-worn device with an adjustable camera can comprise: a band (or sleeve) which is configured to be worn on a person's wrist; a housing on the band (or sleeve) with a transparent convex surface (e.g. transparent dome) which extends outward from the band (or sleeve); a scanning camera on the housing under the transparent convex surface; and an actuator which rotates the scanning camera, wherein the focal direction of the scanning camera is automatically changed when an actuator rotates the scanning camera. In another example, a smart watch, watch band, or other wrist-worn device with a camera can comprise: a band (or sleeve) which is configured to be worn on a person's wrist; a housing on the band (or sleeve), wherein the housing further comprises a rotating turret, bezel, or ring; and a plurality of cameras on the lateral (narrow) perimeter of rotating turret, bezel, or ring. Alternatively, a smart watch, watch band, or other wrist-worn device with a camera can comprise: a band (or sleeve) which is configured to be worn on a person's wrist; a housing on the band (or sleeve), wherein the housing further comprises a rotating turret, bezel, or ring; and a plurality of cameras on the rotating turret, bezel, or ring.

In an example, a smart watch, watch band, or other wrist-worn electronic device with a camera can comprise: a band (or sleeve) which is configured to be worn on a person's wrist; a housing on the band (or sleeve), wherein the housing further comprises a turret, bezel, or ring which can be manually rotated; and at least one camera on the lateral (narrow) perimeter of the rotating turret, bezel, or ring; wherein the turret, bezel, or ring rotates in a plane which is substantially parallel to the closest plane which is tangential to the circumference of the band (or sleeve). In another example, a smart watch, watch band, or other wrist-worn device with an adjustable camera can comprise: a band (or sleeve) which is configured to be worn on a person's wrist; a housing on the band (or sleeve), wherein the housing further comprises a rotating turret; and at least one camera on the rotating turret. Alternatively, a smart watch, watch band, or other wrist-worn device with a camera can comprise: a band (or sleeve) which is configured to be worn on a person's wrist; a housing on the band (or sleeve); a camera on the housing; and a digital micromirror device, wherein the focal direction of the camera is changed by movement of digital micromirror device.

In one embodiment, a smart watch, watch band, or other wrist-worn device with a camera can comprise: a band (or sleeve) which is configured to be worn on a person's wrist; a housing on the band (or sleeve); a display on a first side of the housing; and a camera on a second side of the housing, wherein the second side is perpendicular to the first side. In another example, a smart watch, watch band, or other wrist-worn device with a camera can comprise: a band (or sleeve) which is configured to be worn on a person's wrist; a housing on the band (or sleeve); a flip-up or pop-up component on the housing; a display on a first side of the flip-up or pop-up component; and a camera on a second side of the flip-up or pop-up component, wherein the second side is perpendicular to the first side. Alternatively, a smart watch, watch band, or other wrist-worn electronic device with an adjustable camera can comprise: a band (or sleeve) which is configured to be worn on a person's wrist; a housing on the band (or sleeve); a flip-up or pop-up component on the housing; a display on a first side of the flip-up or pop-up component; and two cameras on a second side of the flip-up or pop-up component, wherein the second side is opposite the first side.

In an embodiment of this invention, a smart watch, watch band, or other wrist-worn device with a camera can comprise: a band (or sleeve) which is configured to be worn on a person's wrist; a housing on the band (or sleeve); a pop-up, flip-up, or tilt-up component on the housing with a first configuration in which the centroid of the pop-up, flip-up, or tilt-up component is a first distance from the surface of the person's wrist and a second configuration in which the centroid of the pop-up, flip-up, or tilt-up component is a second distance from the surface of the person's wrist, wherein the second distance is 2 mm to 4 cm greater than the first distance; a camera on the pop-up, flip-up, or tilt-up component; a motion and/or gesture sensor on the band (or sleeve); wherein the pop-up, flip-up, or tilt-up component is automatically moved from its first configuration to its second configuration when the person makes a selected motion and/or gesture as detected by the motion and/or gesture sensor. For example, a smart watch, watch band, or other wrist-worn device with a camera can comprise: a band (or sleeve) which is configured to be worn on a person's wrist; a housing on the band (or sleeve); a pop-up, flip-up, or tilt-up component on the housing with a first configuration in which the centroid of the pop-up, flip-up, or tilt-up component is a first distance from the side of the housing which is closest to the person's wrist and a second configuration in which the centroid of the pop-up, flip-up, or tilt-up component is a second distance from the side of the housing which is closest to the person's wrist, wherein the second distance is 2 mm to 4 cm greater than the first distance; a display on a first side of the pop-up, flip-up, or tilt-up component; a camera on a second side of the pop-up, flip-up, or tilt-up component; a motion and/or gesture sensor on the band (or sleeve); and an actuator on the band (or sleeve); wherein the pop-up, flip-up, or tilt-up component is automatically popped up, flipped up, or tilted up from its first configuration to its second configuration by the actuator when the person makes a selected motion and/or gesture as detected by the motion and/or gesture sensor.

In yet another example, a smart watch, watch band, or other wrist-worn device with a camera can comprise: a band (or sleeve) which is configured to be worn on a person's wrist; a housing on the band (or sleeve); a pop-up, flip-up, or tilt-up component on the housing with a first configuration in which the centroid of the pop-up, flip-up, or tilt-up component is a first distance from the side of the housing which is closest to the person's wrist and a second configuration in which the centroid of the pop-up, flip-up, or tilt-up component is a second distance from the side of the housing which is closest to the person's wrist, wherein the second distance is 2 mm to 4 cm greater than the first distance; a touch-screen display on a first side of the pop-up, flip-up, or tilt-up component; a first camera on the first side of the pop-up, flip-up, or tilt-up component; and a second camera on a second side of the pop-up, flip-up, or tilt-up component, wherein the second side is opposite the first side; wherein the pop-up, flip-up, or tilt-up component is automatically popped up, flipped up, or tilted up from its first configuration to its second configuration when the person makes a selected touch or swipe motion on the touch-screen display.

In an example, a smart watch, watch band, or other wrist-worn device with an adjustable camera can comprise: a band (or sleeve) which is configured to be worn on a person's wrist; a housing on the band (or sleeve); a pop-up, flip-up, or tilt-up component on the housing with a first configuration in which the centroid of the pop-up, flip-up, or tilt-up component is a first distance from the side of the housing which is closest to the person's wrist and a second configuration in which the centroid of the pop-up, flip-up, or tilt-up component is a second distance from the side of the housing which is closest to the person's wrist, wherein the second distance is 2 mm to 4 cm greater than the first distance; a display on a first side of the pop-up, flip-up, or tilt-up component; a camera on a second side of the pop-up, flip-up, or tilt-up component; and an infrared motion and/or gesture sensor on the band (or sleeve); wherein the pop-up, flip-up, or tilt-up component is automatically popped up, flipped up, or tilted up from its first configuration to its second configuration when the person makes a selected motion and/or gesture as detected by the infrared motion and/or gesture sensor. In an alternative embodiment, a smart watch, watch band, or other wrist-worn electronic device with a camera can comprise: a band (or sleeve) which is configured to be worn on a person's wrist; a housing on the band (or sleeve); a transparent closed-end cylinder on the housing which extends outward from the person's wrist; and a camera under the transparent closed-end cylinder, wherein the camera is automatically rotated and/or tilted relative to the housing by an actuator in order to change the camera's focal direction. Alternatively, a smart watch, watch band, or other wrist-worn device with a camera can comprise: a band (or sleeve) which is configured to be worn on a person's wrist; a housing on the band (or sleeve); a transparent convex component on the housing which extends outward from the person's wrist; and a camera under the transparent convex component, wherein the camera is automatically rotated and/or tilted relative to the housing by an actuator in order to change the camera's focal direction.

In an example, a smart watch, watch band, or other wrist-worn device with a camera can comprise: a band (or sleeve) which is configured to be worn on a person's wrist; a housing on the band (or sleeve); a transparent dome on the housing which extends outward from the person's wrist; and a camera on the housing under the transparent dome, wherein the camera is automatically rotated relative to the housing by an actuator in a plane which is substantially tangential to the circumference of the band (or sleeve) in order to change the camera's focal direction in order to change the camera's focal direction. Alternatively, a smart watch, watch band, or other wrist-worn device with an adjustable camera can comprise: a band (or sleeve) which is configured to be worn on a person's wrist; a housing on the band (or sleeve); a transparent dome on the housing which extends outward from the person's wrist; and a camera on the housing under the transparent dome, wherein the camera can be rotated and/or tilted relative to the housing in order to change the camera's focal direction. In another example, a smart watch, watch band, or other wrist-worn electronic device with a camera can comprise: a band (or sleeve) which is configured to be worn on a person's wrist; a housing on the band (or sleeve); a transparent prism on the housing which extends outward from the person's wrist; and a camera on the housing under the transparent prism, wherein the camera is automatically rotated and/or tilted relative to the housing by an actuator in order to change the camera's focal direction.

In one embodiment, a smart watch, watch band, or other wrist-worn device with a camera can comprise: a band (or sleeve) which is configured to be worn on a person's wrist; a housing on the band (or sleeve); and a camera which can be removed from the housing, wherein the camera remains connected to the housing by a flexible component (such as a wire, cord, or strap) even when the camera is removed from the housing, wherein the camera is in electronic (wired or wireless) communication with the housing even when it is removed from the housing so that the camera can be used to record images even when the camera is removed from the housing. In another example, a smart watch, watch band, or other wrist-worn electronic device with a camera can comprise: a band (or sleeve) which is configured to be worn on a person's wrist; a housing on the band (or sleeve); and a camera which can be reversibly detached from the housing by unplugging, unsnapping, or uncoupling the camera from the housing, wherein the camera is in wireless communication with the housing when it is detached from the housing so that the camera can be used to record images even when the camera is detached from the housing. Alternatively, a smart watch, watch band, or other wrist-worn device with an adjustable camera can comprise: a band (or sleeve) which is configured to be worn on a person's wrist; a housing on the dorsal side of the band (or sleeve); a display on a first side of the housing; and a camera on a second side of the housing, wherein the second side is perpendicular to the first side.

In an example, a smart watch, watch band, or other wrist-worn device with a camera can comprise: a band (or sleeve) which is configured to be worn on a person's wrist; a housing on the dorsal side of the band (or sleeve); a display on a side of the housing; and a camera on the same side of the housing as the display. In another example, a smart watch, watch band, or other wrist-worn device with a camera can comprise: a band (or sleeve) which is configured to be worn on a person's wrist; a housing on the dorsal side of the band (or sleeve); a flip-up or pop-up component on the housing; a display on a first side of the flip-up or pop-up component; a first camera on the first side of the flip-up or pop-up component; and a second camera on a second side of the flip-up or pop-up component, wherein the second side is opposite the first side. In an alternative embodiment, a smart watch, watch band, or other wrist-worn device with a camera can comprise: a band (or sleeve) which is configured to be worn on a person's wrist; a motion and/or gesture sensor on the band (or sleeve); and a plurality of (outward-facing) cameras which collectively span at least one quarter of the circumference of the person's wrist, wherein the person selects which one of the plurality of (outward-facing) cameras to use at a given time by making a movement or gesture.

In an example, a smart watch, watch band, or other wrist-worn device with an adjustable camera can comprise: a band (or sleeve) which is configured to be worn on a person's wrist; a motion and/or gesture sensor on the band (or sleeve); and an (outward-facing) camera on the band (or sleeve) with a first configuration in which the camera faces in a first direction and a second configuration in which the camera faces in a second direction, wherein the camera is automatically moved by an actuator from its first configuration to its second configuration based on data from the motion and/or gesture sensor. In another example, a smart watch, watch band, or other wrist-worn electronic device with a camera can comprise: a band (or sleeve) which is configured to be worn on a person's wrist; a motion and/or gesture sensor on the band (or sleeve); and an arcuate array of (outward-facing) cameras which are distributed around (at least a portion of) the circumference of the band (or sleeve), wherein the arcuate array of (outward-facing) cameras collectively spans at least 25% of the circumference of the person's wrist, wherein a camera in the array is selected by the person to record images at a given time, and wherein the selection of the camera is done by the person moving the band in a selected manner as detected by the motion and/or gesture sensor. For example, a smart watch, watch band, or other wrist-worn device with a camera can comprise: a band (or sleeve) which is configured to be worn on a person's wrist; a motion and/or gesture sensor on the band (or sleeve); and an arcuate array of (outward-facing) cameras which are evenly (e.g. equidistantly) distributed around (at least a portion of) the circumference of the band (or sleeve), wherein the arcuate array of (outward-facing) cameras collectively spans at least 25% of the circumference of the person's wrist, wherein a camera in the array is selected by the person to record images at a given time, and wherein the selection of the camera is done by the person moving the band in a selected manner as detected by the motion and/or gesture sensor.

In yet another example, a smart watch, watch band, or other wrist-worn electronic device with a camera can comprise: a band (or sleeve) which is configured to be worn on a person's wrist; a touch-screen display on the band (or sleeve); and a plurality of (outward-facing) cameras which collectively span at least one quarter of the circumference of the person's wrist, wherein the person selects which one of the plurality of (outward-facing) cameras to use at a given time by touching and/or swiping the display. Alternatively, a smart watch, watch band, or other wrist-worn device with an adjustable camera can comprise: a band (or sleeve) which is configured to be worn on a person's wrist; and a camera which can be reversibly detached from (and re-attached to) the band (or sleeve), wherein the camera is in wireless communication with the band (or sleeve) when it is detached from the band (or sleeve) so that the camera can be used to record images even when the camera is detached from the band (or sleeve). In another example, a smart watch, watch band, or other wrist-worn device with a camera can comprise: a band (or sleeve) which is configured to be worn on a person's wrist; and a plurality of (outward-facing) cameras distributed around at least one quarter of the circumference of the band (or sleeve), wherein angles between the polar coordinate locations of two proximal (e.g. adjacent) cameras are no greater than 30 degrees.

In an embodiment of this invention, a smart watch, watch band, or other wrist-worn device with a camera can comprise: a band (or sleeve) which is configured to be worn on a person's wrist; and a plurality of (outward-facing) cameras distributed around at least one quarter of the circumference of the person's wrist, wherein angles between the polar coordinate locations of two proximal (e.g. adjacent) cameras are no greater than 15 degrees. For example, a smart watch, watch band, or other wrist-worn device with a camera can comprise: a band (or sleeve) which is configured to be worn on a person's wrist; and a plurality of (outward-facing) cameras distributed around at least one half of the circumference of the person's wrist, wherein angles between the polar coordinate locations of two proximal (e.g. adjacent) cameras are no greater than 45 degrees. Alternatively, a smart watch, watch band, or other wrist-worn device with an adjustable camera can comprise: a band (or sleeve) which is configured to be worn on a person's wrist; and a plurality of (outward-facing) cameras evenly (e.g. equidistantly) distributed around at least one quarter of the circumference of the band (or sleeve), wherein angles between the polar coordinate locations of two proximal (e.g. adjacent) cameras are no greater than 30 degrees.

In one embodiment, a smart watch, watch band, or other wrist-worn electronic device with a camera can comprise: a band (or sleeve) which is configured to be worn on a person's wrist; and a plurality of (outward-facing) cameras evenly (e.g. equidistantly) distributed around at least one quarter of the circumference of the person's wrist, wherein angles between the polar coordinate locations of two proximal (e.g. adjacent) cameras are no greater than 15 degrees. Alternatively, a smart watch, watch band, or other wrist-worn device with an adjustable camera can comprise: a band (or sleeve) which is configured to be worn on a person's wrist; and a plurality of (outward-facing) cameras evenly (e.g. equidistantly) distributed around at least one half of the circumference of the person's wrist, wherein angles between the polar coordinate locations of two proximal (e.g. adjacent) cameras are no greater than 45 degrees. In an alternative embodiment, a smart watch, watch band, or other wrist-worn electronic device with a camera can comprise: a band (or sleeve) which is configured to be worn on a person's wrist, wherein the band (or sleeve) further comprises a circumferential array of connectors, ports, or sockets; and a plurality of (outward-facing) cameras which can be selectively and removably attached to any of the connectors, ports, or sockets in the array.

In an example, a smart watch, watch band, or other wrist-worn device with a camera can comprise: a band (or sleeve) which is configured to be worn on a person's wrist, wherein the band (or sleeve) further comprises an arcuate array of connectors, ports, or sockets which spans at least three-quarters of the circumference of the person's wrist; and a plurality of (outward-facing) cameras which can be selectively and removably attached to any of the connectors, ports, or sockets in the array. Alternatively, a smart watch, watch band, or other wrist-worn device with a camera can comprise: a band (or sleeve) which is configured to be worn on a person's wrist, wherein the band (or sleeve) further comprises an arcuate array of connectors, ports, or sockets which spans at least half of the circumference of the person's wrist; and a plurality of (outward-facing) cameras which can be selectively detached from and re-attached to any of the connectors, ports, or sockets in the array. In another example, a smart watch, watch band, or other wrist-worn device with an adjustable camera can comprise: a band (or sleeve) which is configured to be worn on a person's wrist; and a plurality of (outward-facing) cameras which collectively span at least half of the circumference of the band (or sleeve), wherein the person selects which one of the plurality of (outward-facing) cameras to use at a given time by making a movement or gesture.

In an example, a smart watch, watch band, or other wrist-worn device with a camera can comprise: a band (or sleeve) which is configured to be worn on a person's wrist; and an (outward-facing) camera on the band (or sleeve) with a first configuration in which the camera faces in a first direction and a second configuration in which the camera faces in a second direction, wherein the camera is automatically moved by an actuator from its first configuration to its second configuration. In another example, a smart watch, watch band, or other wrist-worn device with an adjustable camera can comprise: a band (or sleeve) which is configured to be worn on a person's wrist; and an (outward-facing) camera on the band (or sleeve), wherein the camera slides along a track or channel to different locations on the circumference of band (or sleeve). Alternatively, a smart watch, watch band, or other wrist-worn device with a camera can comprise: a band (or sleeve) which is configured to be worn on a person's wrist, wherein the band (or sleeve) further comprises a central (partial) ring and an outer (partial) ring, wherein the central (partial) ring is closer to the center of the band (or sleeve) than the outer (partial) ring, and wherein the central (partial) ring is rotated or slid relative to the outer (partial) ring; and an (outward-facing) camera on the central (partial) ring.

In yet another example, a smart watch, watch band, or other wrist-worn electronic device with an adjustable camera can comprise: a band (or sleeve) which is configured to be worn on a person's wrist, wherein the band (or sleeve) further comprises an inner (partial) ring and an outer (partial) ring, wherein the inner (partial) ring is closer to the person's wrist than the outer (partial) ring, and wherein the outer (partial) ring moves circumferentially relative to the inner (partial) ring; and an (outward-facing) camera on the outer (partial) ring. In another example, a smart watch, watch band, or other wrist-worn device with a camera can comprise: a band (or sleeve) which is configured to be worn on a person's wrist, wherein the band (or sleeve) further comprises a central (partial) ring and an outer (partial) ring, wherein the central (partial) ring is closer to the center of the band (or sleeve) than the outer (partial) ring, and wherein the outer (partial) ring is rotated or slid relative to the central (partial) ring; and an (outward-facing) camera on the outer (partial) ring. Alternatively, a smart watch, watch band, or other wrist-worn electronic device with a camera can comprise: a band (or sleeve) which is configured to be worn on a person's wrist, wherein the band (or sleeve) further comprises a first (partial) ring and a second (partial) ring, wherein the second (partial) ring rotates around at least a portion of the first (partial) ring; and an (outward-facing) camera on the second (partial) ring.

In an example, a smart watch, watch band, or other wrist-worn device with a camera can comprise: a band (or sleeve) which is configured to be worn on a person's wrist, wherein the band (or sleeve) further comprises a sliding portion and a stationary portion, wherein the sliding portion slides around at least part of the circumference of the stationary portion; and an (outward-facing) camera on the sliding portion. In an alternative embodiment, a smart watch, watch band, or other wrist-worn device with an adjustable camera can comprise: a band (or sleeve) which is configured to be worn on a person's wrist, wherein the band (or sleeve) further comprises a circumferential array of connectors, ports, or sockets; and an (outward-facing) camera which can be selectively and removably attached to any of the connectors, ports, or sockets in the array. In another example, a smart watch, watch band, or other wrist-worn device with a camera can comprise: a band (or sleeve) which is configured to be worn on a person's wrist, wherein the band (or sleeve) further comprises an arcuate array of connectors, ports, or sockets which spans at least three-quarters of the circumference of the person's wrist; and an (outward-facing) camera which can be selectively and removably attached to any of the connectors, ports, or sockets in the array.

In one embodiment, a smart watch, watch band, or other wrist-worn device with an adjustable camera can comprise: a band (or sleeve) which is configured to be worn on a person's wrist, wherein the band (or sleeve) further comprises a circumferential array of connectors, ports, or sockets; and an (outward-facing) camera which can be selectively detached from and re-attached to any of the connectors, ports, or sockets in the array. Alternatively, a smart watch, watch band, or other wrist-worn device with a camera can comprise: a band (or sleeve) which is configured to be worn on a person's wrist, wherein the band (or sleeve) further comprises an arcuate array of connectors, ports, or sockets which spans at least three-quarters of the circumference of the person's wrist; and an (outward-facing) camera which can be selectively detached from and re-attached to any of the connectors, ports, or sockets in the array. Alternatively, a smart watch, watch band, or other wrist-worn device with an adjustable camera can comprise: a band (or sleeve) which is configured to be worn on a person's wrist; and an (outward-facing) camera with a first configuration in which the camera is at a first location on the band (or sleeve) and a second configuration in which the camera is at a second location on the band (or sleeve), wherein the camera is automatically moved by an actuator from its first configuration to its second configuration.

In an example, a smart watch, watch band, or other wrist-worn electronic device with a camera can comprise: a band (or sleeve) which is configured to be worn on a person's wrist; and an arcuate array of (outward-facing) cameras distributed around (at least a portion of) the circumference of the band (or sleeve), collectively spanning at between 25% and 75% of the circumference of the person's wrist. For example, a smart watch, watch band, or other wrist-worn device with a camera can comprise: a band (or sleeve) which is configured to be worn on a person's wrist; and an arcuate array of (outward-facing) cameras distributed around (at least a portion of) the circumference of the band (or sleeve), collectively spanning at between 25% and 75% of the circumference of the band (or sleeve). Alternatively, a smart watch, watch band, or other wrist-worn electronic device with a camera can comprise: a band (or sleeve) which is configured to be worn on a person's wrist; and an arcuate array of (outward-facing) cameras distributed around (at least a portion of) the circumference of the band (or sleeve), collectively spanning at between 25% and 75% of the circumference of the person's wrist, including the distal lateral side of the person's wrist.

In an embodiment of this invention, a smart watch, watch band, or other wrist-worn device with an adjustable camera can comprise: a band (or sleeve) which is configured to be worn on a person's wrist; and an arcuate array of (outward-facing) cameras distributed around (at least a portion of) the circumference of the band (or sleeve), collectively spanning at between 25% and 75% of the circumference of the band (or sleeve), including the distal lateral side of the band (or sleeve). In an alternative embodiment, a smart watch, watch band, or other wrist-worn device with a camera can comprise: a band (or sleeve) which is configured to be worn on a person's wrist; and an arcuate array of (outward-facing) cameras evenly (e.g. equidistantly) distributed around (at least a portion of) the circumference of the band (or sleeve), collectively spanning at between 25% and 75% of the circumference of the person's wrist. In another example, a smart watch, watch band, or other wrist-worn device with an adjustable camera can comprise: a band (or sleeve) which is configured to be worn on a person's wrist; and an arcuate array of (outward-facing) cameras evenly (e.g. equidistantly) distributed around (at least a portion of) the circumference of the band (or sleeve), collectively spanning at between 25% and 75% of the circumference of the band (or sleeve).

In an example, a smart watch, watch band, or other wrist-worn device with a camera can comprise: a band (or sleeve) which is configured to be worn on a person's wrist; and an arcuate array of (outward-facing) cameras evenly (e.g. equidistantly) distributed around (at least a portion of) the circumference of the band (or sleeve), collectively spanning at between 25% and 75% of the circumference of the person's wrist, including the distal lateral side of the person's wrist. For example, a smart watch, watch band, or other wrist-worn device with an adjustable camera can comprise: a band (or sleeve) which is configured to be worn on a person's wrist; and an arcuate array of (outward-facing) cameras evenly (e.g. equidistantly) distributed around (at least a portion of) the circumference of the band (or sleeve), collectively spanning at between 25% and 75% of the circumference of the band (or sleeve), including the distal lateral side of the band (or sleeve). In another example, a smart watch, watch band, or other wrist-worn device with a camera can comprise: a band (or sleeve) which is configured to be worn on a person's wrist; and an arcuate array of (outward-facing) cameras evenly distributed around (at least a portion of) the circumference of the band (or sleeve), collectively spanning at between 25% and 100% of the circumference of the band (or sleeve), including the distal lateral side of the band (or sleeve).

In yet another example, a smart watch, watch band, or other wrist-worn electronic device with a camera can comprise: a band (or sleeve) which is configured to be worn on a person's wrist; and an arcuate array of (outward-facing) cameras evenly distributed around (at least a portion of) the circumference of the band (or sleeve), collectively spanning at between 25% and 50% of the circumference of the band (or sleeve), including the distal lateral side of the band (or sleeve). Alternatively, a smart watch, watch band, or other wrist-worn device with a camera can comprise: a band (or sleeve) which is configured to be worn on a person's wrist; and an arcuate array of (outward-facing) cameras evenly distributed around (at least a portion of) the circumference of the band (or sleeve), collectively spanning at between 25% and 75% of the circumference of the band (or sleeve), including the distal lateral side of the band (or sleeve). For example, a smart watch, watch band, or other wrist-worn electronic device with an adjustable camera can comprise: a band (or sleeve) which is configured to be worn on a person's wrist; and an arcuate array of (outward-facing) cameras evenly distributed around (at least a portion of) the circumference of the band (or sleeve), collectively spanning at least 25% of the circumference of the person's wrist.

In one embodiment, a smart watch, watch band, or other wrist-worn device with a camera can comprise: a band (or sleeve) which is configured to be worn on a person's wrist; and an arcuate array of (outward-facing) cameras which are centered at compass coordinate locations around (at least a portion of) the circumference of the band (or sleeve) and which collectively span at least one quarter of the circumference of the person's wrist. In another example, a smart watch, watch band, or other wrist-worn device with an adjustable camera can comprise: a band (or sleeve) which is configured to be worn on a person's wrist; and an arcuate array of (outward-facing) cameras which are centered at each clock-hour location around (at least a portion of) the circumference of the band (or sleeve) and which collectively span at least one quarter of the circumference of the person's wrist. Alternatively, a smart watch, watch band, or other wrist-worn device with a camera can comprise: a band (or sleeve) which is configured to be worn on a person's wrist; and an arcuate array of (outward-facing) cameras which are evenly distributed around (at least a portion of) the circumference of the band (or sleeve) and which collectively span at least 25% of the circumference of the person's wrist.

In an example, a smart watch, watch band, or other wrist-worn device with an adjustable camera can comprise: a band (or sleeve) which is configured to be worn on a person's wrist; and eight (outward-facing) cameras which are distributed around (at least a portion of) the circumference of the band (or sleeve) and which collectively span at least half of the circumference of the person's wrist. In another example, a smart watch, watch band, or other wrist-worn device with a camera can comprise: a band (or sleeve) which is configured to be worn on a person's wrist; and eight (outward-facing) cameras which are evenly (e.g. equidistantly) distributed around (at least a portion of) the circumference of the band (or sleeve) and which collectively span at least half of the circumference of the person's wrist. Alternatively, a smart watch, watch band, or other wrist-worn electronic device with a camera can comprise: a band (or sleeve) which is configured to be worn on a person's wrist; and five (outward-facing) cameras which are evenly (e.g. equidistantly) distributed around at least half of the circumference of the band (or sleeve).

In an example, a smart watch, watch band, or other wrist-worn device with a camera can comprise: a band (or sleeve) which is configured to be worn on a person's wrist; and four (outward-facing) cameras which are distributed around (at least a portion of) the circumference of the band (or sleeve) and which collectively span at least half of the circumference of the person's wrist. In another example, a smart watch, watch band, or other wrist-worn electronic device with an adjustable camera can comprise: a band (or sleeve) which is configured to be worn on a person's wrist; and four (outward-facing) cameras which are evenly (e.g. equidistantly) distributed around (at least a portion of) the circumference of the band (or sleeve) and which collectively span at least half of the circumference of the person's wrist. In an alternative embodiment, a smart watch, watch band, or other wrist-worn device with a camera can comprise: a band (or sleeve) which is configured to be worn on a person's wrist; and six (outward-facing) cameras which are evenly (e.g. equidistantly) distributed around at least half of the circumference of the band (or sleeve).

In an example, a smart watch, watch band, or other wrist-worn device with an adjustable camera can comprise: a display at the 12 o'clock location around a person's wrist, wherein clock locations around the person's wrist are defined relative to 12 o'clock at the middle of the dorsal side and 6 o'clock at the middle of the ventral side; a first camera at the 1 o'clock location around a person's wrist; and a second camera at the 12 o'clock location around a person's wrist. For example, a smart watch, watch band, or other wrist-worn device with a camera can comprise: a display at the 12 o'clock location around a person's wrist, wherein clock locations around the person's wrist are defined relative to 12 o'clock at the middle of the dorsal side and 6 o'clock at the middle of the ventral side; a first camera at the 3 o'clock location around a person's wrist; and a second camera at the 12 o'clock location around the person's wrist. Alternatively, a smart watch, watch band, or other wrist-worn device with an adjustable camera can comprise: a display at the 12 o'clock location around a person's wrist, wherein clock locations around the person's wrist are defined relative to 12 o'clock at the middle of the dorsal side and 6 o'clock at the middle of the ventral side; and a camera at the 2 o'clock location around a person's wrist.

In one embodiment, a smart watch, watch band, or other wrist-worn device with a camera can comprise: a display at the 9 o'clock location around a person's wrist, wherein clock locations around the person's wrist are defined relative to 12 o'clock at the middle of the dorsal side and 6 o'clock at the middle of the ventral side; a first camera at the 1 o'clock location around a person's wrist; and a second camera at the 12 o'clock location around a person's wrist. Alternatively, a smart watch, watch band, or other wrist-worn electronic device with a camera can comprise: a display which is configured to be worn on a lateral side of a person's wrist; and an (outward-facing) camera which is configured to be worn within a lateral-ventral quadrant of the circumference of the person's wrist. Alternatively, a smart watch, watch band, or other wrist-worn device with a camera can comprise: a display which is configured to be worn on a lateral side of a person's wrist; and an (outward-facing) camera which is configured to be worn within a ventral quadrant of the circumference of the person's wrist.

In yet another example, a smart watch, watch band, or other wrist-worn electronic device with an adjustable camera can comprise: a display which is configured to be worn on a person's wrist; a camera which is configured to be worn on the person's wrist; and a motion and/or gesture sensor (e.g. accelerometer) which is configured to be worn on the person's wrist, wherein the camera is automatically activated to take pictures based on data from the sensor. In another example, a smart watch, watch band, or other wrist-worn device with a camera can comprise: a display which is configured to be worn on a person's wrist; a motion and/or gesture sensor which is configured to be worn on the person's wrist; and an (outward-facing) camera which is configured to be worn on the person's wrist, wherein the camera has first configuration with a first focal direction and a second configuration with a second focal direction, and wherein the camera is automatically changed from its first configuration to its second configuration based on data from the motion and/or gesture sensor. For example, a smart watch, watch band, or other wrist-worn device with an adjustable camera can comprise: a display which is configured to be worn on the dorsal side of a person's wrist; a first (outward-facing) camera which is configured to be worn on a first lateral (between dorsal and ventral) side of the person's wrist; and a second (outward-facing) camera which is configured to be worn on a second lateral (between dorsal and ventral) side of the person's wrist, wherein the second lateral side is opposite the first lateral side.

In an embodiment of this invention, a smart watch, watch band, or other wrist-worn device with a camera can comprise: a display which is configured to be worn on the dorsal side of a person's wrist; and an (outward-facing) camera which is configured to be worn on a lateral side of the person's wrist at location which is rotated 90 degrees clockwise around the person's wrist relative to the display. In an alternative embodiment, a smart watch, watch band, or other wrist-worn device with an adjustable camera can comprise: a display which is configured to be worn on the dorsal side of a person's wrist; and an (outward-facing) camera which is configured to be worn within a ventral quadrant of the circumference of the person's wrist. In another example, a smart watch, watch band, or other wrist-worn device with a camera can comprise: a display which is configured to be worn on the ventral side of a person's wrist; and an (outward-facing) camera which is configured to be worn within a dorsal quadrant of the circumference of the person's wrist.

In one embodiment, a smart watch, watch band, or other wrist-worn electronic device with a camera can comprise: a display which is substantially centered on the 12 o'clock location around a person's wrist, wherein clock locations around the person's wrist are defined relative to 12 o'clock at the middle of the dorsal side and 6 o'clock at the middle of the ventral side; a first camera which is substantially centered on the 3 o'clock location around a person's wrist; and a second camera which is substantially centered on the 12 o'clock location around the person's wrist. Alternatively, a smart watch, watch band, or other wrist-worn device with a camera can comprise: a display which is substantially centered on the 12 o'clock location around a person's wrist, wherein clock locations around the person's wrist are defined relative to 12 o'clock at the middle of the dorsal side and 6 o'clock at the middle of the ventral side; and a camera which is substantially centered on the 4 o'clock location around a person's wrist. For example, a smart watch, watch band, or other wrist-worn electronic device with a camera can comprise: a display which is substantially centered on the 9 o'clock location around a person's wrist, wherein clock locations around the person's wrist are defined relative to 12 o'clock at the middle of the dorsal side and 6 o'clock at the middle of the ventral side; a first camera which is substantially centered on the 3 o'clock location around a person's wrist; and a second camera which is substantially centered on the 9 o'clock location around the person's wrist.

In an example, a smart watch, watch band, or other wrist-worn device with a camera can comprise: a display which is substantially centered on the 9 o'clock location around a person's wrist, wherein clock locations around the person's wrist are defined relative to 12 o'clock at the middle of the dorsal side and 6 o'clock at the middle of the ventral side; and a camera which is substantially centered on the 2 o'clock location around a person's wrist. Alternatively, a smart watch, watch band, or other wrist-worn device with a camera can comprise: a first housing of which at least 75% is configured to be worn between the 10 o'clock and 2 o'clock locations around a person's wrist, wherein clock locations around the person's wrist are defined relative to 12 o'clock at the middle of the dorsal side and 6 o'clock at the middle of the ventral side; a second housing of which at least 75% is configured to be worn between 4 o'clock and 8 o'clock locations around a person's wrist; and a camera on the second housing, wherein the display functions as a viewfinder for the camera. Alternatively, a smart watch, watch band, or other wrist-worn device with an adjustable camera can comprise: a first housing which is configured to be worn on the dorsal side of a person's wrist; a display on the first housing; a second housing which is configured to be worn on the ventral side of the person's wrist; a flip-up component which is substantially parallel to the second housing in a first configuration and substantially perpendicular to the second housing in a second configuration, wherein the flip-up component is changed from its first configuration to its second configuration by pivoting, tilting, and/or rotating upward and/or outward from the second housing; and a camera on the flip-up component, wherein the display functions as a viewfinder for the camera.

In an example, a smart watch, watch band, or other wrist-worn device with a camera can comprise: a first housing which is configured to be worn on the dorsal side of a person's wrist; a display on the first housing; a second housing which is configured to be worn on the ventral side of the person's wrist; and a camera on the lateral perimeter of the second housing. In an alternative embodiment, a smart watch, watch band, or other wrist-worn device with an adjustable camera can comprise: a first housing which is configured to be worn on the dorsal side of circumference of a person's wrist; a display on the first housing; a second housing which is configured to be worn on the ventral side of the circumference of the person's wrist; and a camera on the second housing. In another example, a smart watch, watch band, or other wrist-worn electronic device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing which pops upward and/or outward from the housing; a display on the pop-up component; and a camera on the side of the pop-up component which is closest to the 2 o'clock location.

In an example, a smart watch, watch band, or other wrist-worn device with an adjustable camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing which pops upward and/or outward from the housing; a display on the pop-up component; and a camera on the narrow lateral perimeter of the pop-up component. Alternatively, a smart watch, watch band, or other wrist-worn electronic device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing, wherein the pop-up component has a first configuration in which the pop-up component extends a first distance upward and/or outward from the housing, has a second configuration in which the pop-up component extends a second distance upward and/or outward from the housing, and wherein the second distance is between 1 mm and 4 cm greater than the first distance; a display on the proximal side of the pop-up component; and a camera on the distal side of the pop-up component. In another example, a smart watch, watch band, or other wrist-worn device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing, wherein the pop-up component has a first configuration which is recessed within the housing and a second configuration which extends upward and/or outward from the housing; and a camera on the distal side of the pop-up component.

In yet another example, a smart watch, watch band, or other wrist-worn device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing, wherein the pop-up component has a first configuration which is recessed within the housing and a second configuration which extends upward and/or outward from the housing; a display on the pop-up component; and a camera on the pop-up component. Alternatively, a smart watch, watch band, or other wrist-worn device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a flip-up component which is substantially parallel to the housing in a first configuration and substantially perpendicular to the housing in a second configuration, wherein the flip-up component is changed from its first configuration to its second configuration by pivoting, tilting, and/or rotating an edge of the flip-up component upward and/or outward from the housing; a display on a first side of the flip-up component facing toward the person when the flip-up component is in its second configuration; and a camera on a second side of the flip-up component facing away from the person when the flip-up component is in its second configuration.

In one embodiment, a smart watch, watch band, or other wrist-worn device with an adjustable camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a flip-up component which is substantially parallel to the housing in a first configuration and is tilted at an angle between 20 and 120 degrees relative to the housing in a second configuration, wherein the flip-up component is changed from its first configuration to its second configuration by pivoting, tilting, and/or rotating an edge of the flip-up component upward and/or outward from the housing; a display on a first side of the flip-up component facing toward the person when the flip-up component is in its second configuration; a first camera on the first side of the flip-up component; and a second camera on a second side of the flip-up component facing away from the person when the flip-up component is in its second configuration.

In an example, a smart watch, watch band, or other wrist-worn device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a flip-up component which is substantially parallel to the housing in a first configuration and is tilted at an angle between 20 and 120 degrees relative to the housing in a second configuration, wherein the flip-up component is changed from its first configuration to its second configuration by pivoting, tilting, and/or rotating an edge of the flip-up component upward and/or outward from the housing; and a camera on a side of the flip-up component facing away from the person when the flip-up component is in its second configuration. In another example, a smart watch, watch band, or other wrist-worn electronic device with an adjustable camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a flip-up component which pivots, tilts, and/or rotates upward and/or outward from the housing; a display on a first side of the flip-up component; and a camera on a second side of the flip-up component, wherein the second side is opposite the first side. For example, a smart watch, watch band, or other wrist-worn device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a flip-up component which pivots, tilts, and/or rotates upward and/or outward from the housing; a display on the flip-up component; and a camera on the flip-up component.

In an embodiment of this invention, a smart watch, watch band, or other wrist-worn electronic device with an adjustable camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a lift-up component which is a first distance from the centroid of the housing in a first configuration and is a second distance from the centroid of the housing in a second configuration, wherein the second distance is 1 mm to 4 cm greater than the first average distance; wherein the lift-up component is changed from its first configuration to its second configuration by being lifted upward and/or outward from the housing; a display on the lift-up component; and a camera on the lift-up component. Alternatively, a smart watch, watch band, or other wrist-worn device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a pop-up or lift-up component whose centroid is a first distance from the centroid of the housing in a first configuration and a second distance from the centroid of the housing in a second configuration, wherein the second distance is 1 mm to 4 cm greater than the first distance, and wherein the pop-up or lift-up component is changed from its first configuration to its second configuration by pivoting, tilting, and/or rotating the distal edge of the pop-up or lift-up component upward and/or outward from the housing; a display on a first side of the pop-up or lift-up component facing toward the person when the pop-up or lift-up component is in its second configuration; and a camera on a second side of the pop-up or lift-up component facing away from the person when the pop-up or lift-up component is in its second configuration.

In an example, a smart watch, watch band, or other wrist-worn device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a pop-up or lift-up component whose centroid is a first distance from the centroid of the housing in a first configuration and a second distance from the centroid of the housing in a second configuration, wherein the second distance is 1 mm to 4 cm greater than the first distance, and wherein the pop-up or lift-up component is changed from its first configuration to its second configuration by moving upward and/or outward from the housing; a first camera on a first side of the pop-up or lift-up component; and a second camera on a second side of the pop-up or lift-up component.

In an example, a smart watch, watch band, or other wrist-worn device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a pop-up or lift-up component whose centroid is a first distance from the centroid of the housing in a first configuration and a second distance from the centroid of the housing in a second configuration, wherein the second distance is 1 mm to 4 cm greater than the first distance, and wherein the pop-up or lift-up component is changed from its first configuration to its second configuration by pivoting, tilting, and/or rotating the distal edge of the pop-up or lift-up component upward and/or outward from the housing; and a camera on a side of the pop-up or lift-up component facing away from the person when the pop-up or lift-up component is in its second configuration. In an alternative embodiment, a smart watch, watch band, or other wrist-worn device with a camera can comprise: a housing which is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing which pops upward and/or outward from the housing; a display on the pop-up component; and a camera on the side of the pop-up component which is closest to the 2 o'clock location. In another example, a smart watch, watch band, or other wrist-worn device with an adjustable camera can comprise: a housing which is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing which pops upward and/or outward from the housing; a display on the pop-up component; and a camera on the narrow lateral perimeter of the pop-up component.

In yet another example, a smart watch, watch band, or other wrist-worn electronic device with a camera can comprise: a housing which is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing, wherein the pop-up component has a first configuration in which the pop-up component extends a first distance upward and/or outward from the housing, has a second configuration in which the pop-up component extends a second distance upward and/or outward from the housing, and wherein the second distance is between 1 mm and 4 cm greater than the first distance; a display on the proximal side of the pop-up component; and a camera on the distal side of the pop-up component. For example, a smart watch, watch band, or other wrist-worn device with an adjustable camera can comprise: a housing which is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing, wherein the pop-up component has a first configuration which is recessed within the housing and a second configuration which extends upward and/or outward from the housing; and a camera on the distal side of the pop-up component. Alternatively, a smart watch, watch band, or other wrist-worn electronic device with a camera can comprise: a housing which is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing, wherein the pop-up component has a first configuration which is recessed within the housing and a second configuration which extends upward and/or outward from the housing; a display on the pop-up component; and a camera on the pop-up component.

In an example, a smart watch, watch band, or other wrist-worn device with an adjustable camera can comprise: a housing which is configured to be worn on a person's wrist; a display on the housing; a motion and/or gesture sensor (e.g. accelerometer and/or gyroscope) which is configured to be worn on the person's wrist; and a camera which is configured to be worn on a person's wrist, wherein the focal direction of the camera is automatically moved based on data from the motion and/or gesture sensor. Alternatively, a smart watch, watch band, or other wrist-worn device with a camera can comprise: a housing which is configured to be worn on a person's wrist; a display on the housing; and a camera which is configured to be worn on a person's wrist, wherein the focal direction of the camera is automatically moved to scan areas near the person. In another example, a smart watch, watch band, or other wrist-worn device with a camera can comprise: a housing which is configured to be worn on a person's wrist; a flip-up component on the housing, wherein the virtual plane which best fits the flip-up component intersects the housing at a first angle in a first configuration, intersects the housing at a second angle in a second configuration, wherein the second angle is 20 to 120 degrees greater than the first angle, and wherein the flip-up component is changed from its first configuration to its second configuration by pivoting, tilting, and/or rotating upward and/or outward from the housing; a display on the flip-up component; and a camera on the flip-up component.

In one embodiment, a smart watch, watch band, or other wrist-worn device with a camera can comprise: a housing which is configured to be worn on a person's wrist; a flip-up component on the housing, wherein the virtual plane which best fits the flip-up component intersects the housing at a first angle in a first configuration, intersects the housing at a second angle in a second configuration, wherein the second angle is 20 to 120 degrees greater than the first angle, and wherein the flip-up component is changed from its first configuration to its second configuration by being pivoted, tilted, and/or rotated; and a camera on the flip-up component. For example, a smart watch, watch band, or other wrist-worn device with a camera can comprise: a housing which is configured to be worn on a person's wrist; a flip-up component which is substantially parallel to the housing in a first configuration and substantially perpendicular to the housing in a second configuration, wherein the flip-up component is changed from its first configuration to its second configuration by pivoting, tilting, and/or rotating upward and/or outward from the housing; a display on the flip-up component; and a camera on the flip-up component. In another example, a smart watch, watch band, or other wrist-worn electronic device with an adjustable camera can comprise: a housing which is configured to be worn on a person's wrist; a flip-up component which is substantially parallel to the housing in a first configuration and is tilted at an angle between 20 and 120 degrees relative to the housing in a second configuration, wherein the flip-up component is changed from its first configuration to its second configuration by pivoting, tilting, and/or rotating upward and/or outward from the housing; and a camera on the flip-up component.

In an example, a smart watch, watch band, or other wrist-worn device with a camera can comprise: a housing which is configured to be worn on a person's wrist; a flip-up component, wherein a portion of the flip-up component pivots, tilts, and/or rotates around a hinge in an upward and/or outward manner from the housing; a display on the flip-up component; and a camera on the flip-up component. Alternatively, a smart watch, watch band, or other wrist-worn electronic device with an adjustable camera can comprise: a housing which is configured to be worn on a person's wrist; a motion and/or gesture sensor (e.g. accelerometer and/or gyroscope) in the housing; and a camera on the housing, wherein the camera is automatically moved relative to the housing based on data from the motion and/or gesture sensor so as to maintain a constant focal direction relative to the environment. In another example, a smart watch, watch band, or other wrist-worn device with a camera can comprise: a housing which is configured to be worn on a person's wrist; a pop-up component which is substantially flush with or recessed within the housing in a first configuration and extends out from the housing in a second configuration, and wherein the pop-up component is automatically changed from its first configuration to its second configuration, or vice versa, by an actuator; a display on the pop-up component; and a camera on the pop-up component.

In an embodiment of this invention, a smart watch, watch band, or other wrist-worn device with an adjustable camera can comprise: a housing which is configured to be worn on a person's wrist; a pop-up or lift-up component on the housing, wherein the centroid of the pop-up or lift-up component is a first distance from the housing in a first configuration, the centroid of the pop-up or lift-up component is a second distance from the housing in a second configuration, and the second distance is greater than the first distance; wherein the pop-up or lift-up component has a wide outer surface which faces away from the person's wrist, a wide inner surface which faces toward the person's wrist, and a lateral perimeter between the outer surface and the inner surface when the pop-up or lift-up component is in its first configuration; wherein the pop-up or lift-up component changes from its first configuration to its second configuration by moving upward and/or outward from the housing; a display on a first side of the pop-up or lift-up component; and a camera on a second side of the pop-up or lift-up component, wherein the second side is opposite the first side.

In yet another example, a smart watch, watch band, or other wrist-worn device with a camera can comprise: a housing which is configured to be worn on a person's wrist; a pop-up or lift-up component on the housing, wherein the centroid of the pop-up or lift-up component is a first distance from the housing in a first configuration, the centroid of the pop-up or lift-up component is a second distance from the housing in a second configuration, and the second distance is greater than the first distance; wherein the pop-up or lift-up component has a wide outer surface which faces away from the person's wrist, a wide inner surface which faces toward the person's wrist, and a lateral perimeter between the outer surface and the inner surface when the pop-up or lift-up component is in its first configuration; wherein the pop-up or lift-up component changes from its first configuration to its second configuration by moving upward and/or outward from the housing; and a camera on the pop-up or lift-up component. Alternatively, a smart watch, watch band, or other wrist-worn device with a camera can comprise: a housing which is configured to be worn on a person's wrist; a pop-up or lift-up component whose centroid is a first distance from the centroid of the housing in a first configuration and a second distance from the centroid of the housing in a second configuration, wherein the second distance is 1 mm to 4 cm greater than the first distance, and wherein the pop-up or lift-up component is changed from its first configuration to its second configuration by moving upward and/or outward from the housing; a display on the pop-up or lift-up component; and a camera on the pop-up or lift-up component.

In an example, a smart watch, watch band, or other wrist-worn device with a camera can comprise: a housing which is configured to be worn on a person's wrist; and a camera which is configured to be worn on a person's wrist, wherein the focal direction of the camera is automatically moved to scan areas near the person. In another example, a smart watch, watch band, or other wrist-worn device with an adjustable camera can comprise: a housing which is configured to be worn on the dorsal side of a person's wrist; a flip-up component which is substantially parallel to the housing in a first configuration and substantially perpendicular to the housing in a second configuration, wherein the flip-up component is changed from its first configuration to its second configuration by pivoting, tilting, and/or rotating upward and/or outward from the housing; a display on a first side the flip-up component; and a camera on a second side of the flip-up component, wherein the second side is opposite the first side. In an alternative embodiment, a smart watch, watch band, or other wrist-worn device with a camera can comprise: a housing which is configured to be worn on the dorsal side of a person's wrist; a flip-up component which is substantially parallel to the housing in a first configuration and is tilted at an angle between 20 and 120 degrees relative to the housing in a second configuration, wherein the flip-up component is changed from its first configuration to its second configuration by pivoting, tilting, and/or rotating upward and/or outward from the housing; a display on a side the flip-up component; and a camera on an edge of the flip-up component, wherein the edge of the flip-up component is substantially perpendicular to the side of the flip-up component.

In an example, a smart watch, watch band, or other wrist-worn electronic device with an adjustable camera can comprise: a housing which is configured to be worn on the dorsal side of a person's wrist; a flip-up component which is substantially parallel to the housing in a first configuration and is tilted at an angle between 20 and 120 degrees relative to the housing in a second configuration, wherein the flip-up component is changed from its first configuration to its second configuration by pivoting, tilting, and/or rotating upward and/or outward from the housing; and a camera on the flip-up component. Alternatively, a smart watch, watch band, or other wrist-worn device with a camera can comprise: a housing which is configured to be worn on the dorsal side of a person's wrist; a pop-up or lift-up component whose centroid is a first distance from the centroid of the housing in a first configuration and a second distance from the centroid of the housing in a second configuration, wherein the second distance is 1 mm to 4 cm greater than the first distance, and wherein the pop-up or lift-up component is changed from its first configuration to its second configuration by moving upward and/or outward from the housing; a display on the pop-up or lift-up component; and a camera on the pop-up or lift-up component. Alternatively, a smart watch, watch band, or other wrist-worn electronic device with an adjustable camera can comprise: a housing which is configured to be worn on the dorsal side of a person's wrist; a pop-up or lift-up component whose centroid is a first distance from the centroid of the housing in a first configuration and a second distance from the centroid of the housing in a second configuration, wherein the second distance is 1 mm to 4 cm greater than the first distance, and wherein the pop-up or lift-up component is changed from its first configuration to its second configuration by moving upward and/or outward from the housing; and a camera on a side of the pop-up or lift-up component.

In an example, a smart watch, watch band, or other wrist-worn device with a camera can comprise: a housing which is configured to be worn on the dorsal side of a person's wrist; a rotating ring around the perimeter of the housing; and a camera on the ring, wherein the focal direction of the camera is changed as the ring rotates. For example, a smart watch, watch band, or other wrist-worn device with a camera can comprise: a housing which is configured to be worn on the ventral side of a person's wrist; a flip-up component which is substantially parallel to the housing in a first configuration and substantially perpendicular to the housing in a second configuration, wherein the flip-up component is changed from its first configuration to its second configuration by pivoting, tilting, and/or rotating upward and/or outward from the housing; a display on the flip-up component; and a camera on the flip-up component. In another example, a smart watch, watch band, or other wrist-worn device with a camera can comprise: a housing which is configured to be worn on the ventral side of a person's wrist; a flip-up component which is substantially parallel to the housing in a first configuration and substantially perpendicular to the housing in a second configuration, wherein the flip-up component is changed from its first configuration to its second configuration by pivoting, tilting, and/or rotating upward and/or outward from the housing; and a camera on the flip-up component.

In one embodiment, a smart watch, watch band, or other wrist-worn device with an adjustable camera can comprise: a housing with a display of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a rotating ring around the perimeter of the housing, wherein the ring is rotated around the housing; and a camera on an outward-facing side of the ring, wherein the focal direction of the camera is changed as the ring rotates. For example, a smart watch, watch band, or other wrist-worn device with a camera can comprise: a housing with a display which is configured to be worn on a person's wrist; and an (outward-facing) camera on a lateral side of the housing. Alternatively, a smart watch, watch band, or other wrist-worn device with an adjustable camera can comprise: a housing with a display which is configured to be worn on a person's wrist; and an (outward-facing) camera on the lateral perimeter of the housing.

In an example, a smart watch, watch band, or other wrist-worn device with a camera can comprise: a touch-screen display which is configured to be worn on a person's wrist; and a plurality of (outward-facing) cameras which are configured to be worn on the person's wrist; and wherein the person selects one of the adjustable cameras for viewing. In another example, a smart watch, watch band, or other wrist-worn electronic device with an adjustable camera can comprise: a wedge-shaped housing which is configured to be worn on a person's wrist; and camera on the distal side of the wedge-shaped housing, wherein the distal side of the wedge-shaped housing is configured to face away from the person's head. Alternatively, a smart watch, watch band, or other wrist-worn device with a camera can comprise: an (outward-facing) camera which is configured to be worn on a person's wrist, wherein gesture recognition or other pattern recognition methods are used to shift the camera's focal direction and/or distance to maintain a line of sight to the person's other hand.

In yet another example, a smart watch, watch band, or other wrist-worn electronic device with a camera can comprise: an (outward-facing) camera which is configured to be worn on a person's wrist, wherein images captured by the camera are analyzed by face recognition or identification; and a display which is configured to be worn on the person's wrist. In an alternative embodiment, a smart watch, watch band, or other wrist-worn device with a camera can comprise: an (outward-facing) camera which is configured to be worn on the proximal lateral side of a person's wrist; and a display which is configured to be worn on the dorsal side of the person's wrist. Alternatively, a smart watch, watch band, or other wrist-worn device with an adjustable camera can comprise: an (outward-facing) camera which is configured to be worn within the 4-5 o'clock locations around a person's wrist; a display of which at least 75% is configured to be worn between 10 o'clock and 2 o'clock locations around a person's wrist; wherein clock locations around the person's wrist are defined relative to 12 o'clock at the middle of the dorsal side and 6 o'clock at the middle of the ventral side.

In one embodiment, a smart watch, watch band, or other wrist-worn device with a camera can comprise: an (outward-facing) camera which is configured to be worn within the 1-2 o'clock locations around a person's wrist; a display which is configured to be worn at the 9 o'clock location on the circumference of a person's wrist; wherein clock locations around the person's wrist are defined relative to 12 o'clock at the middle of the dorsal side and 6 o'clock at the middle of the ventral side. For example, a smart watch, watch band, or other wrist-worn device with an adjustable camera can comprise: an (outward-facing) camera which is configured to be worn within the 1-2 o'clock locations around a person's wrist; a display which is configured to be worn within the 7-8 o'clock locations around a person's wrist; wherein clock locations around the person's wrist are defined relative to 12 o'clock at the middle of the dorsal side and 6 o'clock at the middle of the ventral side. Alternatively, a smart watch, watch band, or other wrist-worn device with a camera can comprise: an outward-facing wide-angle camera which is configured to be worn on the anterior (e.g. ventral) surface of a person's wrist or upper arm; and a display which is configured to be worn on the person's wrist.

In yet another example, a smart watch, watch band, or other wrist-worn device with an adjustable camera can comprise: two cameras which are configured to be worn on the narrow sides of a person's wrist, between the posterior and anterior surfaces of the wrist; and a display which is configured to be worn on the dorsal side of person's wrist. In another example, a smart watch, watch band, or other wrist-worn electronic device with a camera can comprise: two cameras which are configured to be worn on the narrow sides of a person's wrist, between the posterior and anterior surfaces of the wrist; and a display which is configured to be worn on the person's wrist, wherein the display can selectively act as a view finder for one or both of the cameras. Alternatively, a smart watch, watch band, or other wrist-worn device with a camera can comprise: a band (or sleeve) which is configured to be worn on a person's right wrist; a display on the band (or sleeve); a motion and/or gesture sensor on the band (or sleeve); a camera on the band (or sleeve); and an actuator on the band, wherein the focal distance and/or focal direction of the camera is automatically changed by the actuator based on movement of the band which is detected by the motion and/or gesture sensor in order to optically track (e.g. maintain imaging of) the person's left hand.

In an embodiment of this invention, a smart watch, watch band, or other wrist-worn electronic device with a camera can comprise: a band (or sleeve) which is configured to be worn on a person's wrist; a circumferentially-moving portion which slides along a track or channel on the band (or sleeve); and an (outward-facing) camera on the circumferentially-moving portion. Alternatively, a smart watch, watch band, or other wrist-worn device with an adjustable camera can comprise: a band (or sleeve) which is configured to be worn on a person's wrist; a detachable housing which can be reversibly detached from the band (or sleeve) by unplugging, unsnapping, or uncoupling the housing from the band (or sleeve); and a camera on the detachable housing; wherein the camera is in wireless communication with the band (or sleeve) when the housing is detached from the band (or sleeve) so that the camera can be used to record images even when the housing is detached from the band (or sleeve). In another example, a smart watch, watch band, or other wrist-worn device with a camera can comprise: a band (or sleeve) which is configured to be worn on a person's wrist; a display on the band (or sleeve); a first camera with a field of view with a first width; and a second (“wide-angle”) camera with a field of view with a second width, wherein the second width is at least 25% greater than the first width.

In yet another example, a smart watch, watch band, or other wrist-worn device with an adjustable camera can comprise: a band (or sleeve) which is configured to be worn on a person's wrist; a display on the band (or sleeve); a first camera with a first focal distance; and a second (“zoom”) camera with a second focal distance, wherein the second focal distance is at least 25% greater than the first focal distance. In another example, a smart watch, watch band, or other wrist-worn device with a camera can comprise: a band (or sleeve) which is configured to be worn on a person's wrist; a display on the band (or sleeve); a motion and/or gesture sensor on the band (or sleeve); a camera on the band (or sleeve); and an actuator on the band, wherein the focal distance and/or focal direction of the camera is automatically changed by the actuator based on movement of the band which is detected by the motion and/or gesture sensor in order to optically track (e.g. maintain imaging of) the person's other hand. In an alternative embodiment, a smart watch, watch band, or other wrist-worn device with an adjustable camera can comprise: a band (or sleeve) which is configured to be worn on a person's wrist; a display on the band (or sleeve); and an (outward-facing) camera with a wide-angle lens on the band (or sleeve).

In an example, a smart watch, watch band, or other wrist-worn electronic device with a camera can comprise: a band (or sleeve) which is configured to be worn on a person's wrist; a display on the band (or sleeve); and an arcuate array of (outward-facing) cameras, wherein the cameras and the display collectively are evenly distributed around the entire circumference of the band (or sleeve). Alternatively, a smart watch, watch band, or other wrist-worn device with a camera can comprise: a band (or sleeve) which is configured to be worn on a person's wrist; a display on the band (or sleeve); and an arcuate array of (outward-facing) cameras, wherein the cameras and the display collectively are evenly distributed around the entire circumference of the person's wrist. For example, a smart watch, watch band, or other wrist-worn electronic device with a camera can comprise: a band (or sleeve) which is configured to be worn on a person's wrist; a display which is centered at a first clock-hour location around the circumference of band (or sleeve); and a camera which is centered at a second clock-hour location around the circumference of band (or sleeve), wherein the first clock-hour location differs from the second clock-hour location by 3 hours.

In an example, a smart watch, watch band, or other wrist-worn device with an adjustable camera can comprise: a band (or sleeve) which is configured to be worn on a person's wrist; a display which is centered at a first clock-hour location around the circumference of band (or sleeve); and a camera which is centered at a second clock-hour location around the circumference of band (or sleeve), wherein the first clock-hour location differs from the second clock-hour location by between 1 and 3 hours. Alternatively, a smart watch, watch band, or other wrist-worn device with a camera can comprise: a band (or sleeve) which is configured to be worn on a person's wrist; a display which is centered at a first location on the circumference of band (or sleeve) with a first polar coordinate; a first camera which is centered at a second location on the circumference of band (or sleeve) with a second polar coordinate; and a second camera which is centered at a third location on the circumference of band (or sleeve) with a third polar coordinate; wherein the angle of the second polar coordinate differs from the angle of the first polar coordinate by 45 degrees, wherein the angle of the third polar coordinate differs from the angle of the first polar coordinate by 90 degrees, and wherein the angle of the third polar coordinate differs from the angle of the second coordinate by 135 degrees. In another example, a smart watch, watch band, or other wrist-worn device with an adjustable camera can comprise: a band (or sleeve) which is configured to be worn on a person's wrist; a display which is centered at a first location on the circumference of band (or sleeve) with a first polar coordinate; and a camera which is centered at a second location on the circumference of band (or sleeve) with a second polar coordinate, wherein the angle of the second polar coordinate differs from the angle of the first polar coordinate by between 80 and 100 degrees.

In an example, a smart watch, watch band, or other wrist-worn device with a camera can comprise: a band (or sleeve) which is configured to be worn on a person's wrist; a display which is centered at a first location on the circumference of band (or sleeve) with a first polar coordinate; and a camera which is centered at a second location on the circumference of band (or sleeve) with a second polar coordinate, wherein the angle of the second polar coordinate differs from the angle of the first polar coordinate by between 170 and 190 degrees. Alternatively, a smart watch, watch band, or other wrist-worn device with an adjustable camera can comprise: a band (or sleeve) which is configured to be worn on a person's wrist; a display which is centered at a first location on the circumference of band (or sleeve) with a first polar coordinate; and a camera which is centered at a second location on the circumference of band (or sleeve) with a second polar coordinate, wherein the angle of the second polar coordinate differs from the angle of the first polar coordinate by 125 and 145 degrees. In an alternative embodiment, a smart watch, watch band, or other wrist-worn device with a camera can comprise: a band (or sleeve) which is configured to be worn on a person's wrist; a first camera which is centered at a first location on the circumference of band (or sleeve) with a first polar coordinate; a display which is centered at a second location on the circumference of band (or sleeve) with a second polar coordinate; and a second camera which is centered at a third location on the circumference of band (or sleeve) with a third polar coordinate; wherein the angle of the second polar coordinate differs from the angle of the first polar coordinate by between 30 and 60 degrees, wherein the angle of the third polar coordinate differs from the angle of the second polar coordinate by between 30 and 60 degrees, and wherein the angle of the third polar coordinate differs from the angle of the first coordinate by between 60 and 120 degrees.

In an example, a smart watch, watch band, or other wrist-worn device with a camera can comprise: a band (or sleeve) which is configured to be worn on a person's wrist; a housing on the band (or sleeve) on the dorsal side of the person's wrist; a transparent dome on the housing which extends outward from the person's wrist; and a camera on the housing under the transparent dome, wherein the camera can be rotated and/or tilted relative to the housing in order to change the camera's focal direction. Alternatively, a smart watch, watch band, or other wrist-worn electronic device with a camera can comprise: a band (or sleeve) which is configured to be worn on a person's wrist; a housing on the band (or sleeve) on the ventral side of the person's wrist; a transparent convex component on the housing which extends outward from the person's wrist; and a camera on the housing under the transparent convex component, wherein the camera is automatically rotated and/or tilted relative to the housing by an actuator in order to change the camera's focal direction. For example, a smart watch, watch band, or other wrist-worn device with a camera can comprise: a band (or sleeve) which is configured to be worn on a person's wrist; a housing on the band (or sleeve) which extends between 1 cm and 3 cm outward from the band (or sleeve); a display on the housing; and a plurality of cameras evenly (e.g. equidistantly) distributed around the lateral (narrow) perimeter of the housing.

In one embodiment, a smart watch, watch band, or other wrist-worn electronic device with an adjustable camera can comprise: a band (or sleeve) which is configured to be worn on a person's wrist; a housing on the band (or sleeve) which extends between 5 mm and 1 cm outward from the band (or sleeve); a display on the housing; and a plurality of cameras evenly (e.g. equidistantly) distributed around the lateral (narrow) perimeter of the housing. In another example, a smart watch, watch band, or other wrist-worn device with a camera can comprise: a band (or sleeve) which is configured to be worn on a person's wrist; a housing on the band (or sleeve) which extends between 5 mm and 2 cm outward from the band (or sleeve); a touch-screen display on the housing; and a plurality of cameras evenly (e.g. equidistantly) distributed around the lateral (narrow) perimeter of the housing, wherein the person selects one of the plurality of cameras for imaging at a given time by touching or swiping the display. Alternatively, a smart watch, watch band, or other wrist-worn device with an adjustable camera can comprise: a band (or sleeve) which is configured to be worn on a person's wrist; a housing on the band (or sleeve) which extends outward from the band (or sleeve); a display on the housing; a rotating ring or bezel on the housing; and a plurality of cameras evenly (e.g. equidistantly) distributed around the perimeter of the ring or bezel, wherein the person selects one of the plurality of cameras for imaging at a given time by rotating the ring or bezel.

In yet another example, a smart watch, watch band, or other wrist-worn device with a camera can comprise: a band (or sleeve) which is configured to be worn on a person's wrist; a housing on the band (or sleeve) which extends outward from the band (or sleeve); a display on the housing; and a plurality of cameras which are evenly (e.g. equidistantly) distributed around the lateral (narrow) perimeter of the housing, wherein central focal vectors of the cameras are parallel to vectors which are tangential to the circumference of the band (or sleeve). Alternatively, a smart watch, watch band, or other wrist-worn device with an adjustable camera can comprise: a band (or sleeve) which is configured to be worn on a person's wrist; a housing on the band (or sleeve) which extends outward from the band (or sleeve); a display on the housing; a rotating ring or bezel on the housing; and a plurality of cameras distributed around the perimeter of the ring or bezel, wherein the person selects one of the plurality of cameras for imaging at a given time by rotating the ring or bezel. For example, a smart watch, watch band, or other wrist-worn device with a camera can comprise: a band (or sleeve) which is configured to be worn on a person's wrist; a housing on the band (or sleeve) which extends outward from the band (or sleeve); a display on the housing; and a plurality of cameras which are distributed around the lateral (narrow) perimeter of the housing, wherein central focal vectors of the cameras are parallel to vectors which are tangential to the circumference of the band (or sleeve).

In an embodiment of this invention, a smart watch, watch band, or other wrist-worn electronic device with a camera can comprise: a band (or sleeve) which is configured to be worn on a person's wrist; a housing on the band (or sleeve) which extends outward from the band (or sleeve); a display on the housing; and two cameras on the housing, wherein the cameras are located on opposite sides of the lateral (narrow) perimeter of the housing. In another example, a smart watch, watch band, or other wrist-worn device with a camera can comprise: a band (or sleeve) which is configured to be worn on a person's wrist; a housing on the band (or sleeve) which extends outward from the band (or sleeve); a display on the housing; a rotating ring or bezel on the housing; and at least one camera on the perimeter of the ring or bezel, wherein the person changes the focal direction of the at least one camera by rotating the ring or bezel. In an alternative embodiment, a smart watch, watch band, or other wrist-worn electronic device with an adjustable camera can comprise: a band (or sleeve) which is configured to be worn on a person's wrist; a housing on the band (or sleeve) with a transparent convex surface (e.g. transparent dome) which extends outward from the band (or sleeve); a rotating camera on the housing under the transparent convex surface; and an actuator which rotates the camera, wherein the focal direction of the camera is automatically changed when an actuator rotates the camera.

In yet another example, a smart watch, watch band, or other wrist-worn device with a camera can comprise: a band (or sleeve) which is configured to be worn on a person's wrist; a housing on the band (or sleeve), wherein the housing further comprises a rotating turret, bezel, or ring; and a plurality of cameras on the lateral (narrow) perimeter of the rotating turret, bezel, or ring; wherein the turret, bezel, or ring rotates in a plane which is substantially parallel to the closest plane which is tangential to the circumference of the band (or sleeve). In another example, a smart watch, watch band, or other wrist-worn device with an adjustable camera can comprise: a band (or sleeve) which is configured to be worn on a person's wrist; a housing on the band (or sleeve), wherein the housing further comprises a rotating turret, bezel, or ring; and a plurality of cameras on the rotating turret, bezel, or ring; wherein the turret, bezel, or ring rotates in a plane which is substantially parallel to the closest plane which is tangential to the circumference of the band (or sleeve). Alternatively, a smart watch, watch band, or other wrist-worn device with a camera can comprise: a band (or sleeve) which is configured to be worn on a person's wrist; a housing on the band (or sleeve), wherein the housing further comprises a turret, bezel, or ring which is automatically rotated by an actuator; and at least one camera on the lateral (narrow) perimeter of the rotating turret, bezel, or ring; wherein the turret, bezel, or ring rotates in a plane which is substantially parallel to the closest plane which is tangential to the circumference of the band (or sleeve).

In one embodiment, a smart watch, watch band, or other wrist-worn device with an adjustable camera can comprise: a band (or sleeve) which is configured to be worn on a person's wrist; a housing on the band (or sleeve); a camera on the housing; and a lens which is moved by electromagnetic means, wherein the focal direction of the camera is changed by movement of the lens. In another example, a smart watch, watch band, or other wrist-worn device with a camera can comprise: a band (or sleeve) which is configured to be worn on a person's wrist; a housing on the band (or sleeve); a display on a first side of the housing; a first camera on the first side of the housing; and a second camera on a second side of the housing, wherein the second side is opposite the first side. Alternatively, a smart watch, watch band, or other wrist-worn electronic device with a camera can comprise: a band (or sleeve) which is configured to be worn on a person's wrist; a housing on the band (or sleeve); a flip-up or pop-up component on the housing; a display on a side of the flip-up or pop-up component; and a camera on the same side of the flip-up or pop-up component as the display.

In an example, a smart watch, watch band, or other wrist-worn device with a camera can comprise: a band (or sleeve) which is configured to be worn on a person's wrist; a housing on the band (or sleeve); a pop-up, flip-up, or tilt-up component on the housing with a first configuration in which the centroid of the pop-up, flip-up, or tilt-up component is a first distance from the surface of the person's wrist and a second configuration in which the centroid of the pop-up, flip-up, or tilt-up component is a second distance from the surface of the person's wrist, wherein the second distance is 2 mm to 4 cm greater than the first distance; a camera on the pop-up, flip-up, or tilt-up component; a motion and/or gesture sensor on the band (or sleeve); and an actuator on the band (or sleeve); wherein the pop-up, flip-up, or tilt-up component is automatically moved by the actuator from its first configuration to its second configuration when the person makes a selected motion and/or gesture as detected by the motion and/or gesture sensor. For example, a smart watch, watch band, or other wrist-worn electronic device with a camera can comprise: a band (or sleeve) which is configured to be worn on a person's wrist; a housing on the band (or sleeve); a pop-up, flip-up, or tilt-up component on the housing with a first configuration in which the centroid of the pop-up, flip-up, or tilt-up component is a first distance from the side of the housing which is closest to the person's wrist and a second configuration in which the centroid of the pop-up, flip-up, or tilt-up component is a second distance from the side of the housing which is closest to the person's wrist, wherein the second distance is 2 mm to 4 cm greater than the first distance; a display on a first side of the pop-up, flip-up, or tilt-up component; a camera on a second side of the pop-up, flip-up, or tilt-up component; and a motion and/or gesture sensor on the band (or sleeve); wherein the pop-up, flip-up, or tilt-up component is automatically popped up, flipped up, or tilted up from its first configuration to its second configuration when the person makes a selected motion and/or gesture as detected by the motion and/or gesture sensor.

In an example, a smart watch, watch band, or other wrist-worn device with a camera can comprise: a band (or sleeve) which is configured to be worn on a person's wrist; a housing on the band (or sleeve); a pop-up, flip-up, or tilt-up component on the housing with a first configuration in which the centroid of the pop-up, flip-up, or tilt-up component is a first distance from the side of the housing which is closest to the person's wrist and a second configuration in which the centroid of the pop-up, flip-up, or tilt-up component is a second distance from the side of the housing which is closest to the person's wrist, wherein the second distance is 2 mm to 4 cm greater than the first distance; a touch-screen display on a first side of the pop-up, flip-up, or tilt-up component; a first camera on the first side of the pop-up, flip-up, or tilt-up component; and a second camera on a second side of the pop-up, flip-up, or tilt-up component, wherein the second side is parallel to the first side; wherein the pop-up, flip-up, or tilt-up component is automatically popped up, flipped up, or tilted up from its first configuration to its second configuration when the person makes a selected touch or swipe motion on the touch-screen display.

In an example, a smart watch, watch band, or other wrist-worn device with a camera can comprise: a band (or sleeve) which is configured to be worn on a person's wrist; a housing on the band (or sleeve); a transparent closed-end cylinder on the housing which extends outward from the person's wrist; and a camera under the transparent closed-end cylinder, wherein the camera is rotated and/or tilted relative to the housing in order to change the camera's focal direction. Alternatively, a smart watch, watch band, or other wrist-worn device with an adjustable camera can comprise: a band (or sleeve) which is configured to be worn on a person's wrist; a housing on the band (or sleeve); a transparent convex component on the housing which extends outward from the person's wrist; and a camera under the transparent convex component, wherein the camera is rotated and/or tilted relative to the housing in order to change the camera's focal direction. In an alternative embodiment, a smart watch, watch band, or other wrist-worn device with a camera can comprise: a band (or sleeve) which is configured to be worn on a person's wrist; a housing on the band (or sleeve); a transparent dome on the housing which extends outward from the person's wrist; and a camera on the housing under the transparent dome, wherein the camera is automatically rotated and/or tilted relative to the housing by an actuator in order to change the camera's focal direction.

In yet another example, a smart watch, watch band, or other wrist-worn electronic device with an adjustable camera can comprise: a band (or sleeve) which is configured to be worn on a person's wrist; a housing on the band (or sleeve); a transparent portion of a sphere on the housing which extends outward from the person's wrist; and a camera on the housing under the transparent portion of a sphere, wherein the camera is automatically rotated and/or tilted relative to the housing by an actuator in order to change the camera's focal direction. Alternatively, a smart watch, watch band, or other wrist-worn device with a camera can comprise: a band (or sleeve) which is configured to be worn on a person's wrist; a housing on the band (or sleeve); a transparent prism on the housing which extends outward from the person's wrist; and a camera under the transparent prism, wherein the camera is automatically rotated and/or tilted relative to the housing by an actuator in order to change the camera's focal direction. In another example, a smart watch, watch band, or other wrist-worn electronic device with an adjustable camera can comprise: a band (or sleeve) which is configured to be worn on a person's wrist; a housing on the band (or sleeve); and a camera which can be reversibly detached from (and re-attached to) the housing, wherein the camera is in wireless communication with the housing when it is detached from the housing so that the camera can be used to record images even when the camera is detached from the housing.

In an example, a smart watch, watch band, or other wrist-worn device with a camera can comprise: a band (or sleeve) which is configured to be worn on a person's wrist; a housing on the dorsal side of the band (or sleeve); a display on a first side of the housing; a first camera on the first side of the housing; and a second camera on a second side of the housing, wherein the second side is opposite the first side. For example, a smart watch, watch band, or other wrist-worn electronic device with a camera can comprise: a band (or sleeve) which is configured to be worn on a person's wrist; a housing on the dorsal side of the band (or sleeve); a flip-up or pop-up component on the housing; a display on a first side of the flip-up or pop-up component; and a camera on a second side of the flip-up or pop-up component, wherein the second side is opposite the first side. In another example, a smart watch, watch band, or other wrist-worn device with a camera can comprise: a band (or sleeve) which is configured to be worn on a person's wrist; a housing on the dorsal side of the band (or sleeve); a flip-up or pop-up component on the housing; a display on a first side of the flip-up or pop-up component; a first camera on the first side of the flip-up or pop-up component; and a second camera on a second side of the flip-up or pop-up component, wherein the second side is perpendicular to the first side.

In yet another example, a smart watch, watch band, or other wrist-worn device with a camera can comprise: a band (or sleeve) which is configured to be worn on a person's wrist; a motion and/or gesture sensor on the band (or sleeve); and a plurality of (outward-facing) cameras which collectively span at least half of the circumference of the person's wrist, wherein the person selects which one of the plurality of (outward-facing) cameras to use at a given time by making a movement or gesture. Alternatively, a smart watch, watch band, or other wrist-worn device with an adjustable camera can comprise: a band (or sleeve) which is configured to be worn on a person's wrist; a motion and/or gesture sensor on the band (or sleeve); and an arcuate array of (outward-facing) cameras which are distributed around (at least a portion of) the circumference of the band (or sleeve), wherein the arcuate array of (outward-facing) cameras collectively spans at least 25% of the circumference of the person's wrist, wherein a camera in the array is selected by the person to record images at a given time, and wherein the selection of the camera is done by the person moving the band as detected by the motion and/or gesture sensor. Alternatively, a smart watch, watch band, or other wrist-worn device with a camera can comprise: a band (or sleeve) which is configured to be worn on a person's wrist; a motion and/or gesture sensor on the band (or sleeve); and an arcuate array of (outward-facing) cameras which are evenly (e.g. equidistantly) distributed around (at least a portion of) the circumference of the band (or sleeve), wherein the arcuate array of (outward-facing) cameras collectively spans at least 25% of the circumference of the person's wrist, wherein a camera in the array is selected by the person to record images at a given time, and wherein the selection of the camera is done by the person moving the band as detected by the motion and/or gesture sensor.

In an embodiment of this invention, a smart watch, watch band, or other wrist-worn device with an adjustable camera can comprise: a band (or sleeve) which is configured to be worn on a person's wrist; a removable housing which can be removed from the band (or sleeve); wherein the housing remains connected to the band (or sleeve) by a flexible component (such as a wire, cord, or strap) even when the housing is removed from the band (or sleeve); and a camera on the removable housing, wherein the camera is in electronic (wired or wireless) communication with the band (or sleeve) when the housing is removed from the band (or sleeve) so that the camera can be used to record images even when the housing is removed from the band (or sleeve). In an alternative embodiment, a smart watch, watch band, or other wrist-worn device with a camera can comprise: a band (or sleeve) which is configured to be worn on a person's wrist; a touch-screen display on the band (or sleeve); and a plurality of (outward-facing) cameras which collectively span at least half of the circumference of the person's wrist, wherein the person selects which one of the plurality of (outward-facing) cameras to use at a given time by touching and/or swiping the display. For example, a smart watch, watch band, or other wrist-worn electronic device with an adjustable camera can comprise: a band (or sleeve) which is configured to be worn on a person's wrist; and a camera which can be reversibly detached from the band (or sleeve) by sliding, popping, or pulling the camera out of an opening in the band (or sleeve), wherein the camera is in wireless communication with the band (or sleeve) when it is detached from the band (or sleeve) so that the camera can be used to record images even when the camera is detached from the band (or sleeve).

In one embodiment, a smart watch, watch band, or other wrist-worn device with a camera can comprise: a band (or sleeve) which is configured to be worn on a person's wrist; and a plurality of (outward-facing) cameras distributed around at least one quarter of the circumference of the band (or sleeve), wherein angles between the polar coordinate locations of two proximal (e.g. adjacent) cameras are no greater than 15 degrees. In another example, a smart watch, watch band, or other wrist-worn electronic device with a camera can comprise: a band (or sleeve) which is configured to be worn on a person's wrist; and a plurality of (outward-facing) cameras distributed around at least one half of the circumference of the band (or sleeve), wherein angles between the polar coordinate locations of two proximal (e.g. adjacent) cameras are no greater than 45 degrees. In another example, a smart watch, watch band, or other wrist-worn device with a camera can comprise: a band (or sleeve) which is configured to be worn on a person's wrist; and a plurality of (outward-facing) cameras distributed around at least one half of the circumference of the person's wrist, wherein angles between the polar coordinate locations of two proximal (e.g. adjacent) cameras are no greater than 30 degrees.

In an example, a smart watch, watch band, or other wrist-worn device with a camera can comprise: a band (or sleeve) which is configured to be worn on a person's wrist; and a plurality of (outward-facing) cameras evenly (e.g. equidistantly) distributed around at least one quarter of the circumference of the band (or sleeve), wherein angles between the polar coordinate locations of two proximal (e.g. adjacent) cameras are no greater than 15 degrees. Alternatively, a smart watch, watch band, or other wrist-worn device with an adjustable camera can comprise: a band (or sleeve) which is configured to be worn on a person's wrist; and a plurality of (outward-facing) cameras evenly (e.g. equidistantly) distributed around at least one half of the circumference of the band (or sleeve), wherein angles between the polar coordinate locations of two proximal (e.g. adjacent) cameras are no greater than 45 degrees. Alternatively, a smart watch, watch band, or other wrist-worn device with a camera can comprise: a band (or sleeve) which is configured to be worn on a person's wrist; and a plurality of (outward-facing) cameras evenly (e.g. equidistantly) distributed around at least one half of the circumference of the person's wrist, wherein angles between the polar coordinate locations of two proximal (e.g. adjacent) cameras are no greater than 30 degrees.

In one embodiment, a smart watch, watch band, or other wrist-worn device with an adjustable camera can comprise: a band (or sleeve) which is configured to be worn on a person's wrist, wherein the band (or sleeve) further comprises an arcuate array of connectors, ports, or sockets which spans at least half of the circumference of the person's wrist; and a plurality of (outward-facing) cameras which can be selectively and removably attached to connectors, ports, or sockets in the array. Alternatively, a smart watch, watch band, or other wrist-worn device with a camera can comprise: a band (or sleeve) which is configured to be worn on a person's wrist, wherein the band (or sleeve) further comprises a circumferential array of connectors, ports, or sockets; and a plurality of (outward-facing) cameras which can be selectively detached from and re-attached to connectors, ports, or sockets in the array. In another example, a smart watch, watch band, or other wrist-worn electronic device with an adjustable camera can comprise: a band (or sleeve) which is configured to be worn on a person's wrist, wherein the band (or sleeve) further comprises an arcuate array of connectors, ports, or sockets which spans at least three-quarters of the circumference of the person's wrist; and a plurality of (outward-facing) cameras which can be selectively detached from and re-attached to connectors, ports, or sockets in the array.

In yet another example, a smart watch, watch band, or other wrist-worn device with a camera can comprise: a band (or sleeve) which is configured to be worn on a person's wrist; and a plurality of (outward-facing) cameras which collectively span at least one quarter of the circumference of the person's wrist, wherein the person selects which one of the plurality of (outward-facing) cameras to use at a given time by making a movement or gesture. For example, a smart watch, watch band, or other wrist-worn electronic device with a camera can comprise: a band (or sleeve) which is configured to be worn on a person's wrist; and an (outward-facing) camera on the band (or sleeve), wherein the camera can be attached to different locations on the circumference of band (or sleeve). In another example, a smart watch, watch band, or other wrist-worn device with a camera can comprise: a band (or sleeve) which is configured to be worn on a person's wrist; and an (outward-facing) camera on the band (or sleeve), wherein the circumferential location of the camera relative to the circumference of the person's wrist can be manually changed.

In an embodiment of this invention, a smart watch, watch band, or other wrist-worn device with an adjustable camera can comprise: a band (or sleeve) which is configured to be worn on a person's wrist, wherein the band (or sleeve) further comprises a proximal (partial) ring and a distal (partial) ring, wherein the proximal (partial) ring is closer to the person's elbow than the distal (partial) ring, and wherein the distal (partial) ring moves circumferentially relative to the proximal (partial) ring; and an (outward-facing) camera on the distal (partial) ring. Alternatively, a smart watch, watch band, or other wrist-worn device with a camera can comprise: a band (or sleeve) which is configured to be worn on a person's wrist, wherein the band (or sleeve) further comprises a central (partial) ring and an outer (partial) ring, wherein the central (partial) ring is closer to the center of the band (or sleeve) than the outer (partial) ring, and wherein the outer (partial) ring moves circumferentially relative to the central (partial) ring; and an (outward-facing) camera on the outer (partial) ring. For example, a smart watch, watch band, or other wrist-worn device with an adjustable camera can comprise: a band (or sleeve) which is configured to be worn on a person's wrist, wherein the band (or sleeve) further comprises an inner ring with a track or channel, wherein the band (or sleeve) further comprises an outer ring which rotates or slides circumferentially along the track or channel; and an (outward-facing) camera on the outer ring.

In yet another example, a smart watch, watch band, or other wrist-worn device with a camera can comprise: a band (or sleeve) which is configured to be worn on a person's wrist, wherein the band (or sleeve) further comprises a first (partial) ring and a second (partial) ring, wherein the second (partial) ring slides around at least a portion of the first (partial) ring; and an (outward-facing) camera on the second (partial) ring. In an alternative embodiment, a smart watch, watch band, or other wrist-worn electronic device with an adjustable camera can comprise: a band (or sleeve) which is configured to be worn on a person's wrist, wherein the band (or sleeve) has a track or channel around at least a portion of its circumference; and an (outward-facing) camera which can be manually moved along the track or channel to different locations on the circumference of the band (or sleeve). In another example, a smart watch, watch band, or other wrist-worn device with a camera can comprise: a band (or sleeve) which is configured to be worn on a person's wrist, wherein the band (or sleeve) further comprises an arcuate array of connectors, ports, or sockets which spans at least half of the circumference of the person's wrist; and an (outward-facing) camera which can be selectively and removably attached to a connector, port, or socket in the array.

In an example, a smart watch, watch band, or other wrist-worn electronic device with a camera can comprise: a band (or sleeve) which is configured to be worn on a person's wrist, wherein the band (or sleeve) further comprises a circumferential array of connection ports; and an (outward-facing) camera which can be selectively and removably attached to a connection port in the array. For example, a smart watch, watch band, or other wrist-worn device with a camera can comprise: a band (or sleeve) which is configured to be worn on a person's wrist, wherein the band (or sleeve) further comprises an arcuate array of connectors, ports, or sockets which spans at least half of the circumference of the person's wrist; and an (outward-facing) camera which can be selectively detached from and re-attached to a connector, port, or socket in the array. Alternatively, a smart watch, watch band, or other wrist-worn device with an adjustable camera can comprise: a band (or sleeve) which is configured to be worn on a person's wrist, wherein the band (or sleeve) has a track or channel around at least a portion of its circumference; and an (outward-facing) camera which is automatically moved by an actuator along the track or channel to different locations on the circumference of the band (or sleeve).

In an example, a smart watch, watch band, or other wrist-worn device with a camera can comprise: a band (or sleeve) which is configured to be worn on a person's wrist; and an (outward-facing) camera with a first configuration in which the camera is at a first location on the circumference of the band (or sleeve) and a second configuration in which the camera is at a second location on the circumference of the band (or sleeve), wherein the camera is automatically moved by an actuator from its first configuration to its second configuration. In an alternative embodiment, a smart watch, watch band, or other wrist-worn device with an adjustable camera can comprise: a band (or sleeve) which is configured to be worn on a person's wrist; and an arcuate array of (outward-facing) cameras distributed around (at least a portion of) the circumference of the band (or sleeve), collectively spanning at between 25% and 100% of the circumference of the person's wrist. In another example, a smart watch, watch band, or other wrist-worn device with a camera can comprise: a band (or sleeve) which is configured to be worn on a person's wrist; and an arcuate array of (outward-facing) cameras distributed around (at least a portion of) the circumference of the band (or sleeve), collectively spanning at between 25% and 100% of the circumference of the band (or sleeve).

In an example, a smart watch, watch band, or other wrist-worn device with an adjustable camera can comprise: a band (or sleeve) which is configured to be worn on a person's wrist; and an arcuate array of (outward-facing) cameras distributed around (at least a portion of) the circumference of the band (or sleeve), collectively spanning at between 25% and 100% of the circumference of the person's wrist, including the distal lateral side of the person's wrist. In another example, a smart watch, watch band, or other wrist-worn electronic device with a camera can comprise: a band (or sleeve) which is configured to be worn on a person's wrist; and an arcuate array of (outward-facing) cameras distributed around (at least a portion of) the circumference of the band (or sleeve), collectively spanning at between 25% and 100% of the circumference of the band (or sleeve), including the distal lateral side of the band (or sleeve). Alternatively, a smart watch, watch band, or other wrist-worn device with a camera can comprise: a band (or sleeve) which is configured to be worn on a person's wrist; and an arcuate array of (outward-facing) cameras evenly (e.g. equidistantly) distributed around (at least a portion of) the circumference of the band (or sleeve), collectively spanning at between 25% and 100% of the circumference of the person's wrist.

In an example, a smart watch, watch band, or other wrist-worn electronic device with a camera can comprise: a band (or sleeve) which is configured to be worn on a person's wrist; and an arcuate array of (outward-facing) cameras evenly (e.g. equidistantly) distributed around (at least a portion of) the circumference of the band (or sleeve), collectively spanning at between 25% and 100% of the circumference of the band (or sleeve). Alternatively, a smart watch, watch band, or other wrist-worn device with an adjustable camera can comprise: a band (or sleeve) which is configured to be worn on a person's wrist; and an arcuate array of (outward-facing) cameras evenly (e.g. equidistantly) distributed around (at least a portion of) the circumference of the band (or sleeve), collectively spanning at between 25% and 100% of the circumference of the person's wrist, including the distal lateral side of the person's wrist. Alternatively, a smart watch, watch band, or other wrist-worn electronic device with a camera can comprise: a band (or sleeve) which is configured to be worn on a person's wrist; and an arcuate array of (outward-facing) cameras evenly (e.g. equidistantly) distributed around (at least a portion of) the circumference of the band (or sleeve), collectively spanning at between 25% and 100% of the circumference of the band (or sleeve), including the distal lateral side of the band (or sleeve).

In yet another example, a smart watch, watch band, or other wrist-worn device with an adjustable camera can comprise: a band (or sleeve) which is configured to be worn on a person's wrist; and an arcuate array of (outward-facing) cameras evenly distributed around (at least a portion of) the circumference of the band (or sleeve), collectively spanning at between 25% and 100% of the circumference of the person's wrist, including the distal lateral side of the person's wrist. In another example, a smart watch, watch band, or other wrist-worn device with a camera can comprise: a band (or sleeve) which is configured to be worn on a person's wrist; and an arcuate array of (outward-facing) cameras evenly distributed around (at least a portion of) the circumference of the band (or sleeve), collectively spanning at between 25% and 50% of the circumference of the person's wrist, including the distal lateral side of the person's wrist. For example, a smart watch, watch band, or other wrist-worn device with an adjustable camera can comprise: a band (or sleeve) which is configured to be worn on a person's wrist; and an arcuate array of (outward-facing) cameras evenly distributed around (at least a portion of) the circumference of the band (or sleeve), collectively spanning at between 25% and 75% of the circumference of the person's wrist, including the distal lateral side of the person's wrist.

In one embodiment, a smart watch, watch band, or other wrist-worn device with a camera can comprise: a band (or sleeve) which is configured to be worn on a person's wrist; and an arcuate array of (outward-facing) cameras evenly distributed around (at least a portion of) the circumference of the band (or sleeve), collectively spanning at least 25% of the circumference of the person's wrist, including the distal lateral side of the person's wrist. Alternatively, a smart watch, watch band, or other wrist-worn device with a camera can comprise: a band (or sleeve) which is configured to be worn on a person's wrist; and an arcuate array of (outward-facing) cameras which are centered at clock-hour locations around (at least a portion of) the circumference of the band (or sleeve) and which collectively span at least half of the circumference of the person's wrist. In another example, a smart watch, watch band, or other wrist-worn device with a camera can comprise: a band (or sleeve) which is configured to be worn on a person's wrist; and an arcuate array of (outward-facing) cameras which are distributed around (at least a portion of) the circumference of the band (or sleeve), wherein the arcuate array of (outward-facing) cameras collectively spans at least 25% of the circumference of the person's wrist, wherein a camera in the array is selected by the person to record images at a given time, and wherein the selection of the camera is done by the device recognizing a motion and/or gesture by the person.

In yet another example, a smart watch, watch band, or other wrist-worn electronic device with an adjustable camera can comprise: a band (or sleeve) which is configured to be worn on a person's wrist; and an arcuate array of (outward-facing) cameras which are evenly distributed around (at least a portion of) the circumference of the band (or sleeve) and which collectively span at least half of the circumference of the person's wrist. Alternatively, a smart watch, watch band, or other wrist-worn device with a camera can comprise: a band (or sleeve) which is configured to be worn on a person's wrist; and eight (outward-facing) cameras which are distributed around at least half of the circumference of the band (or sleeve). For example, a smart watch, watch band, or other wrist-worn electronic device with an adjustable camera can comprise: a band (or sleeve) which is configured to be worn on a person's wrist; and five (outward-facing) cameras which are distributed around (at least a portion of) the circumference of the band (or sleeve) and which collectively span at least 25% of the circumference of the person's wrist.

In an example, a smart watch, watch band, or other wrist-worn device with a camera can comprise: a band (or sleeve) which is configured to be worn on a person's wrist; and five (outward-facing) cameras which are evenly (e.g. equidistantly) distributed around (at least a portion of) the circumference of the band (or sleeve) and which collectively span at least 25% of the circumference of the person's wrist. In an alternative embodiment, a smart watch, watch band, or other wrist-worn electronic device with an adjustable camera can comprise: a band (or sleeve) which is configured to be worn on a person's wrist; and four (outward-facing) cameras which are distributed around at least half of the circumference of the band (or sleeve). Alternatively, a smart watch, watch band, or other wrist-worn device with a camera can comprise: a band (or sleeve) which is configured to be worn on a person's wrist; and six (outward-facing) cameras which are distributed around (at least a portion of) the circumference of the band (or sleeve) and which collectively span at least 25% of the circumference of the person's wrist.

In one embodiment, a smart watch, watch band, or other wrist-worn device with a camera can comprise: a band (or sleeve) which is configured to be worn on a person's wrist; and six (outward-facing) cameras which are evenly (e.g. equidistantly) distributed around (at least a portion of) the circumference of the band (or sleeve) and which collectively span at least 25% of the circumference of the person's wrist. In an alternative embodiment, a smart watch, watch band, or other wrist-worn device with a camera can comprise: a display at the 12 o'clock location around a person's wrist, wherein clock locations around the person's wrist are defined relative to 12 o'clock at the middle of the dorsal side and 6 o'clock at the middle of the ventral side; a first camera at the 2 o'clock location around a person's wrist; and a second camera at the 12 o'clock location around a person's wrist. In another example, a smart watch, watch band, or other wrist-worn device with an adjustable camera can comprise: a display at the 12 o'clock location around a person's wrist, wherein clock locations around the person's wrist are defined relative to 12 o'clock at the middle of the dorsal side and 6 o'clock at the middle of the ventral side; and a camera at the 3 o'clock location around a person's wrist.

In an example, a smart watch, watch band, or other wrist-worn device with a camera can comprise: a display at the 9 o'clock location around a person's wrist, wherein clock locations around the person's wrist are defined relative to 12 o'clock at the middle of the dorsal side and 6 o'clock at the middle of the ventral side; a first camera at the 2 o'clock location around a person's wrist; and a second camera at the 12 o'clock location around a person's wrist. For example, a smart watch, watch band, or other wrist-worn device with an adjustable camera can comprise: a display at the 9 o'clock location around a person's wrist, wherein clock locations around the person's wrist are defined relative to 12 o'clock at the middle of the dorsal side and 6 o'clock at the middle of the ventral side; and a camera at the 1 o'clock location around a person's wrist. In another example, a smart watch, watch band, or other wrist-worn electronic device with a camera can comprise: a display which is configured to be worn on a lateral side of a person's wrist; and an (outward-facing) camera which is configured to be worn within a lateral-dorsal quadrant of the circumference of the person's wrist.

In an embodiment of this invention, a smart watch, watch band, or other wrist-worn device with an adjustable camera can comprise: a display which is configured to be worn on a lateral side of a person's wrist; and an (outward-facing) camera which is configured to be worn within a dorsal quadrant of the circumference of the person's wrist. Alternatively, a smart watch, watch band, or other wrist-worn electronic device with a camera can comprise: a display which is configured to be worn on a person's wrist; a camera which is configured to be worn on the person's wrist; and a sound sensor (e.g. microphone) which is configured to be worn on the person's wrist, wherein the camera is automatically activated to take pictures based on data from the sensor. In another example, a smart watch, watch band, or other wrist-worn device with a camera can comprise: a display which is configured to be worn on a person's wrist; a motion and/or gesture sensor which is configured to be worn on the person's wrist; and an (outward-facing) camera which is configured to be worn on the person's wrist, wherein the camera has first configuration with a first focal direction and a second configuration with a second focal direction, and wherein the camera is automatically changed from its first configuration to its second configuration.

In yet another example, a smart watch, watch band, or other wrist-worn electronic device with a camera can comprise: a display which is configured to be worn on the dorsal side of a person's wrist; and an (outward-facing) camera which is configured to be worn on a lateral side of the person's wrist at location which is rotated 90 degrees counter-clockwise around the person's wrist relative to the display. Alternatively, a smart watch, watch band, or other wrist-worn device with an adjustable camera can comprise: a display which is configured to be worn on the dorsal side of a person's wrist; and an (outward-facing) camera which is configured to be worn within a dorsal quadrant of the circumference of the person's wrist. In another example, a smart watch, watch band, or other wrist-worn device with a camera can comprise: a display which is configured to be worn on the ventral side of a person's wrist; and an (outward-facing) camera which is configured to be worn within a lateral-ventral quadrant of the circumference of the person's wrist.

In an example, a smart watch, watch band, or other wrist-worn device with an adjustable camera can comprise: a display which is substantially centered on the 12 o'clock location around a person's wrist, wherein clock locations around the person's wrist are defined relative to 12 o'clock at the middle of the dorsal side and 6 o'clock at the middle of the ventral side; a first camera which is substantially centered on the 4 o'clock location around a person's wrist; and a second camera which is substantially centered on the 12 o'clock location around the person's wrist. Alternatively, a smart watch, watch band, or other wrist-worn device with a camera can comprise: a display which is substantially centered on the 12 o'clock location around a person's wrist, wherein clock locations around the person's wrist are defined relative to 12 o'clock at the middle of the dorsal side and 6 o'clock at the middle of the ventral side; and a camera which is substantially centered on the 1 o'clock location around a person's wrist. Alternatively, a smart watch, watch band, or other wrist-worn device with an adjustable camera can comprise: a display which is substantially centered on the 12 o'clock location around a person's wrist, wherein clock locations around the person's wrist are defined relative to 12 o'clock at the middle of the dorsal side and 6 o'clock at the middle of the ventral side; and a camera which is substantially centered on the 6 o'clock location around a person's wrist.

In yet another example, a smart watch, watch band, or other wrist-worn device with a camera can comprise: a display which is substantially centered on the 9 o'clock location around a person's wrist, wherein clock locations around the person's wrist are defined relative to 12 o'clock at the middle of the dorsal side and 6 o'clock at the middle of the ventral side; and a camera which is substantially centered on the 3 o'clock location around a person's wrist. In an alternative embodiment, a smart watch, watch band, or other wrist-worn electronic device with a camera can comprise: a first (outward-facing) camera which is configured to be worn on a person's wrist on a first side of a person's wrist; a second (outward-facing) camera which is configured to be worn on the person's wrist on a second side of the person's wrist, wherein the second side is opposite the first side; and a display which is configured to be worn on the person's wrist. For example, a smart watch, watch band, or other wrist-worn device with a camera can comprise: a first housing which is configured to be worn on the dorsal side of circumference of a person's wrist; a display on the first housing; a first camera on the first housing; a second housing which is configured to be wom on a lateral side of the circumference of the person's wrist; and a second camera on the second housing.

In an embodiment of this invention, a smart watch, watch band, or other wrist-worn electronic device with an adjustable camera can comprise: a first housing which is configured to be worn on the dorsal side of a person's wrist; a display on the first housing; a second housing which is configured to be worn on the ventral side of the person's wrist; a flip-up component which is substantially parallel to the second housing in a first configuration and is tilted at an angle between 20 and 120 degrees relative to the housing in a second configuration, wherein the flip-up component is changed from its first configuration to its second configuration by pivoting, tilting, and/or rotating upward and/or outward from the second housing; and a camera on the flip-up component, wherein the display functions as a viewfinder for the camera. In another example, a smart watch, watch band, or other wrist-worn device with a camera can comprise: a first housing which is configured to be worn on the dorsal side of a person's wrist; a display on the first housing; a second housing which is configured to be worn on the ventral side of the person's wrist; and a camera on the second housing, wherein the focal direction of the camera is substantially parallel to the outer surface of the second housing. Alternatively, a smart watch, watch band, or other wrist-worn electronic device with an adjustable camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing which pops upward and/or outward from the housing; and a camera on the side of the pop-up component which is closest to the 2 o'clock location.

In an example, a smart watch, watch band, or other wrist-worn device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing which pops upward and/or outward from the housing; a display on the proximal side of the pop-up component; and a camera on the distal side of the pop-up component. For example, a smart watch, watch band, or other wrist-worn device with an adjustable camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing, wherein the pop-up component has a first configuration in which the pop-up component extends a first distance upward and/or outward from the housing, has a second configuration in which the pop-up component extends a second distance upward and/or outward from the housing, and wherein the second distance is between 1 mm and 4 cm greater than the first distance; and a camera on the distal side of the pop-up component. In an alternative embodiment, a smart watch, watch band, or other wrist-worn electronic device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing, wherein the pop-up component has a first configuration in which the pop-up component extends a first distance upward and/or outward from the housing, has a second configuration in which the pop-up component extends a second distance upward and/or outward from the housing, and wherein the second distance is between 1 mm and 4 cm greater than the first distance; a display on the pop-up component; and a camera on the pop-up component.

In one embodiment, a smart watch, watch band, or other wrist-worn device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing, wherein the pop-up component has a first configuration which is recessed within the housing and a second configuration which extends upward and/or outward from the housing; and a camera on the pop-up component. In another example, a smart watch, watch band, or other wrist-worn electronic device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a flip-up component which is substantially parallel to the housing in a first configuration and substantially perpendicular to the housing in a second configuration, wherein the flip-up component is changed from its first configuration to its second configuration by pivoting, tilting, and/or rotating upward and/or outward from the housing; a display on a first side of the flip-up component facing toward the person when the flip-up component is in its second configuration; and a camera on a second side of the flip-up component facing away from the person when the flip-up component is in its second configuration.

In an example, a smart watch, watch band, or other wrist-worn device with an adjustable camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a flip-up component which is substantially parallel to the housing in a first configuration and substantially perpendicular to the housing in a second configuration, wherein the flip-up component is changed from its first configuration to its second configuration by pivoting, tilting, and/or rotating the distal edge of the flip-up component upward and/or outward from the housing; a display on a first side of the flip-up component facing toward the person when the flip-up component is in its second configuration; and a camera on a second side of the flip-up component facing away from the person when the flip-up component is in its second configuration.

In yet another example, a smart watch, watch band, or other wrist-worn device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a flip-up component which is substantially parallel to the housing in a first configuration and is tilted at an angle between 20 and 120 degrees relative to the housing in a second configuration, wherein the flip-up component is changed from its first configuration to its second configuration by pivoting, tilting, and/or rotating an edge of the flip-up component upward and/or outward from the housing; a display on a first side of the flip-up component facing toward the person when the flip-up component is in its second configuration; and a camera on a second side of the flip-up component facing away from the person when the flip-up component is in its second configuration. Alternatively, a smart watch, watch band, or other wrist-worn electronic device with an adjustable camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a flip-up component which is substantially parallel to the housing in a first configuration and substantially perpendicular to the housing in a second configuration, wherein the flip-up component is changed from its first configuration to its second configuration by pivoting, tilting, and/or rotating an edge of the flip-up component upward and/or outward from the housing; and a camera on a side of the flip-up component facing away from the person when the flip-up component is in its second configuration.

In one embodiment, a smart watch, watch band, or other wrist-worn device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a flip-up component which is substantially parallel to the housing in a first configuration and is tilted at an angle between 20 and 120 degrees relative to the housing in a second configuration, wherein the flip-up component is changed from its first configuration to its second configuration by pivoting, tilting, and/or rotating upward and/or outward from the housing; and a camera on a side of the flip-up component facing away from the person when the flip-up component is in its second configuration.

In yet another example, a smart watch, watch band, or other wrist-worn electronic device with an adjustable camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side;

a flip-up component which is substantially parallel to the housing in a first configuration and substantially perpendicular to the housing in a second configuration, wherein the flip-up component is changed from its first configuration to its second configuration by pivoting, tilting, and/or rotating upward and/or outward from the housing; and a camera on the flip-up component. Alternatively, a smart watch, watch band, or other wrist-worn device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a flip-up component which pivots, tilts, and/or rotates upward and/or outward from the housing; a display on a first side of the flip-up component; and a camera on a second side of the flip-up component, wherein the second side is opposite the first side, and wherein the display functions as a viewfinder for the camera. Alternatively, a smart watch, watch band, or other wrist-worn device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a pop-up or lift-up component whose centroid is a first distance from the centroid of the housing in a first configuration and a second distance from the centroid of the housing in a second configuration, wherein the second distance is 1 mm to 4 cm greater than the first distance, and wherein the pop-up or lift-up component is changed from its first configuration to its second configuration by moving upward and/or outward from the housing; a display on a first side of the pop-up or lift-up component; and a camera on a second side of the pop-up or lift-up component, wherein the second side is opposite the first side, and wherein the display functions as a viewfinder for the camera.

In an example, a smart watch, watch band, or other wrist-worn electronic device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a pop-up or lift-up component whose centroid is a first distance from the centroid of the housing in a first configuration and a second distance from the centroid of the housing in a second configuration, wherein the second distance is 1 mm to 4 cm greater than the first distance, and wherein the pop-up or lift-up component is changed from its first configuration to its second configuration by moving upward and/or outward from the housing; a display on the pop-up or lift-up component; and a camera on the pop-up or lift-up component. For example, a smart watch, watch band, or other wrist-worn device with an adjustable camera can comprise: a housing which is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing which pops upward and/or outward from the housing; and a camera on the side of the pop-up component which is closest to the 2 o'clock location. In another example, a smart watch, watch band, or other wrist-worn electronic device with a camera can comprise: a housing which is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing which pops upward and/or outward from the housing; a display on the proximal side of the pop-up component; and a camera on the distal side of the pop-up component.

In yet another example, a smart watch, watch band, or other wrist-worn device with an adjustable camera can comprise: a housing which is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing, wherein the pop-up component has a first configuration in which the pop-up component extends a first distance upward and/or outward from the housing, has a second configuration in which the pop-up component extends a second distance upward and/or outward from the housing, and wherein the second distance is between 1 mm and 4 cm greater than the first distance; and a camera on the distal side of the pop-up component. Alternatively, a smart watch, watch band, or other wrist-worn device with a camera can comprise: a housing which is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing, wherein the pop-up component has a first configuration in which the pop-up component extends a first distance upward and/or outward from the housing, has a second configuration in which the pop-up component extends a second distance upward and/or outward from the housing, and wherein the second distance is between 1 mm and 4 cm greater than the first distance; a display on the pop-up component; and a camera on the pop-up component. In another example, a smart watch, watch band, or other wrist-worn electronic device with an adjustable camera can comprise: a housing which is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing, wherein the pop-up component has a first configuration which is recessed within the housing and a second configuration which extends upward and/or outward from the housing; and a camera on the pop-up component.

In an example, a smart watch, watch band, or other wrist-worn device with a camera can comprise: a housing which is configured to be worn on a person's wrist proximal to the person's first hand; a camera on the housing; wherein the imaging vector (e.g. focal direction) of the camera is automatically moved relative to the housing in order to maintain a line of sight to the person's second hand. In another example, a smart watch, watch band, or other wrist-worn device with a camera can comprise: a housing which is configured to be worn on a person's wrist; a display on the housing; a motion and/or gesture sensor (e.g. accelerometer and/or gyroscope) in the housing; and a camera on the housing, wherein the camera is automatically moved relative to the housing based on data from the motion and/or gesture sensor so as to maintain a constant focal direction relative to the environment. In an alternative embodiment, a smart watch, watch band, or other wrist-worn device with a camera can comprise: a housing which is configured to be worn on a person's wrist; a display on the housing; and a camera on the housing, wherein the focal direction of the camera is automatically moved relative to the housing in order to scan areas near the person.

In an example, a smart watch, watch band, or other wrist-worn device with an adjustable camera can comprise: a housing which is configured to be worn on a person's wrist; a display on the housing; and a camera which is configured to be worn on a person's wrist, wherein the camera is automatically moved to scan areas near the person. Alternatively, a smart watch, watch band, or other wrist-worn device with a camera can comprise: a housing which is configured to be worn on a person's wrist; a flip-up component on the housing, wherein the virtual plane which best fits the flip-up component intersects the housing at a first angle in a first configuration, intersects the housing at a second angle in a second configuration, wherein the second angle is 20 to 120 degrees greater than the first angle, and wherein the flip-up component is changed from its first configuration to its second configuration by being pivoted, tilted, and/or rotated; a display on the flip-up component; and a camera on the flip-up component. For example, a smart watch, watch band, or other wrist-worn device with an adjustable camera can comprise: a housing which is configured to be worn on a person's wrist; a flip-up component on the housing, wherein the virtual plane which best fits the flip-up component intersects the housing at a first angle in a first configuration, intersects the housing at a second angle in a second configuration, wherein the second angle is 20 to 120 degrees greater than the first angle, and wherein the flip-up component is automatically changed from its first configuration to its second configuration by being pivoted, tilted, and/or rotated by an actuator; and a camera on the flip-up component.

In an example, a smart watch, watch band, or other wrist-worn device with a camera can comprise: a housing which is configured to be worn on a person's wrist; a flip-up component which is substantially parallel to the housing in a first configuration and is tilted at an angle between 20 and 120 degrees relative to the housing in a second configuration, wherein the flip-up component is changed from its first configuration to its second configuration by pivoting, tilting, and/or rotating upward and/or outward from the housing; a display on the flip-up component; and a camera on the flip-up component. In another example, a smart watch, watch band, or other wrist-worn electronic device with an adjustable camera can comprise: a housing which is configured to be worn on a person's wrist; a flip-up component, wherein a portion of the flip-up component pivots, tilts, and/or rotates around a joint in an upward and/or outward manner from the housing; a display on the flip-up component; and a camera on the flip-up component. Alternatively, a smart watch, watch band, or other wrist-worn device with a camera can comprise: a housing which is configured to be worn on a person's wrist; a motion and/or gesture sensor (e.g. accelerometer and/or gyroscope) in the housing; and a camera on the housing which is automatically moved relative to the housing based on data from the motion and/or gesture sensor.

In an example, a smart watch, watch band, or other wrist-worn electronic device with a camera can comprise: a housing which is configured to be worn on a person's wrist; a pop-up component which is substantially flush with or recessed within the housing in a first configuration and extends out from the housing in a second configuration, and wherein the pop-up component is changed from its first configuration to its second configuration by pressure from a spring; a display on the pop-up component; and a camera on the pop-up component. Alternatively, a smart watch, watch band, or other wrist-worn device with a camera can comprise: a housing which is configured to be worn on a person's wrist; a pop-up component which is substantially flush with or recessed within the housing in a first configuration and extends outward from the housing in a second configuration; a motion and/or gesture sensor; wherein the pop-up component is automatically changed from its first configuration to its second configuration based on data from the motion and/or gesture sensor; a display on the pop-up component; and a camera on the pop-up component. For example, a smart watch, watch band, or other wrist-worn device with an adjustable camera can comprise: a housing which is configured to be worn on a person's wrist; a pop-up or lift-up component on the housing, wherein the centroid of the pop-up or lift-up component is a first distance from the housing in a first configuration, the centroid of the pop-up or lift-up component is a second distance from the housing in a second configuration, and the second distance is greater than the first distance; wherein the pop-up or lift-up component has a wide outer surface which faces away from the person's wrist, a wide inner surface which faces toward the person's wrist, and a lateral perimeter between the outer surface and the inner surface when the pop-up or lift-up component is in its first configuration; wherein the pop-up or lift-up component changes from its first configuration to its second configuration by moving upward and/or outward from the housing; a display on a first side of the pop-up or lift-up component; and a camera on a second side of the pop-up or lift-up component.

In yet another example, a smart watch, watch band, or other wrist-worn device with a camera can comprise: a housing which is configured to be worn on a person's wrist; a pop-up or lift-up component on the housing, wherein the centroid of the pop-up or lift-up component is a first distance from the housing in a first configuration, the centroid of the pop-up or lift-up component is a second distance from the housing in a second configuration, and the second distance is greater than the first distance; wherein the pop-up or lift-up component has a wide outer surface which faces away from the person's wrist, a wide inner surface which faces toward the person's wrist, and a lateral perimeter between the outer surface and the inner surface when the pop-up or lift-up component is in its first configuration; wherein the pop-up or lift-up component changes from its first configuration to its second configuration by moving upward and/or outward from the housing; and a camera the wide inner surface of the pop-up or lift-up component. In an alternative embodiment, a smart watch, watch band, or other wrist-worn device with an adjustable camera can comprise: a housing which is configured to be worn on a person's wrist; and a camera which is configured to be worn on a person's wrist, wherein the camera is automatically moved to scan areas near the person. Alternatively, a smart watch, watch band, or other wrist-worn device with a camera can comprise: a housing which is configured to be worn on the dorsal side of a person's wrist; a display on the housing; and a camera at the 12 o'clock position on the perimeter of the housing, wherein clock locations around the perimeter of the housing are defined relative to 3 o'clock being closest to the person's middle finger and 9 o'clock being closest to the person's elbow.

In one embodiment, a smart watch, watch band, or other wrist-worn electronic device with an adjustable camera can comprise: a housing which is configured to be worn on the dorsal side of a person's wrist; a display on the housing; and a camera on the housing, wherein the focal direction of the camera is substantially parallel to the outer surface of the housing. In another example, a smart watch, watch band, or other wrist-worn device with a camera can comprise: a housing which is configured to be worn on the dorsal side of a person's wrist; a flip-up component which is substantially parallel to the housing in a first configuration and is tilted at an angle between 20 and 120 degrees relative to the housing in a second configuration, wherein the flip-up component is changed from its first configuration to its second configuration by pivoting, tilting, and/or rotating upward and/or outward from the housing; a display on a first side the flip-up component; and a camera on a second side of the flip-up component, wherein the second side is opposite the first side. For example, a smart watch, watch band, or other wrist-worn electronic device with a camera can comprise: a housing which is configured to be worn on the dorsal side of a person's wrist; a flip-up component which is substantially parallel to the housing in a first configuration and substantially perpendicular to the housing in a second configuration, wherein the flip-up component is changed from its first configuration to its second configuration by pivoting, tilting, and/or rotating upward and/or outward from the housing; and a camera on an edge of the flip-up component.

In yet another example, a smart watch, watch band, or other wrist-worn device with a camera can comprise: a housing which is configured to be worn on the dorsal side of a person's wrist; a pop-up or lift-up component whose centroid is a first distance from the centroid of the housing in a first configuration and a second distance from the centroid of the housing in a second configuration, wherein the second distance is 1 mm to 4 cm greater than the first distance, and wherein the pop-up or lift-up component is changed from its first configuration to its second configuration by moving upward and/or outward from the housing; a display on a side the pop-up or lift-up component; and a camera on an edge of the pop-up or lift-up component, wherein the edge of the pop-up or lift-up component is substantially perpendicular to the side of the pop-up or lift-up component. Alternatively, a smart watch, watch band, or other wrist-worn device with a camera can comprise: a housing which is configured to be worn on the dorsal side of circumference of a person's wrist; a display on the housing; and an (outward-facing) camera which is configured to be worn on a lateral side of the circumference of the person's wrist. Alternatively, a smart watch, watch band, or other wrist-worn device with an adjustable camera can comprise: a housing which is configured to be worn on the ventral side of a person's wrist; a flip-up component which is substantially parallel to the housing in a first configuration and is tilted at an angle between 20 and 120 degrees relative to the housing in a second configuration, wherein the flip-up component is changed from its first configuration to its second configuration by pivoting, tilting, and/or rotating upward and/or outward from the housing; a display on the flip-up component; and a camera on the flip-up component.

In an embodiment of this invention, a smart watch, watch band, or other wrist-worn device with a camera can comprise: a housing which is configured to be worn on the ventral side of a person's wrist; a flip-up component which is substantially parallel to the housing in a first configuration and is tilted at an angle between 20 and 120 degrees relative to the housing in a second configuration, wherein the flip-up component is changed from its first configuration to its second configuration by pivoting, tilting, and/or rotating upward and/or outward from the housing; and a camera on the flip-up component. In another example, a smart watch, watch band, or other wrist-worn electronic device with an adjustable camera can comprise: a housing with a display which is configured to be on a person's wrist; and an (outward-facing) camera on the perimeter of the housing, wherein the central focal vector of the (outward-facing) camera is substantially tangential to the circumference of the person's wrist. In an alternative embodiment, a smart watch, watch band, or other wrist-worn device with a camera can comprise: a housing with a display which is configured to be worn on a person's wrist, wherein the display is substantially tangential to the circumference of the wrist; and an (outward-facing) camera on a side of the housing with a focal direction which is substantially tangential to the circumference of the wrist.

In one embodiment, a smart watch, watch band, or other wrist-worn electronic device with an adjustable camera can comprise: a plurality of (outward-facing) cameras which are configured to be worn on a person's wrist; a display which is configured to be worn on the person's wrist. Alternatively, a smart watch, watch band, or other wrist-worn device with a camera can comprise: a touch-screen display which is configured to be worn on a person's wrist; and a plurality of (outward-facing) cameras which are configured to be worn on the person's wrist; and wherein the person selects one of the adjustable cameras to have its field of view shown by the display. In another example, a smart watch, watch band, or other wrist-worn device with a camera can comprise: a wedge-shaped housing which is configured to be worn on a person's wrist; wherein a proximal portion of the lateral perimeter of the wedge-shaped housing faces generally toward from the person and a distal portion of the lateral perimeter of the wedge-shaped housing faces generally away from the person; wherein the proximal portion of the lateral perimeter of the wedge-shaped housing has a first thickness, the distal portion of the lateral perimeter of the wedge-shaped housing has a second thickness, and the second thickness is between 1 mm and 1 cm greater than the first thickness; a display on a first side of the wedge-shaped housing; and camera on a second side of the wedge-shaped housing.

In an example, a smart watch, watch band, or other wrist-worn device with a camera can comprise: an (outward-facing) camera which is configured to be worn on a person's wrist, wherein face recognition is used to track the location of the person's face; and a display which is configured to be worn on the person's wrist. Alternatively, a smart watch, watch band, or other wrist-worn device with a camera can comprise: an (outward-facing) camera which is configured to be worn on a person's wrist on the person's first (e.g. right or left) arm; wherein gesture recognition or other pattern recognition methods are used to change the focus of the camera to maintain a line of sight to the person's hand on their second (e.g. left or right) arm. Alternatively, a smart watch, watch band, or other wrist-worn device with an adjustable camera can comprise: an (outward-facing) camera which is configured to be worn on the proximal lateral side of a person's wrist; and a display which is configured to be worn on the person's wrist.

In an embodiment of this invention, a smart watch, watch band, or other wrist-worn electronic device with a camera can comprise: an (outward-facing) camera which is configured to be worn within the 1-2 o'clock locations around a person's wrist; a display of which at least 75% is configured to be worn between 10 o'clock and 2 o'clock locations around a person's wrist; wherein clock locations around the person's wrist are defined relative to 12 o'clock at the middle of the dorsal side and 6 o'clock at the middle of the ventral side. In another example, a smart watch, watch band, or other wrist-worn device with an adjustable camera can comprise: an (outward-facing) camera which is configured to be worn within the 4-5 o'clock locations around a person's wrist; a display which is configured to be worn at the 9 o'clock location on the circumference of a person's wrist; wherein clock locations around the person's wrist are defined relative to 12 o'clock at the middle of the dorsal side and 6 o'clock at the middle of the ventral side. Alternatively, a smart watch, watch band, or other wrist-worn electronic device with a camera can comprise: an (outward-facing) camera which is configured to be worn within the 4-5 o'clock locations around a person's wrist; a display which is configured to be worn within the 7-8 o'clock locations around a person's wrist; wherein clock locations around the person's wrist are defined relative to 12 o'clock at the middle of the dorsal side and 6 o'clock at the middle of the ventral side.

In an example, a smart watch, watch band, or other wrist-worn device with an adjustable camera can comprise: two cameras attached to a wrist band (or sleeve) on opposite (narrow) sides of the person's wrist; and a display which is configured to be worn on the dorsal side of a person's wrist. Alternatively, a smart watch, watch band, or other wrist-worn device with a camera can comprise: two cameras which are configured to be worn on the narrow sides of a person's wrist, between the dorsal and ventral surfaces of the wrist; and a display which is configured to be worn on the dorsal side of person's wrist. For example, a smart watch, watch band, or other wrist-worn device with a camera can comprise: two cameras which are configured to be worn on the narrow sides of a person's wrist, between the dorsal and ventral surfaces of the wrist; and a display which is configured to be worn on the person's wrist, wherein the display can selectively act as a view finder for one or both of the cameras. In an alternative embodiment, a smart watch, watch band, or other wrist-worn device with a camera can comprise: a band (or sleeve) which is configured to be worn on a person's wrist; a display on the band (or sleeve); a first camera with a field of view with a first width; and a second (“wide-angle”) camera with a field of view with a second width, wherein the second width is at least twice the first width.

In yet another example, a smart watch, watch band, or other wrist-worn device with a camera can comprise: a band (or sleeve) which is configured to be worn on a person's wrist; a display on the band (or sleeve); a first camera with a first focal distance; and a second (“zoom”) camera with a second focal distance, wherein the second focal distance is at least twice the first focal distance. Alternatively, a smart watch, watch band, or other wrist-worn device with a camera can comprise: a band (or sleeve) which is configured to be worn on a person's wrist; a display on the band (or sleeve); a motion and/or gesture sensor on the band (or sleeve); a camera on the band (or sleeve); and an actuator on the band, wherein the focal distance and/or focal direction of the camera is automatically changed by the actuator based on movement of the band which is detected by the motion and/or gesture sensor.

In an example, a smart watch, watch band, or other wrist-worn device with a camera can comprise: a band (or sleeve) which is configured to be worn on a person's wrist; a display on the band (or sleeve); a motion and/or gesture sensor on the band (or sleeve); a camera on the band (or sleeve); and an actuator on the band, wherein the focal distance and/or focal direction of the camera is automatically changed by the actuator based on movement of the band which is detected by the motion and/or gesture sensor in order to optically track (e.g. maintain imaging of) the person's face. In another example, a smart watch, watch band, or other wrist-worn electronic device with an adjustable camera can comprise: a band (or sleeve) which is configured to be worn on a person's wrist; a display on the band (or sleeve); and an arcuate array of (outward-facing) cameras, wherein the cameras and the display collectively are evenly distributed around at least one-quarter of the circumference of the band (or sleeve). For example, a smart watch, watch band, or other wrist-worn device with a camera can comprise: a band (or sleeve) which is configured to be worn on a person's wrist; a display on the band (or sleeve); and an arcuate array of (outward-facing) cameras, wherein the cameras and the display collectively are evenly distributed around at least one-quarter of the circumference of the person's wrist.

In yet another example, a smart watch, watch band, or other wrist-worn electronic device with an adjustable camera can comprise: a band (or sleeve) which is configured to be worn on a person's wrist; a display which is centered at a first clock-hour location around the circumference of band (or sleeve); and a camera which is centered at a second clock-hour location around the circumference of band (or sleeve), wherein the first clock-hour location differs from the second clock-hour location by 1 hour. In another example, a smart watch, watch band, or other wrist-worn device with a camera can comprise: a band (or sleeve) which is configured to be worn on a person's wrist; a display which is centered at a first clock-hour location around the circumference of band (or sleeve); and a camera which is centered at a second clock-hour location around the circumference of band (or sleeve), wherein the first clock-hour location differs from the second clock-hour location by between 3 and 6 hours. In an alternative embodiment, a smart watch, watch band, or other wrist-worn device with a camera can comprise: a band (or sleeve) which is configured to be worn on a person's wrist; a display which is centered at a first location on the circumference of band (or sleeve) with a first polar coordinate; a first camera which is centered at a second location on the circumference of band (or sleeve) with a second polar coordinate; and a second camera which is centered at a third location on the circumference of band (or sleeve) with a third polar coordinate; wherein the angle of the second polar coordinate differs from the angle of the first polar coordinate by 90 degrees, wherein the angle of the third polar coordinate differs from the angle of the first polar coordinate by 45 degrees, and wherein the angle of the third polar coordinate differs from the angle of the second coordinate by 135 degrees.

In an example, a smart watch, watch band, or other wrist-worn device with a camera can comprise: a band (or sleeve) which is configured to be worn on a person's wrist; a display which is centered at a first location on the circumference of band (or sleeve) with a first polar coordinate; and a camera which is centered at a second location on the circumference of band (or sleeve) with a second polar coordinate, wherein the angle of the second polar coordinate differs from the angle of the first polar coordinate by 45 degrees. Alternatively, a smart watch, watch band, or other wrist-worn device with an adjustable camera can comprise: a band (or sleeve) which is configured to be worn on a person's wrist; a display which is centered at a first location on the circumference of band (or sleeve) with a first polar coordinate; and a camera which is centered at a second location on the circumference of band (or sleeve) with a second polar coordinate, wherein the angle of the second polar coordinate differs from the angle of the first polar coordinate by between 45 and 90 degrees. For example, a smart watch, watch band, or other wrist-worn device with a camera can comprise: a band (or sleeve) which is configured to be worn on a person's wrist; a first camera which is centered at a first location on the circumference of band (or sleeve) with a first polar coordinate; a display which is centered at a second location on the circumference of band (or sleeve) with a second polar coordinate; and a second camera which is centered at a third location on the circumference of band (or sleeve) with a third polar coordinate; wherein the angle of the second polar coordinate differs from the angle of the first polar coordinate by between 40 and 50 degrees, wherein the angle of the third polar coordinate differs from the angle of the second polar coordinate by between 40 and 50 degrees, and wherein the angle of the third polar coordinate differs from the angle of the first coordinate by between 80 and 100 degrees.

In one embodiment, a smart watch, watch band, or other wrist-worn electronic device with a camera can comprise: a band (or sleeve) which is configured to be worn on a person's wrist; a housing on the band (or sleeve) on the dorsal side of the person's wrist; a transparent convex component on the housing which extends outward from the person's wrist; and a camera on the housing under the transparent convex component, wherein the camera is automatically rotated and/or tilted relative to the housing by an actuator in order to change the camera's focal direction. Alternatively, a smart watch, watch band, or other wrist-worn device with a camera can comprise: a band (or sleeve) which is configured to be worn on a person's wrist; a housing on the band (or sleeve) on the ventral side of the person's wrist; a transparent convex component on the housing which extends outward from the person's wrist; and a camera on the housing under the transparent convex component, wherein the camera can be rotated and/or tilted relative to the housing in order to change the camera's focal direction. In another example, a smart watch, watch band, or other wrist-worn electronic device with a camera can comprise: a band (or sleeve) which is configured to be worn on a person's wrist; a housing on the band (or sleeve) on the ventral side of the person's wrist; a transparent dome on the housing which extends outward from the person's wrist; and a camera on the housing under the transparent dome, wherein the camera is automatically rotated and/or tilted relative to the housing by an actuator in order to change the camera's focal direction.

In an example, a smart watch, watch band, or other wrist-worn device with an adjustable camera can comprise: a band (or sleeve) which is configured to be worn on a person's wrist; a housing on the band (or sleeve) which extends between 1 cm and 3 cm outward from the band (or sleeve); a display on the housing; and a plurality of cameras distributed around the lateral (narrow) perimeter of the housing. Alternatively, a smart watch, watch band, or other wrist-worn device with a camera can comprise: a band (or sleeve) which is configured to be worn on a person's wrist; a housing on the band (or sleeve) which extends between 5 mm and 2 cm outward from the band (or sleeve); a display on the housing; and a plurality of cameras which are evenly (e.g. equidistantly) distributed around the lateral (narrow) perimeter of the housing, wherein central focal vectors of the cameras are parallel to vectors which are tangential to the circumference of the band (or sleeve). In another example, a smart watch, watch band, or other wrist-worn device with a camera can comprise: a band (or sleeve) which is configured to be worn on a person's wrist; a housing on the band (or sleeve) which extends between 5 mm and 2 cm outward from the band (or sleeve); a touch-screen display on the housing; and a plurality of cameras distributed around the lateral (narrow) perimeter of the housing, wherein the person selects one of the plurality of cameras for imaging at a given time by touching or swiping the display.

In one embodiment, a smart watch, watch band, or other wrist-worn device with a camera can comprise: a band (or sleeve) which is configured to be worn on a person's wrist; a housing on the band (or sleeve) which extends outward from the band (or sleeve); a display on the housing; a rotating ring or bezel on the housing; and a plurality of cameras evenly (e.g. equidistantly) distributed around the perimeter of the ring or bezel, wherein the person changes the focal directions of the cameras by rotating the ring or bezel. Alternatively, a smart watch, watch band, or other wrist-worn device with an adjustable camera can comprise: a band (or sleeve) which is configured to be worn on a person's wrist; a housing on the band (or sleeve) which extends outward from the band (or sleeve); a display on the housing; and four or more cameras evenly (e.g. equidistantly) distributed around the lateral (narrow) perimeter of the housing, wherein central focal vectors of the cameras are parallel to vectors which are tangential to the circumference of the band (or sleeve). In another example, a smart watch, watch band, or other wrist-worn electronic device with a camera can comprise: a band (or sleeve) which is configured to be worn on a person's wrist; a housing on the band (or sleeve) which extends outward from the band (or sleeve); a display on the housing; a rotating ring or bezel on the housing; and a plurality of cameras distributed around the perimeter of the ring or bezel, wherein the person changes the focal directions of the cameras by rotating the ring or bezel.

In yet another example, a smart watch, watch band, or other wrist-worn device with a camera can comprise: a band (or sleeve) which is configured to be worn on a person's wrist; a housing on the band (or sleeve) which extends outward from the band (or sleeve); a display on the housing; and four or more cameras distributed around the lateral (narrow) perimeter of the housing, wherein central focal vectors of the cameras are parallel to vectors which are tangential to the circumference of the band (or sleeve). Alternatively, a smart watch, watch band, or other wrist-worn electronic device with a camera can comprise: a band (or sleeve) which is configured to be worn on a person's wrist; a housing on the band (or sleeve) which extends outward from the band (or sleeve); a display on the housing; and four cameras on the lateral (narrow) perimeter of the housing. In an alternative embodiment, a smart watch, watch band, or other wrist-worn device with an adjustable camera can comprise: a band (or sleeve) which is configured to be worn on a person's wrist; a housing on the band (or sleeve) which extends outward from the band (or sleeve); a display on the housing; a rotating ring or bezel on the housing; and a camera on the perimeter of the ring or bezel, wherein the person changes the focal direction of the camera by rotating the ring or bezel.

In an example, a smart watch, watch band, or other wrist-worn device with a camera can comprise: a band (or sleeve) which is configured to be worn on a person's wrist; a housing on the band (or sleeve) which extends outward from the band (or sleeve); a rotating ring or bezel on the housing; a display on the housing; and a plurality of cameras evenly (e.g. equidistantly) distributed around the lateral (narrow) perimeter of the housing, wherein the person selects one of the plurality of cameras for imaging at a given time by rotating the ring or bezel. Alternatively, a smart watch, watch band, or other wrist-worn device with a camera can comprise: a band (or sleeve) which is configured to be worn on a person's wrist; a housing on the band (or sleeve) with a display; and an arcuate array of (outward-facing) cameras which are distributed around (at least a portion of) the circumference of the band (or sleeve), wherein the arcuate array of (outward-facing) cameras collectively spans at least 25% of the circumference of the person's wrist, wherein a camera in the array is selected by the person to record images at a given time, and wherein the selection of the camera is done by the person rotating a ring or bezel on the housing. In an alternative embodiment, a smart watch, watch band, or other wrist-worn device with a camera can comprise: a band (or sleeve) which is configured to be worn on a person's wrist; a housing on the band (or sleeve) with a display; and an arcuate array of (outward-facing) cameras which are evenly (e.g. equidistantly) distributed around (at least a portion of) the circumference of the band (or sleeve), wherein the arcuate array of (outward-facing) cameras collectively spans at least 25% of the circumference of the person's wrist, wherein a camera in the array is selected by the person to record images at a given time, and wherein the selection of the camera is done by the person rotating a ring or bezel on the housing.

In yet another example, a smart watch, watch band, or other wrist-worn device with an adjustable camera can comprise: a band (or sleeve) which is configured to be worn on a person's wrist; a housing on the band (or sleeve) with a transparent convex surface (e.g. transparent dome) which extends outward from the band (or sleeve); and a camera on the housing under the transparent convex surface, wherein the focal direction of the camera is automatically changed when an actuator rotates the camera. In another example, a smart watch, watch band, or other wrist-worn electronic device with a camera can comprise: a band (or sleeve) which is configured to be worn on a person's wrist; a housing on the band (or sleeve), wherein the housing further comprises a rotating turret, bezel, or ring; and a plurality of cameras distributed around the lateral (narrow) perimeter of rotating turret, bezel, or ring. For example, a smart watch, watch band, or other wrist-worn device with a camera can comprise: a band (or sleeve) which is configured to be worn on a person's wrist; a housing on the band (or sleeve), wherein the housing further comprises a turret, bezel, or ring which can be manually rotated; and a plurality of cameras on the lateral (narrow) perimeter of the rotating turret, bezel, or ring; wherein the turret, bezel, or ring rotates in a plane which is substantially parallel to the closest plane which is tangential to the circumference of the band (or sleeve).

In an example, a smart watch, watch band, or other wrist-worn electronic device with a camera can comprise: a band (or sleeve) which is configured to be worn on a person's wrist; a housing on the band (or sleeve), wherein the housing further comprises a rotating turret; and a plurality of cameras on the rotating turret. In another example, a smart watch, watch band, or other wrist-worn device with an adjustable camera can comprise: a band (or sleeve) which is configured to be worn on a person's wrist; a housing on the band (or sleeve), wherein the housing further comprises a rotating turret, bezel, or ring; and at least one camera on the lateral (narrow) perimeter of the rotating turret, bezel, or ring. Alternatively, a smart watch, watch band, or other wrist-worn device with a camera can comprise: a band (or sleeve) which is configured to be worn on a person's wrist; a housing on the band (or sleeve), wherein the housing further comprises a rotating turret, bezel, or ring; and at least one camera on the rotating turret, bezel, or ring.

In an example, a smart watch, watch band, or other wrist-worn device with a camera can comprise: a band (or sleeve) which is configured to be worn on a person's wrist; a housing on the band (or sleeve); a camera on the housing; and a lens which is moved by electromagnetic means, wherein the focal distance of the camera is changed by movement of the lens. For example, a smart watch, watch band, or other wrist-worn device with a camera can comprise: a band (or sleeve) which is configured to be worn on a person's wrist; a housing on the band (or sleeve); a display on a first side of the housing; a first camera on the first side of the housing; and a second camera on a second side of the housing, wherein the second side is perpendicular to the first side. Alternatively, a smart watch, watch band, or other wrist-worn device with an adjustable camera can comprise: a band (or sleeve) which is configured to be worn on a person's wrist; a housing on the band (or sleeve); a flip-up or pop-up component on the housing; a display on a first side of the flip-up or pop-up component; a first camera on the first side of the flip-up or pop-up component; and a second camera on a second side of the flip-up or pop-up component, wherein the second side is opposite the first side.

In an embodiment of this invention, a smart watch, watch band, or other wrist-worn electronic device with a camera can comprise: a band (or sleeve) which is configured to be worn on a person's wrist; a housing on the band (or sleeve); a pop-up, flip-up, or tilt-up component on the housing with a first configuration in which the centroid of the pop-up, flip-up, or tilt-up component is a first distance from the side of the housing which is closest to the person's wrist and a second configuration in which the centroid of the pop-up, flip-up, or tilt-up component is a second distance from the side of the housing which is closest to the person's wrist, wherein the second distance is 2 mm to 4 cm greater than the first distance; a camera on the pop-up, flip-up, or tilt-up component; a motion and/or gesture sensor on the band (or sleeve); and an actuator on the band (or sleeve); wherein the pop-up, flip-up, or tilt-up component is automatically moved by the actuator from its first configuration to its second configuration when the person makes a selected motion and/or gesture as detected by the motion and/or gesture sensor. In another example, a smart watch, watch band, or other wrist-worn device with an adjustable camera can comprise: a band (or sleeve) which is configured to be worn on a person's wrist; a housing on the band (or sleeve); a pop-up, flip-up, or tilt-up component on the housing with a first configuration in which the centroid of the pop-up, flip-up, or tilt-up component is a first distance from the side of the housing which is closest to the person's wrist and a second configuration in which the centroid of the pop-up, flip-up, or tilt-up component is a second distance from the side of the housing which is closest to the person's wrist, wherein the second distance is 2 mm to 4 cm greater than the first distance; a touch-screen display on a first side of the pop-up, flip-up, or tilt-up component; and camera on a second side of the pop-up, flip-up, or tilt-up component; wherein the pop-up, flip-up, or tilt-up component is automatically popped up, flipped up, or tilted up from its first configuration to its second configuration when the person makes a selected touch or swipe motion on the touch-screen display.

In an example, a smart watch, watch band, or other wrist-worn electronic device with a camera can comprise: a band (or sleeve) which is configured to be worn on a person's wrist; a housing on the band (or sleeve); a pop-up, flip-up, or tilt-up component on the housing with a first configuration in which the centroid of the pop-up, flip-up, or tilt-up component is a first distance from the side of the housing which is closest to the person's wrist and a second configuration in which the centroid of the pop-up, flip-up, or tilt-up component is a second distance from the side of the housing which is closest to the person's wrist, wherein the second distance is 2 mm to 4 cm greater than the first distance; a touch-screen display on a first side of the pop-up, flip-up, or tilt-up component; a first camera on the first side of the pop-up, flip-up, or tilt-up component; and a second camera on a second side of the pop-up, flip-up, or tilt-up component, wherein the second side is perpendicular to the first side; wherein the pop-up, flip-up, or tilt-up component is automatically popped up, flipped up, or tilted up from its first configuration to its second configuration when the person makes a selected touch or swipe motion on the touch-screen display.

In yet another example, a smart watch, watch band, or other wrist-worn device with an adjustable camera can comprise: a band (or sleeve) which is configured to be worn on a person's wrist; a housing on the band (or sleeve); a transparent convex component on the housing which extends outward from the person's wrist; and a camera on the housing under the transparent convex component, wherein the camera can be rotated and/or tilted relative to the housing in order to change the camera's focal direction. In another example, a smart watch, watch band, or other wrist-worn device with a camera can comprise: a band (or sleeve) which is configured to be worn on a person's wrist; a housing on the band (or sleeve); a transparent dome on the housing which extends outward from the person's wrist; and a camera on the housing under the transparent dome, wherein the camera can be rotated and/or tilted relative to the housing in order to change the camera's focal direction. Alternatively, a smart watch, watch band, or other wrist-worn device with a camera can comprise: a band (or sleeve) which is configured to be worn on a person's wrist; a housing on the band (or sleeve); a transparent portion of a sphere on the housing which extends outward from the person's wrist; and a camera under the transparent portion of a sphere, wherein the camera is automatically rotated and/or tilted relative to the housing by an actuator in order to change the camera's focal direction.

In one embodiment, a smart watch, watch band, or other wrist-worn device with a camera can comprise: a band (or sleeve) which is configured to be worn on a person's wrist; a housing on the band (or sleeve); a transparent prism on the housing which extends outward from the person's wrist; and a camera under the transparent prism, wherein the camera is rotated and/or tilted relative to the housing in order to change the camera's focal direction. Alternatively, a smart watch, watch band, or other wrist-worn device with an adjustable camera can comprise: a band (or sleeve) which is configured to be worn on a person's wrist; a housing on the band (or sleeve); and a camera which can be reversibly detached from the housing by sliding, popping, or pulling the camera out of an opening in the housing, wherein the camera is in wireless communication with the housing when it is detached from the housing so that the camera can be used to record images even when the camera is detached from the housing. In another example, a smart watch, watch band, or other wrist-worn electronic device with a camera can comprise: a band (or sleeve) which is configured to be worn on a person's wrist; a housing on the dorsal side of the band (or sleeve); a display on a first side of the housing; a first camera on the first side of the housing; and a second camera on a second side of the housing, wherein the second side is perpendicular to the first side.

In yet another example, a smart watch, watch band, or other wrist-worn device with an adjustable camera can comprise: a band (or sleeve) which is configured to be worn on a person's wrist; a housing on the dorsal side of the band (or sleeve); a flip-up or pop-up component on the housing; a display on a first side of the flip-up or pop-up component; and a camera on a second side of the flip-up or pop-up component, wherein the second side is perpendicular to the first side. In another example, a smart watch, watch band, or other wrist-worn electronic device with an adjustable camera can comprise: a band (or sleeve) which is configured to be worn on a person's wrist; a motion and/or gesture sensor on the band (or sleeve); and a plurality of (outward-facing) cameras which collectively span at least one quarter of the circumference of the band (or sleeve), wherein the person selects which one of the plurality of (outward-facing) cameras to use at a given time by making a movement or gesture. Alternatively, a smart watch, watch band, or other wrist-worn device with a camera can comprise: a band (or sleeve) which is configured to be worn on a person's wrist; a moving portion which slides along at least a portion of the circumference of the band (or sleeve); and an (outward-facing) camera on the moving portion.

In an embodiment of this invention, a smart watch, watch band, or other wrist-worn device with a camera can comprise: a band (or sleeve) which is configured to be worn on a person's wrist; a removable housing which can be removed from the band (or sleeve) by unplugging, unsnapping, or uncoupling the housing from the band (or sleeve); wherein the housing remains connected to the band (or sleeve) by a flexible component (such as a wire, cord, or strap) even when the housing is removed from the band (or sleeve); and a camera on the removable housing, wherein the camera is in electronic (wired or wireless) communication with the band (or sleeve) when the housing is removed from the band (or sleeve) so that the camera can be used to record images even when the housing is removed from the band (or sleeve). Alternatively, a smart watch, watch band, or other wrist-worn device with an adjustable camera can comprise: a band (or sleeve) which is configured to be worn on a person's wrist; a touch-screen display on the band (or sleeve); and a plurality of (outward-facing) cameras which collectively span at least one quarter of the circumference of the band (or sleeve), wherein the person selects which one of the plurality of (outward-facing) cameras to use at a given time by touching and/or swiping the display. For example, a smart watch, watch band, or other wrist-worn device with a camera can comprise: a band (or sleeve) which is configured to be worn on a person's wrist; and a camera which can be removed from the band (or sleeve) by unplugging, unsnapping, or uncoupling the camera from the band (or sleeve), wherein the camera remains connected to the band (or sleeve) by a flexible component (such as a wire, cord, or strap) even when the camera is removed from the band (or sleeve), wherein the camera is in electronic (wired or wireless) communication with the band (or sleeve) when it is removed from the band (or sleeve) so that the camera can be used to record images even when the camera is removed from the band (or sleeve).

In yet another example, a smart watch, watch band, or other wrist-worn device with an adjustable camera can comprise: a band (or sleeve) which is configured to be worn on a person's wrist; and a camera which can be reversibly detached from the band (or sleeve) by unplugging, unsnapping, or uncoupling the camera from the band (or sleeve), wherein the camera is in wireless communication with the band (or sleeve) when it is detached from the band (or sleeve) so that the camera can be used to record images even when the camera is detached from the band (or sleeve). In an alternative embodiment, a smart watch, watch band, or other wrist-worn device with a camera can comprise: a band (or sleeve) which is configured to be worn on a person's wrist; and a plurality of (outward-facing) cameras distributed around at least one quarter of the circumference of the person's wrist, wherein angles between the polar coordinate locations of two proximal (e.g. adjacent) cameras are no greater than 45 degrees. Alternatively, a smart watch, watch band, or other wrist-worn device with a camera can comprise: a band (or sleeve) which is configured to be worn on a person's wrist; and a plurality of (outward-facing) cameras distributed around at least one half of the circumference of the band (or sleeve), wherein angles between the polar coordinate locations of two proximal (e.g. adjacent) cameras are no greater than 30 degrees.

In one embodiment, a smart watch, watch band, or other wrist-worn electronic device with a camera can comprise: a band (or sleeve) which is configured to be worn on a person's wrist; and a plurality of (outward-facing) cameras distributed around at least one half of the circumference of the person's wrist, wherein angles between the polar coordinate locations of two proximal (e.g. adjacent) cameras are no greater than 15 degrees. In an alternative embodiment, a smart watch, watch band, or other wrist-worn device with an adjustable camera can comprise: a band (or sleeve) which is configured to be worn on a person's wrist; and a plurality of (outward-facing) cameras evenly (e.g. equidistantly) distributed around at least one quarter of the circumference of the person's wrist, wherein angles between the polar coordinate locations of two proximal (e.g. adjacent) cameras are no greater than 45 degrees. In another example, a smart watch, watch band, or other wrist-worn electronic device with a camera can comprise: a band (or sleeve) which is configured to be worn on a person's wrist; and a plurality of (outward-facing) cameras evenly (e.g. equidistantly) distributed around at least one half of the circumference of the band (or sleeve), wherein angles between the polar coordinate locations of two proximal (e.g. adjacent) cameras are no greater than 30 degrees.

In an example, a smart watch, watch band, or other wrist-worn device with an adjustable camera can comprise: a band (or sleeve) which is configured to be worn on a person's wrist; and a plurality of (outward-facing) cameras evenly (e.g. equidistantly) distributed around at least one half of the circumference of the person's wrist, wherein angles between the polar coordinate locations of two proximal (e.g. adjacent) cameras are no greater than 15 degrees. For example, a smart watch, watch band, or other wrist-worn device with an adjustable camera can comprise: a band (or sleeve) which is configured to be worn on a person's wrist, wherein the band (or sleeve) further comprises an arcuate array of connectors, ports, or sockets which spans at least half of the circumference of the person's wrist; and a plurality of (outward-facing) cameras which can be selectively and removably attached to any of the connectors, ports, or sockets in the array. Alternatively, a smart watch, watch band, or other wrist-worn device with a camera can comprise: a band (or sleeve) which is configured to be worn on a person's wrist, wherein the band (or sleeve) further comprises a circumferential array of connectors, ports, or sockets; and a plurality of (outward-facing) cameras which can be selectively detached from and re-attached to any of the connectors, ports, or sockets in the array.

In an embodiment of this invention, a smart watch, watch band, or other wrist-worn device with an adjustable camera can comprise: a band (or sleeve) which is configured to be worn on a person's wrist, wherein the band (or sleeve) further comprises an arcuate array of connectors, ports, or sockets which spans at least three-quarters of the circumference of the person's wrist; and a plurality of (outward-facing) cameras which can be selectively detached from and re-attached to any of the connectors, ports, or sockets in the array. In another example, a smart watch, watch band, or other wrist-worn device with a camera can comprise: a band (or sleeve) which is configured to be worn on a person's wrist; and a plurality of (outward-facing) cameras which collectively span at least half of the circumference of the person's wrist, wherein the person selects which one of the plurality of (outward-facing) cameras to use at a given time by making a movement or gesture. Alternatively, a smart watch, watch band, or other wrist-worn electronic device with an adjustable camera can comprise: a band (or sleeve) which is configured to be worn on a person's wrist; and an (outward-facing) camera on the band (or sleeve), wherein the camera can be manually moved to different locations on the circumference of band (or sleeve).

In an example, a smart watch, watch band, or other wrist-worn device with a camera can comprise: a band (or sleeve) which is configured to be worn on a person's wrist, wherein the band (or sleeve) further comprises a central (partial) ring and an outer (partial) ring, wherein the central (partial) ring is closer to the center of the band (or sleeve) than the outer (partial) ring, and wherein the central (partial) ring moves circumferentially relative to the outer (partial) ring; and an (outward-facing) camera on the central (partial) ring. In another example, a smart watch, watch band, or other wrist-worn electronic device with a camera can comprise: a band (or sleeve) which is configured to be worn on a person's wrist, wherein the band (or sleeve) further comprises a proximal (partial) ring and a distal (partial) ring, wherein the proximal (partial) ring is closer to the person's elbow than the distal (partial) ring, and wherein the distal (partial) ring is rotated or slid relative to the proximal (partial) ring; and an (outward-facing) camera on the distal (partial) ring. Alternatively, a smart watch, watch band, or other wrist-worn device with a camera can comprise: a band (or sleeve) which is configured to be worn on a person's wrist, wherein the band (or sleeve) further comprises an inner (partial) ring and an outer (partial) ring, wherein the outer (partial) ring is rotated or slid relative to the inner (partial) ring; and an (outward-facing) camera on the outer (partial) ring.

In an example, a smart watch, watch band, or other wrist-worn device with an adjustable camera can comprise: a band (or sleeve) which is configured to be worn on a person's wrist, wherein the band (or sleeve) further comprises a proximal (partial) ring and a distal (partial) ring, wherein the proximal (partial) ring is closer to the person's elbow than the distal (partial) ring, and wherein the proximal (partial) ring moves circumferentially relative to the distal (partial) ring; and an (outward-facing) camera on the proximal (partial) ring. In another example, a smart watch, watch band, or other wrist-worn device with a camera can comprise: a band (or sleeve) which is configured to be worn on a person's wrist, wherein the band (or sleeve) further comprises a first portion and a second portion, wherein the second portion moves circumferentially relative to the first portion; and an (outward-facing) camera on the second portion. Alternatively, a smart watch, watch band, or other wrist-worn device with an adjustable camera can comprise: a band (or sleeve) which is configured to be worn on a person's wrist, wherein the band (or sleeve) has a track or channel around at least a portion of its circumference; and an (outward-facing) camera which can be moved circumferentially along the track or channel to different locations on the circumference of the band (or sleeve).

In an example, a smart watch, watch band, or other wrist-worn device with a camera can comprise: a band (or sleeve) which is configured to be worn on a person's wrist, wherein the band (or sleeve) further comprises an arcuate array of connectors, ports, or sockets which spans at least half of the circumference of the person's wrist; and an (outward-facing) camera which can be selectively and removably attached to any of the connectors, ports, or sockets in the array. Alternatively, a smart watch, watch band, or other wrist-worn device with an adjustable camera can comprise: a band (or sleeve) which is configured to be worn on a person's wrist, wherein the band (or sleeve) further comprises a circumferential array of connection ports; and an (outward-facing) camera which can be selectively and removably attached to any one of the connection ports in the array. In an alternative embodiment, a smart watch, watch band, or other wrist-worn electronic device with a camera can comprise: a band (or sleeve) which is configured to be worn on a person's wrist, wherein the band (or sleeve) further comprises an arcuate array of connectors, ports, or sockets which spans at least half of the circumference of the person's wrist; and an (outward-facing) camera which can be selectively detached from and re-attached to any of the connectors, ports, or sockets in the array.

In yet another example, a smart watch, watch band, or other wrist-worn device with a camera can comprise: a band (or sleeve) which is configured to be worn on a person's wrist, wherein the band (or sleeve) has a track or channel around at least a portion of its circumference; and an (outward-facing) camera which slides along the track or channel to different locations on the circumference of the band (or sleeve). In another example, a smart watch, watch band, or other wrist-worn electronic device with a camera can comprise: a band (or sleeve) which is configured to be worn on a person's wrist; and an arcuate array of (outward-facing) cameras distributed around (at least a portion of) the circumference of the band (or sleeve), collectively spanning at least 25% of the circumference of the person's wrist. For example, a smart watch, watch band, or other wrist-worn device with an adjustable camera can comprise: a band (or sleeve) which is configured to be worn on a person's wrist; and an arcuate array of (outward-facing) cameras distributed around (at least a portion of) the circumference of the band (or sleeve), collectively spanning at least 25% of the circumference of the band (or sleeve).

In one embodiment, a smart watch, watch band, or other wrist-worn electronic device with a camera can comprise: a band (or sleeve) which is configured to be worn on a person's wrist; and an arcuate array of (outward-facing) cameras distributed around (at least a portion of) the circumference of the band (or sleeve), collectively spanning at least 25% of the circumference of the person's wrist, including the distal lateral side of the person's wrist. Alternatively, a smart watch, watch band, or other wrist-worn device with an adjustable camera can comprise: a band (or sleeve) which is configured to be worn on a person's wrist; and an arcuate array of (outward-facing) cameras distributed around (at least a portion of) the circumference of the band (or sleeve), collectively spanning at least 25% of the circumference of the band (or sleeve), including the distal lateral side of the band (or sleeve). In another example, a smart watch, watch band, or other wrist-worn electronic device with a camera can comprise: a band (or sleeve) which is configured to be worn on a person's wrist; and an arcuate array of (outward-facing) cameras evenly (e.g. equidistantly) distributed around (at least a portion of) the circumference of the band (or sleeve), collectively spanning at least 25% of the circumference of the person's wrist.

In yet another example, a smart watch, watch band, or other wrist-worn device with an adjustable camera can comprise: a band (or sleeve) which is configured to be worn on a person's wrist; and an arcuate array of (outward-facing) cameras evenly (e.g. equidistantly) distributed around (at least a portion of) the circumference of the band (or sleeve), collectively spanning at least 25% of the circumference of the band (or sleeve). In an alternative embodiment, a smart watch, watch band, or other wrist-worn device with a camera can comprise: a band (or sleeve) which is configured to be worn on a person's wrist; and an arcuate array of (outward-facing) cameras evenly (e.g. equidistantly) distributed around (at least a portion of) the circumference of the band (or sleeve), collectively spanning at least 25% of the circumference of the person's wrist, including the distal lateral side of the person's wrist. For example, a smart watch, watch band, or other wrist-worn device with a camera can comprise: a band (or sleeve) which is configured to be worn on a person's wrist; and an arcuate array of (outward-facing) cameras evenly (e.g. equidistantly) distributed around (at least a portion of) the circumference of the band (or sleeve), collectively spanning at least 25% of the circumference of the band (or sleeve), including the distal lateral side of the band (or sleeve).

In an example, a smart watch, watch band, or other wrist-worn device with a camera can comprise: a band (or sleeve) which is configured to be worn on a person's wrist; and an arcuate array of (outward-facing) cameras evenly distributed around (at least a portion of) the circumference of the band (or sleeve), collectively spanning at between 25% and 100% of the circumference of the person's wrist. Alternatively, a smart watch, watch band, or other wrist-worn device with an adjustable camera can comprise: a band (or sleeve) which is configured to be worn on a person's wrist; and an arcuate array of (outward-facing) cameras evenly distributed around (at least a portion of) the circumference of the band (or sleeve), collectively spanning at between 25% and 50% of the circumference of the person's wrist. Alternatively, a smart watch, watch band, or other wrist-worn device with a camera can comprise: a band (or sleeve) which is configured to be worn on a person's wrist; and an arcuate array of (outward-facing) cameras evenly distributed around (at least a portion of) the circumference of the band (or sleeve), collectively spanning at between 25% and 75% of the circumference of the person's wrist.

In one embodiment, a smart watch, watch band, or other wrist-worn electronic device with an adjustable camera can comprise: a band (or sleeve) which is configured to be worn on a person's wrist; and an arcuate array of (outward-facing) cameras evenly distributed around (at least a portion of) the circumference of the band (or sleeve), collectively spanning at least 25% of the circumference of the band (or sleeve). In another example, a smart watch, watch band, or other wrist-worn device with a camera can comprise: a band (or sleeve) which is configured to be worn on a person's wrist; and an arcuate array of (outward-facing) cameras which are centered at clock-hour locations around (at least a portion of) the circumference of the band (or sleeve) and which collectively span at least one quarter of the circumference of the person's wrist. Alternatively, a smart watch, watch band, or other wrist-worn electronic device with an adjustable camera can comprise: a band (or sleeve) which is configured to be worn on a person's wrist; and an arcuate array of (outward-facing) cameras which are centered at polar coordinate locations around (at least a portion of) the circumference of the band (or sleeve) and which collectively span at least half of the circumference of the person's wrist.

In an example, a smart watch, watch band, or other wrist-worn device with a camera can comprise: a band (or sleeve) which is configured to be worn on a person's wrist; and an arcuate array of (outward-facing) cameras which are equidistantly-distributed around (at least a portion of) the circumference of the band (or sleeve) and which collectively span at least 25% of the circumference of the person's wrist. For example, a smart watch, watch band, or other wrist-worn device with a camera can comprise: a band (or sleeve) which is configured to be worn on a person's wrist; and an arcuate array of (outward-facing) cameras which are evenly distributed around at least half of the circumference of the band (or sleeve). Alternatively, a smart watch, watch band, or other wrist-worn device with a camera can comprise: a band (or sleeve) which is configured to be worn on a person's wrist; and eight (outward-facing) cameras which are evenly (e.g. equidistantly) distributed around at least half of the circumference of the band (or sleeve).

In an embodiment of this invention, a smart watch, watch band, or other wrist-worn device with an adjustable camera can comprise: a band (or sleeve) which is configured to be worn on a person's wrist; and five (outward-facing) cameras which are distributed around (at least a portion of) the circumference of the band (or sleeve) and which collectively span at least half of the circumference of the person's wrist. In another example, a smart watch, watch band, or other wrist-worn device with a camera can comprise: a band (or sleeve) which is configured to be worn on a person's wrist; and five (outward-facing) cameras which are evenly (e.g. equidistantly) distributed around (at least a portion of) the circumference of the band (or sleeve) and which collectively span at least half of the circumference of the person's wrist. In an alternative embodiment, a smart watch, watch band, or other wrist-worn electronic device with an adjustable camera can comprise: a band (or sleeve) which is configured to be worn on a person's wrist; and four (outward-facing) cameras which are evenly (e.g. equidistantly) distributed around at least half of the circumference of the band (or sleeve).

In yet another example, a smart watch, watch band, or other wrist-worn device with a camera can comprise: a band (or sleeve) which is configured to be worn on a person's wrist; and six (outward-facing) cameras which are distributed around (at least a portion of) the circumference of the band (or sleeve) and which collectively span at least half of the circumference of the person's wrist. Alternatively, a smart watch, watch band, or other wrist-worn electronic device with an adjustable camera can comprise: a band (or sleeve) which is configured to be worn on a person's wrist; and six (outward-facing) cameras which are evenly (e.g. equidistantly) distributed around (at least a portion of) the circumference of the band (or sleeve) and which collectively span at least half of the circumference of the person's wrist. In an alternative embodiment, a smart watch, watch band, or other wrist-worn device with a camera can comprise: a display at the 12 o'clock location around a person's wrist, wherein clock locations around the person's wrist are defined relative to 12 o'clock at the middle of the dorsal side and 6 o'clock at the middle of the ventral side; a first camera at the 4 o'clock location around a person's wrist; and a second camera at the 12 o'clock location around a person's wrist.

In an example, a smart watch, watch band, or other wrist-worn device with a camera can comprise: a display at the 12 o'clock location around a person's wrist, wherein clock locations around the person's wrist are defined relative to 12 o'clock at the middle of the dorsal side and 6 o'clock at the middle of the ventral side; and a camera at the 4 o'clock location around a person's wrist. In another example, a smart watch, watch band, or other wrist-worn device with a camera can comprise: a display at the 9 o'clock location around a person's wrist, wherein clock locations around the person's wrist are defined relative to 12 o'clock at the middle of the dorsal side and 6 o'clock at the middle of the ventral side; a first camera at the 3 o'clock location around a person's wrist; and a second camera at the 12 o'clock location around a person's wrist. In another example, a smart watch, watch band, or other wrist-worn device with an adjustable camera can comprise: a display at the 9 o'clock location around a person's wrist, wherein clock locations around the person's wrist are defined relative to 12 o'clock at the middle of the dorsal side and 6 o'clock at the middle of the ventral side; and a camera at the 2 o'clock location around a person's wrist.

In yet another example, a smart watch, watch band, or other wrist-worn electronic device with a camera can comprise: a display which is configured to be worn on a lateral side of a person's wrist; and an (outward-facing) camera which is configured to be worn within a lateral-dorsal quadrant of the circumference of the person's wrist. Alternatively, a smart watch, watch band, or other wrist-worn device with an adjustable camera can comprise: a display which is configured to be worn on a lateral side of a person's wrist; and an (outward-facing) camera which is configured to be worn within a dorsal quadrant of the circumference of the person's wrist. Alternatively, a smart watch, watch band, or other wrist-worn electronic device with a camera can comprise: a display which is configured to be worn on a person's wrist; a camera which is configured to be worn on the person's wrist; and an EMG sensor which is configured to be worn on the person's wrist, wherein the camera is automatically activated to take pictures based on data from the sensor.

In an embodiment of this invention, a smart watch, watch band, or other wrist-worn device with an adjustable camera can comprise: a display which is configured to be worn on a person's wrist; a motion and/or gesture sensor which is configured to be worn on the person's wrist; and an (outward-facing) camera which is configured to be worn on the person's wrist, wherein the camera has first configuration with a first focal distance and a second configuration with a second focal distance, and wherein the camera is automatically changed from its first configuration to its second configuration. In another example, a smart watch, watch band, or other wrist-worn device with a camera can comprise: a display which is configured to be worn on the dorsal side of a person's wrist; a first (outward-facing) camera which is configured to be worn on a lateral side of the person's wrist at a first location which is rotated 90 degrees clockwise around the person's wrist relative to the display; and a second (outward-facing) camera which is configured to be worn on a lateral side of the person's wrist at a second location which is rotated 90 degrees counter-clockwise around the person's wrist relative to the display. For example, a smart watch, watch band, or other wrist-worn device with a camera can comprise: a display which is configured to be worn on the dorsal side of a person's wrist; and an (outward-facing) camera which is configured to be worn within a lateral-ventral quadrant of the circumference of the person's wrist.

In an example, a smart watch, watch band, or other wrist-worn device with a camera can comprise: a display which is configured to be worn on the ventral side of a person's wrist; and an (outward-facing) camera which is configured to be worn within a lateral-dorsal quadrant of the circumference of the person's wrist. Alternatively, a smart watch, watch band, or other wrist-worn device with an adjustable camera can comprise: a display which is substantially centered on the 12 o'clock location around a person's wrist, wherein clock locations around the person's wrist are defined relative to 12 o'clock at the middle of the dorsal side and 6 o'clock at the middle of the ventral side; a first camera which is substantially centered on the 1 o'clock location around a person's wrist; and a second camera which is substantially centered on the 12 o'clock location around the person's wrist. Alternatively, a smart watch, watch band, or other wrist-worn electronic device with a camera can comprise: a display which is substantially centered on the 12 o'clock location around a person's wrist, wherein clock locations around the person's wrist are defined relative to 12 o'clock at the middle of the dorsal side and 6 o'clock at the middle of the ventral side; a first camera which is substantially centered on the 6 o'clock location around a person's wrist; and a second camera which is substantially centered on the 12 o'clock location around the person's wrist.

In one embodiment, a smart watch, watch band, or other wrist-worn device with an adjustable camera can comprise: a display which is substantially centered on the 12 o'clock location around a person's wrist, wherein clock locations around the person's wrist are defined relative to 12 o'clock at the middle of the dorsal side and 6 o'clock at the middle of the ventral side; and a camera which is substantially centered on the 2 o'clock location around a person's wrist. In an alternative embodiment, a smart watch, watch band, or other wrist-worn electronic device with a camera can comprise: a display which is substantially centered on the 9 o'clock location around a person's wrist, wherein clock locations around the person's wrist are defined relative to 12 o'clock at the middle of the dorsal side and 6 o'clock at the middle of the ventral side; a first camera which is substantially centered on the 1 o'clock location around a person's wrist; and a second camera which is substantially centered on the 9 o'clock location around the person's wrist. Alternatively, a smart watch, watch band, or other wrist-worn device with an adjustable camera can comprise: a first housing of which at least 75% is configured to be worn between the 10 o'clock and 2 o'clock locations around a person's wrist, wherein clock locations around the person's wrist are defined relative to 12 o'clock at the middle of the dorsal side and 6 o'clock at the middle of the ventral side; a second housing of which at least 75% is configured to be worn between 4 o'clock and 8 o'clock locations around a person's wrist; a pop-up or flip-up component on the second housing; and a camera on the pop-up or flip-up component, wherein the display functions as a viewfinder for the camera.

In an embodiment of this invention, a smart watch, watch band, or other wrist-worn electronic device with a camera can comprise: a first housing which is configured to be worn on the dorsal side of circumference of a person's wrist; a display on the first housing; a first camera on the first housing; a second housing which is configured to be worn on the ventral side of the circumference of the person's wrist; and a second camera on the second housing. In another example, a smart watch, watch band, or other wrist-worn device with a camera can comprise: a first housing which is configured to be worn on the dorsal side of a person's wrist; a display on the first housing; a second housing which is configured to be worn on the ventral side of the person's wrist; and a camera at the 6 o'clock position on the perimeter of the second housing, wherein clock locations around the perimeter of the second housing are defined relative to 3 o'clock being closest to the person's middle finger and 9 o'clock being closest to the person's elbow. In an alternative embodiment, a smart watch, watch band, or other wrist-worn device with a camera can comprise: a first housing which is configured to be worn on the dorsal side of a person's wrist; a display on the first housing; a second housing which is configured to be worn on the ventral side of the person's wrist; and a camera on the second housing, wherein the focal direction of the camera is substantially tangential to the circumference of the person's wrist.

In one embodiment, a smart watch, watch band, or other wrist-worn device with an adjustable camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing which pops upward and/or outward from the housing; and a camera on the distal side of the pop-up component. For example, a smart watch, watch band, or other wrist-worn device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing which pops upward and/or outward from the housing; a display on the pop-up component; and a camera on the pop-up component. Alternatively, a smart watch, watch band, or other wrist-worn device with an adjustable camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing, wherein the pop-up component has a first configuration in which the pop-up component extends a first distance upward and/or outward from the housing, has a second configuration in which the pop-up component extends a second distance upward and/or outward from the housing, and wherein the second distance is between 1 mm and 4 cm greater than the first distance; and a camera on the pop-up component.

In yet another example, a smart watch, watch band, or other wrist-worn electronic device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing, wherein the pop-up component has a first configuration in which the pop-up component extends a first distance upward and/or outward from the housing, has a second configuration in which the pop-up component extends a second distance upward and/or outward from the housing, and wherein the second distance is between 1 mm and 4 cm greater than the first distance; a display on the pop-up component; and a camera on the side of the pop-up component which is closest to the 2 o'clock location. In another example, a smart watch, watch band, or other wrist-worn device with an adjustable camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing, wherein the pop-up component has a first configuration which is recessed within the housing and a second configuration which extends upward and/or outward from the housing; a display on the pop-up component; and a camera on the side of the pop-up component which is closest to the 2 o'clock location.

In an example, a smart watch, watch band, or other wrist-worn electronic device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a flip-up component which is substantially parallel to the housing in a first configuration and substantially perpendicular to the housing in a second configuration, wherein the flip-up component is changed from its first configuration to its second configuration by pivoting, tilting, and/or rotating upward and/or outward from the housing; a display on a first side of the flip-up component facing toward the person when the flip-up component is in its second configuration; a first camera on the first side of the flip-up component; and a second camera on a second side of the flip-up component facing away from the person when the flip-up component is in its second configuration.

In yet another example, a smart watch, watch band, or other wrist-worn device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a flip-up component which is substantially parallel to the housing in a first configuration and is tilted at an angle between 20 and 120 degrees relative to the housing in a second configuration, wherein the flip-up component is changed from its first configuration to its second configuration by pivoting, tilting, and/or rotating upward and/or outward from the housing; a display on a first side of the flip-up component facing toward the person when the flip-up component is in its second configuration; and a camera on a second side of the flip-up component facing away from the person when the flip-up component is in its second configuration. In an alternative embodiment, a smart watch, watch band, or other wrist-worn electronic device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a flip-up component which is substantially parallel to the housing in a first configuration and is tilted at an angle between 20 and 120 degrees relative to the housing in a second configuration, wherein the flip-up component is changed from its first configuration to its second configuration by pivoting, tilting, and/or rotating the distal edge of the flip-up component upward and/or outward from the housing; a display on a first side of the flip-up component facing toward the person when the flip-up component is in its second configuration; and a camera on a second side of the flip-up component facing away from the person when the flip-up component is in its second configuration.

In an example, a smart watch, watch band, or other wrist-worn device with an adjustable camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a flip-up component which is substantially parallel to the housing in a first configuration and substantially perpendicular to the housing in a second configuration, wherein the flip-up component is changed from its first configuration to its second configuration by pivoting, tilting, and/or rotating upward and/or outward from the housing; a display on the flip-up component; and a camera on the flip-up component.

In an example, a smart watch, watch band, or other wrist-worn device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a flip-up component which is substantially parallel to the housing in a first configuration and substantially perpendicular to the housing in a second configuration, wherein the flip-up component is changed from its first configuration to its second configuration by pivoting, tilting, and/or rotating upward and/or outward from the housing; a first camera on a first side of the flip-up component; and a second camera on a second side of the flip-up component. For example, a smart watch, watch band, or other wrist-worn device with an adjustable camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a flip-up component which is substantially parallel to the housing in a first configuration and substantially perpendicular to the housing in a second configuration, wherein the flip-up component is changed from its first configuration to its second configuration by pivoting, tilting, and/or rotating upward and/or outward from the housing; and a camera on a side of the flip-up component facing away from the person when the flip-up component is in its second configuration. Alternatively, a smart watch, watch band, or other wrist-worn device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a flip-up component which is substantially parallel to the housing in a first configuration and is tilted at an angle between 20 and 120 degrees relative to the housing in a second configuration, wherein the flip-up component is changed from its first configuration to its second configuration by pivoting, tilting, and/or rotating the distal edge of the flip-up component upward and/or outward from the housing; and a camera on a side of the flip-up component facing away from the person when the flip-up component is in its second configuration.

In an example, a smart watch, watch band, or other wrist-worn electronic device with an adjustable camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a flip-up component which is substantially parallel to the housing in a first configuration and is tilted at an angle between 20 and 120 degrees relative to the housing in a second configuration, wherein the flip-up component is changed from its first configuration to its second configuration by pivoting, tilting, and/or rotating upward and/or outward from the housing; and a camera on the flip-up component. Alternatively, a smart watch, watch band, or other wrist-worn device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a pop-up or lift-up component whose centroid is a first distance from the centroid of the housing in a first configuration and a second distance from the centroid of the housing in a second configuration, wherein the second distance is 1 mm to 4 cm greater than the first distance, and wherein the pop-up or lift-up component is changed from its first configuration to its second configuration by pivoting, tilting, and/or rotating an edge of the pop-up or lift-up component upward and/or outward from the housing; a display on a first side of the pop-up or lift-up component facing toward the person when the pop-up or lift-up component is in its second configuration; a first camera on the first side of the pop-up or lift-up component; and a second camera on a second side of the pop-up or lift-up component facing away from the person when the pop-up or lift-up component is in its second configuration. In another example, a smart watch, watch band, or other wrist-worn electronic device with a camera can comprise: a housing which is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing which pops upward and/or outward from the housing; and a camera on the distal side of the pop-up component.

In an example, a smart watch, watch band, or other wrist-worn device with a camera can comprise: a housing which is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing which pops upward and/or outward from the housing; a display on the pop-up component; and a camera on the pop-up component. In another example, a smart watch, watch band, or other wrist-worn device with an adjustable camera can comprise: a housing which is configured to be worn between 10 o'clock and 2 o'clock locations around a person's wrist, wherein clock locations around the person's wrist are defined relative to 12 o'clock at the middle of the dorsal side and 6 o'clock at the middle of the ventral side;

a display on the housing; a pop-up component on the housing, wherein the pop-up component has a first configuration in which the pop-up component extends a first distance upward and/or outward from the housing, has a second configuration in which the pop-up component extends a second distance upward and/or outward from the housing, and wherein the second distance is between 1 mm and 4 cm greater than the first distance; and a camera on the pop-up component. Alternatively, a smart watch, watch band, or other wrist-worn device with a camera can comprise: a housing which is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing, wherein the pop-up component has a first configuration in which the pop-up component extends a first distance upward and/or outward from the housing, has a second configuration in which the pop-up component extends a second distance upward and/or outward from the housing, and wherein the second distance is between 1 mm and 4 cm greater than the first distance; a display on the pop-up component; and a camera on the side of the pop-up component which is closest to the 2 o'clock location.

In yet another example, a smart watch, watch band, or other wrist-worn device with an adjustable camera can comprise: a housing which is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing, wherein the pop-up component has a first configuration which is recessed within the housing and a second configuration which extends upward and/or outward from the housing; a display on the pop-up component; and a camera on the side of the pop-up component which is closest to the 2 o'clock location. In an alternative embodiment, a smart watch, watch band, or other wrist-worn device with a camera can comprise: a housing which is configured to be worn on a person's wrist; a display on the housing; a motion and/or gesture sensor (e.g. accelerometer and/or gyroscope) in the housing; and a camera on the housing, wherein the focal direction of the camera is automatically moved relative to the housing based on data from the motion and/or gesture sensor. Alternatively, a smart watch, watch band, or other wrist-worn device with an adjustable camera can comprise: a housing which is configured to be worn on a person's wrist; a flip-up component on the housing, wherein the flip-up component is substantially parallel to the housing in a first configuration and is tilted relative to the housing in a second configuration, wherein the flip-up component is changed from its first configuration to its second configuration by pivoting, tilting, and/or rotating upward and/or outward from the housing; and a camera on the flip-up component.

In one embodiment, a smart watch, watch band, or other wrist-worn electronic device with a camera can comprise: a housing which is configured to be worn on a person's wrist; a flip-up component on the housing, wherein the virtual plane which best fits the flip-up component intersects the housing at a first angle in a first configuration, intersects the housing at a second angle in a second configuration, wherein the second angle is 20 to 120 degrees greater than the first angle, and wherein the flip-up component is automatically changed from its first configuration to its second configuration by being pivoted, tilted, and/or rotated by an actuator; a display on the flip-up component; and a camera on the flip-up component. In another example, a smart watch, watch band, or other wrist-worn device with a camera can comprise: a housing which is configured to be worn on a person's wrist; a flip-up component on the housing, wherein the virtual plane which best fits the flip-up component intersects the housing at a first angle in a first configuration, intersects the housing at a second angle in a second configuration, wherein the second angle is 20 to 120 degrees greater than the first angle, and wherein the flip-up component is automatically changed from its first configuration to its second configuration by being pivoted, tilted, and/or rotated by a spring; and a camera on the flip-up component. For example, a smart watch, watch band, or other wrist-worn electronic device with a camera can comprise: a housing which is configured to be worn on a person's wrist; a flip-up component which pivots, tilts, and/or rotates upward and/or outward from the housing; a display on a first side of the flip-up component; and a camera on a second side of the flip-up component, wherein the second side is opposite the first side.

In yet another example, a smart watch, watch band, or other wrist-worn device with an adjustable camera can comprise: a housing which is configured to be worn on a person's wrist; a flip-up component which pivots, tilts, and/or rotates upward and/or outward from the housing; a display on the flip-up component; and a camera on the flip-up component. In another example, a smart watch, watch band, or other wrist-worn electronic device with a camera can comprise: a housing which is configured to be worn on a person's wrist; a flip-up component, wherein a portion of the flip-up component pivots, tilts, and/or rotates around a flexible and/or elastic strip in an upward and/or outward manner from the housing; a display on the flip-up component; and a camera on the flip-up component. In an alternative embodiment, a smart watch, watch band, or other wrist-worn device with an adjustable camera can comprise: a housing which is configured to be worn on a person's wrist; a motion and/or gesture sensor (e.g. accelerometer and/or gyroscope) in the housing; and a camera on the housing which is automatically moved relative to the housing based on data from the motion and/or gesture sensor so as to maintain a constant focal direction relative to the environment.

In an embodiment of this invention, a smart watch, watch band, or other wrist-worn device with a camera can comprise: a housing which is configured to be worn on a person's wrist; a motion and/or gesture sensor (e.g. accelerometer and/or gyroscope) in the housing; and a camera on the housing, wherein the focal direction of the camera is automatically moved relative to the housing based on data from the motion and/or gesture sensor. Alternatively, a smart watch, watch band, or other wrist-worn device with an adjustable camera can comprise: a housing which is configured to be worn on a person's wrist; a motion and/or gesture sensor (e.g. accelerometer and/or gyroscope) in the housing; and a camera which is configured to be worn on a person's wrist, wherein the camera is automatically moved based on data from the motion and/or gesture sensor so as to maintain a constant focal direction relative to the environment. For example, a smart watch, watch band, or other wrist-worn device with a camera can comprise: a housing which is configured to be worn on a person's wrist; a pop-up component which is substantially flush with or recessed within the housing in a first configuration and extends out from the housing in a second configuration, and wherein the pop-up component is changed from its first configuration to its second configuration when the person presses a button; a display on the pop-up component; and a camera on the pop-up component.

In yet another example, a smart watch, watch band, or other wrist-worn device with a camera can comprise: a housing which is configured to be worn on a person's wrist; a pop-up or lift-up component on the housing, wherein the centroid of the pop-up or lift-up component is a first distance from the housing in a first configuration, the centroid of the pop-up or lift-up component is a second distance from the housing in a second configuration, and the second distance is greater than the first distance; wherein the pop-up or lift-up component has a wide outer surface which faces away from the person's wrist, a wide inner surface which faces toward the person's wrist, and a lateral perimeter between the outer surface and the inner surface when the pop-up or lift-up component is in its first configuration; wherein the pop-up or lift-up component changes from its first configuration to its second configuration by moving upward and/or outward from the housing; a display on the wide outer surface of the pop-up or lift-up component; and a camera on the wide inner surface of the pop-up or lift-up component. In another example, a smart watch, watch band, or other wrist-worn device with a camera can comprise: a housing which is configured to be worn on a person's wrist; a pop-up or lift-up component on the housing, wherein the centroid of the pop-up or lift-up component is a first distance from the housing in a first configuration, the centroid of the pop-up or lift-up component is a second distance from the housing in a second configuration, and the second distance is greater than the first distance; wherein the pop-up or lift-up component has a wide outer surface which faces away from the person's wrist, a wide inner surface which faces toward the person's wrist, and a lateral perimeter between the outer surface and the inner surface when the pop-up or lift-up component is in its first configuration; wherein the pop-up or lift-up component changes from its first configuration to its second configuration by moving upward and/or outward from the housing; and a camera on the wide inner surface of the pop-up or lift-up component. In an alternative embodiment, a smart watch, watch band, or other wrist-worn device with an adjustable camera can comprise: a housing which is configured to be worn on a person's wrist; and a camera on the housing, wherein the camera is automatically moved relative to the housing in order to scan areas near the person.

In one embodiment, a smart watch, watch band, or other wrist-worn electronic device with a camera can comprise: a housing which is configured to be worn on the dorsal side of a person's wrist; a display on the housing; and a camera on the housing, wherein the focal direction of the camera is substantially tangential to the circumference of the person's wrist. For example, a smart watch, watch band, or other wrist-worn device with an adjustable camera can comprise: a housing which is configured to be worn on the dorsal side of a person's wrist; a flip-up component which is substantially parallel to the housing in a first configuration and substantially perpendicular to the housing in a second configuration, wherein the flip-up component is changed from its first configuration to its second configuration by pivoting, tilting, and/or rotating upward and/or outward from the housing; a display on the flip-up component; and a camera on the flip-up component. Alternatively, a smart watch, watch band, or other wrist-worn electronic device with a camera can comprise: a housing which is configured to be worn on the dorsal side of a person's wrist; a flip-up component which is substantially parallel to the housing in a first configuration and substantially perpendicular to the housing in a second configuration, wherein the flip-up component is changed from its first configuration to its second configuration by pivoting, tilting, and/or rotating upward and/or outward from the housing; and a camera on a side of the flip-up component.

In an example, a smart watch, watch band, or other wrist-worn device with a camera can comprise: a housing which is configured to be worn on the dorsal side of a person's wrist; a flip-up component which is substantially parallel to the housing in a first configuration and is tilted at an angle between 20 and 120 degrees relative to the housing in a second configuration, wherein the flip-up component is changed from its first configuration to its second configuration by pivoting, tilting, and/or rotating upward and/or outward from the housing; and a camera on an edge of the flip-up component. In another example, a smart watch, watch band, or other wrist-worn device with a camera can comprise: a housing which is configured to be worn on the dorsal side of a person's wrist; a pop-up or lift-up component whose centroid is a first distance from the centroid of the housing in a first configuration and a second distance from the centroid of the housing in a second configuration, wherein the second distance is 1 mm to 4 cm greater than the first distance, and wherein the pop-up or lift-up component is changed from its first configuration to its second configuration by moving upward and/or outward from the housing; a display on a first side the pop-up or lift-up component; and a camera on a second side of the pop-up or lift-up component, wherein the second side is opposite the first side. Alternatively, a smart watch, watch band, or other wrist-worn device with an adjustable camera can comprise: a housing which is configured to be worn on the dorsal side of circumference of a person's wrist; a display on the housing; and an (outward-facing) camera which is configured to be worn on a lateral side of the circumference of the person's wrist.

In an embodiment of this invention, a smart watch, watch band, or other wrist-worn device with a camera can comprise: a housing which is configured to be worn on the ventral side of a person's wrist; a pop-up or lift-up component whose centroid is a first distance from the centroid of the housing in a first configuration and a second distance from the centroid of the housing in a second configuration, wherein the second distance is 1 mm to 4 cm greater than the first distance, and wherein the pop-up or lift-up component is changed from its first configuration to its second configuration by moving upward and/or outward from the housing; a display on the pop-up or lift-up component; and a camera on the pop-up or lift-up component.

Alternatively, a smart watch, watch band, or other wrist-worn device with a camera can comprise: a housing which is configured to be worn on the ventral side of a person's wrist; a pop-up or lift-up component whose centroid is a first distance from the centroid of the housing in a first configuration and a second distance from the centroid of the housing in a second configuration, wherein the second distance is 1 mm to 4 cm greater than the first distance, and wherein the pop-up or lift-up component is changed from its first configuration to its second configuration by moving upward and/or outward from the housing; and a camera on the pop-up or lift-up component. In an alternative embodiment, a smart watch, watch band, or other wrist-worn device with a camera can comprise: a housing with a display which is configured to be on a person's wrist; and an (outward-facing) camera on the perimeter of the housing, wherein the central focal vector of the (outward-facing) camera is substantially parallel to the outer surface of the display.

In an example, a smart watch, watch band, or other wrist-worn device with an adjustable camera can comprise: a housing with a display which is configured to be worn on a person's wrist, wherein the outer surface of the display is substantially tangential to the circumference of the wrist; and an (outward-facing) camera on a side of the housing with a focal direction which is substantially parallel to the outer surface of the display. In another example, a smart watch, watch band, or other wrist-worn electronic device with a camera can comprise: a touch-screen display which is configured to be worn on a person's wrist; and a plurality of (outward-facing) cameras which are configured to be worn on the person's wrist; and wherein the person selects one of the adjustable cameras by touching the touch-screen display. In another example, a smart watch, watch band, or other wrist-worn device with a camera can comprise: a watch and/or wrist band (or sleeve) which is worn on a person's wrist; a display on the band (or sleeve); and two cameras on opposite (narrow) sides of the band (or sleeve).

In yet another example, a smart watch, watch band, or other wrist-worn electronic device with a camera can comprise: a wedge-shaped housing which is configured to be worn on a person's wrist; wherein a proximal portion of the lateral perimeter of the wedge-shaped housing faces generally toward from the person and a distal portion of the lateral perimeter of the wedge-shaped housing faces generally away from the person; wherein the proximal portion of the lateral perimeter of the wedge-shaped housing has a first thickness, the distal portion of the lateral perimeter of the wedge-shaped housing has a second thickness, and the second thickness is between 1 mm and 1 cm greater than the first thickness; and camera on the distal portion of the lateral perimeter of the wedge-shaped housing. Alternatively, a smart watch, watch band, or other wrist-worn device with an adjustable camera can comprise: an (outward-facing) camera which is configured to be worn on a person's wrist; a display which is configured to be worn on the person's wrist; and a wearable sensor worn on the person's wrist which is selected from the group consisting of accelerometer, inclinometer, motion and/or gesture sensor, sound sensor, smell sensor, blood pressure sensor, heart rate sensor, EEG sensor, ECG sensor, EMG sensor, electrochemical sensor, gastric activity sensor, GPS sensor, location sensor, image sensor, optical sensor, piezoelectric sensor, respiration sensor, strain gauge, electrogoniometer, chewing sensor, swallow sensor, temperature sensor, and pressure sensor; wherein the focal direction of the camera is automatically changed based on data from the wearable sensor. For example, a smart watch, watch band, or other wrist-worn device with a camera can comprise: an (outward-facing) camera which is configured to be worn on a person's wrist, wherein images captured by the camera are analyzed by pattern recognition or identification; and a display which is configured to be worn on the person's wrist.

In an embodiment of this invention, a smart watch, watch band, or other wrist-worn device with a camera can comprise: an (outward-facing) camera which is configured to be worn within the 1-2 o'clock locations around a person's wrist; a display which is configured to be worn at the 6 o'clock location on the circumference of a person's wrist; wherein clock locations around the person's wrist are defined relative to 12 o'clock at the middle of the dorsal side and 6 o'clock at the middle of the ventral side. In an alternative embodiment, a smart watch, watch band, or other wrist-worn device with a camera can comprise: an (outward-facing) camera which is configured to be worn within distal dorsal-lateral quadrant locations on the circumference of a person's wrist; a display which is configured to be worn within proximal dorsal-lateral quadrant locations on the circumference of a person's wrist. Alternatively, a smart watch, watch band, or other wrist-worn device with an adjustable camera can comprise: an (outward-facing) camera which is configured to be worn within the 1-2 o'clock locations around a person's wrist; a display which is configured to be worn within the 10-11 o'clock locations around a person's wrist; wherein clock locations around the person's wrist are defined relative to 12 o'clock at the middle of the dorsal side and 6 o'clock at the middle of the ventral side.

In yet another example, a smart watch, watch band, or other wrist-worn device with a camera can comprise: an (outward-facing) camera with a first configuration in which the camera is at a first location on a person's wrist and a second configuration in which the camera is at a second location on a person's wrist, wherein the camera can be moved from the first location to the second location independently of movement of the body member to which the camera is attached; and a display which is configured to be worn on the person's wrist. In an alternative embodiment, a smart watch, watch band, or other wrist-worn device with a camera can comprise: two cameras attached to a wrist band (or sleeve) on opposite (narrow) sides of the person's wrist; and a display which is configured to be worn on the person's wrist. In another example, a smart watch, watch band, or other wrist-worn electronic device with a camera can comprise: two cameras which are configured to be worn on the narrow sides of a person's wrist, between the posterior and anterior surfaces of the wrist; and a display which is configured to be worn on the person's wrist.

In an example, a smart watch, watch band, or other wrist-worn device with an adjustable camera can comprise: a band (or sleeve) which is configured to be worn on a person's wrist; a detachable housing which can be reversibly detached from (and re-attached to) the band (or sleeve); and a camera on the detachable housing; wherein the camera is in wireless communication with the band (or sleeve) when the housing is detached from the band (or sleeve) so that the camera can be used to record images even when the housing is detached from the band (or sleeve). For example, a smart watch, watch band, or other wrist-worn electronic device with a camera can comprise: a band (or sleeve) which is configured to be worn on a person's wrist; a display on the band (or sleeve); a first camera with a first focal distance range; and a second (“zoom”) camera with a second focal distance range, wherein the second focal distance range is at least 25% greater than the first focal distance range. Alternatively, a smart watch, watch band, or other wrist-worn device with a camera can comprise: a band (or sleeve) which is configured to be worn on a person's wrist; a display on the band (or sleeve); a motion and/or gesture sensor on the band (or sleeve); a camera on the band (or sleeve); and an actuator on the band, wherein the focal distance and/or focal direction of the camera is automatically changed by the actuator based on movement of the band which is detected by the motion and/or gesture sensor in order to stabilize the image captured by the camera.

In one embodiment, a smart watch, watch band, or other wrist-worn device with a camera can comprise: a band (or sleeve) which is configured to be worn on a person's wrist; a display on the band (or sleeve); and an arcuate array of (outward-facing) cameras, wherein the cameras and the display collectively are evenly distributed around at least half of the circumference of the band (or sleeve). In another example, a smart watch, watch band, or other wrist-worn device with an adjustable camera can comprise: a band (or sleeve) which is configured to be worn on a person's wrist; a display on the band (or sleeve); and an arcuate array of (outward-facing) cameras, wherein the cameras and the display collectively are evenly distributed around at least half of the circumference of the person's wrist. Alternatively, a smart watch, watch band, or other wrist-worn device with a camera can comprise: a band (or sleeve) which is configured to be worn on a person's wrist; a display which is centered at a first clock-hour location around the circumference of band (or sleeve); and a camera which is centered at a second clock-hour location around the circumference of band (or sleeve), wherein the first clock-hour location differs from the second clock-hour location by 2 hours.

In an example, a smart watch, watch band, or other wrist-worn device with a camera can comprise: a band (or sleeve) which is configured to be worn on a person's wrist; a display which is centered at a first clock-hour location around the circumference of band (or sleeve); and a camera which is centered at a second clock-hour location around the circumference of band (or sleeve), wherein the first clock-hour location differs from the second clock-hour location by between 4 and 5 hours. Alternatively, a smart watch, watch band, or other wrist-worn device with a camera can comprise: a band (or sleeve) which is configured to be worn on a person's wrist; a display which is centered at a first location on the circumference of band (or sleeve) with a first polar coordinate; a first camera which is centered at a second location on the circumference of band (or sleeve) with a second polar coordinate; and a second camera which is centered at a third location on the circumference of band (or sleeve) with a third polar coordinate; wherein the angle of the second polar coordinate differs from the angle of the first polar coordinate by 45 degrees, wherein the angle of the third polar coordinate differs from the angle of the first polar coordinate by 45 degrees, and wherein the angle of the third polar coordinate differs from the angle of the second coordinate by 90 degrees. For example, a smart watch, watch band, or other wrist-worn device with an adjustable camera can comprise: a band (or sleeve) which is configured to be worn on a person's wrist; a display which is centered at a first location on the circumference of band (or sleeve) with a first polar coordinate; a first camera which is centered at the first location; and a second camera which is centered at a second location on the circumference of band (or sleeve) with a second polar coordinate; wherein the angle of the second polar coordinate differs from the angle of the first polar coordinate by 90 degrees.

In one embodiment, a smart watch, watch band, or other wrist-worn device with a camera can comprise: a band (or sleeve) which is configured to be worn on a person's wrist; a display which is centered at a first location on the circumference of band (or sleeve) with a first polar coordinate; and a camera which is centered at a second location on the circumference of band (or sleeve) with a second polar coordinate, wherein the angle of the second polar coordinate differs from the angle of the first polar coordinate by between 35 and 55 degrees. In an alternative embodiment, a smart watch, watch band, or other wrist-worn electronic device with a camera can comprise: a band (or sleeve) which is configured to be worn on a person's wrist; a display which is centered at a first location on the circumference of band (or sleeve) with a first polar coordinate; and a camera which is centered at a second location on the circumference of band (or sleeve) with a second polar coordinate, wherein the angle of the second polar coordinate differs from the angle of the first polar coordinate by between 90 and 180 degrees. In another example, a smart watch, watch band, or other wrist-worn electronic device with a camera can comprise: a band (or sleeve) which is configured to be worn on a person's wrist; a housing on the band (or sleeve) on the dorsal side of the person's wrist; a transparent convex component on the housing which extends outward from the person's wrist; and a camera on the housing under the transparent convex component, wherein the camera is automatically rotated and/or tilted relative to the housing by an actuator in order to change the camera's focal direction.

In yet another example, a smart watch, watch band, or other wrist-worn device with an adjustable camera can comprise: a band (or sleeve) which is configured to be worn on a person's wrist; a housing on the band (or sleeve) on the ventral side of the person's wrist; a transparent dome on the housing which extends outward from the person's wrist; and a camera on the housing under the transparent dome, wherein the camera can be rotated and/or tilted relative to the housing in order to change the camera's focal direction. Alternatively, a smart watch, watch band, or other wrist-worn device with a camera can comprise: a band (or sleeve) which is configured to be worn on a person's wrist; a housing on the band (or sleeve) which extends between 2 mm and 1 cm outward from the band (or sleeve); a display on the housing; and a plurality of cameras evenly (e.g. equidistantly) distributed around the lateral (narrow) perimeter of the housing. In an alternative embodiment, a smart watch, watch band, or other wrist-worn device with a camera can comprise: a band (or sleeve) which is configured to be worn on a person's wrist; a housing on the band (or sleeve) which extends between 5 mm and 1 cm outward from the band (or sleeve); a display on the housing; and a plurality of cameras distributed around the lateral (narrow) perimeter of the housing.

In an example, a smart watch, watch band, or other wrist-worn electronic device with a camera can comprise: a band (or sleeve) which is configured to be worn on a person's wrist; a housing on the band (or sleeve) which extends outward from the band (or sleeve); a display on the housing; and a plurality of cameras evenly (e.g. equidistantly) distributed around the lateral (narrow) perimeter of the housing. Alternatively, a smart watch, watch band, or other wrist-worn electronic device with an adjustable camera can comprise: a band (or sleeve) which is configured to be worn on a person's wrist; a housing on the band (or sleeve) which extends outward from the band (or sleeve); a display on the housing; and a plurality of cameras evenly (e.g. equidistantly) distributed around the lateral (narrow) perimeter of the housing, wherein the person selects one of the plurality of cameras for imaging at a given time by making a gesture which is recognized by the device. In another example, a smart watch, watch band, or other wrist-worn device with a camera can comprise: a band (or sleeve) which is configured to be worn on a person's wrist; a housing on the band (or sleeve) which extends outward from the band (or sleeve); a display on the housing; and a plurality of cameras distributed around the lateral (narrow) perimeter of the housing.

In yet another example, a smart watch, watch band, or other wrist-worn device with a camera can comprise: a band (or sleeve) which is configured to be worn on a person's wrist; a housing on the band (or sleeve) which extends outward from the band (or sleeve); a display on the housing; and a plurality of cameras distributed around the lateral (narrow) perimeter of the housing, wherein the person selects one of the plurality of cameras for imaging at a given time by making a gesture which is recognized by the device. In an alternative embodiment, a smart watch, watch band, or other wrist-worn electronic device with a camera can comprise: a band (or sleeve) which is configured to be worn on a person's wrist; a housing on the band (or sleeve) which extends outward from the band (or sleeve); a display on the housing; and two cameras on the housing, wherein the cameras are located on opposite sides of the lateral (narrow) perimeter of the housing, wherein central focal vectors of the cameras are parallel to vectors which are tangential to the circumference of the band (or sleeve). In another example, a smart watch, watch band, or other wrist-worn electronic device with an adjustable camera can comprise: a band (or sleeve) which is configured to be worn on a person's wrist; a housing on the band (or sleeve) which extends outward from the band (or sleeve); a display on the housing; a rotating ring or bezel on the housing; and a camera on the perimeter of the ring or bezel, wherein the ring or bezel is automatically rotated by an actuator in order to change the focal direction of the camera.

In an example, a smart watch, watch band, or other wrist-worn device with a camera can comprise: a band (or sleeve) which is configured to be worn on a person's wrist; a housing on the band (or sleeve) which extends outward from the band (or sleeve); a rotating ring or bezel on the housing; a display on the housing; and a plurality of cameras distributed around the lateral (narrow) perimeter of the housing, wherein the person selects one of the plurality of cameras for imaging at a given time by rotating the ring or bezel. Alternatively, a smart watch, watch band, or other wrist-worn device with a camera can comprise: a band (or sleeve) which is configured to be worn on a person's wrist; a housing on the band (or sleeve) with a touch-screen display; and an arcuate array of (outward-facing) cameras which are distributed around (at least a portion of) the circumference of the band (or sleeve), wherein the arcuate array of (outward-facing) cameras collectively spans at least 25% of the circumference of the person's wrist, wherein a camera in the array is selected by the person to record images at a given time, and wherein the selection of the camera is done by the person touching and/or swiping the touch-screen display. For example, a smart watch, watch band, or other wrist-worn electronic device with a camera can comprise: a band (or sleeve) which is configured to be worn on a person's wrist; a housing on the band (or sleeve) with a touch-screen display; and an arcuate array of (outward-facing) cameras which are evenly (e.g. equidistantly) distributed around (at least a portion of) the circumference of the band (or sleeve), wherein the arcuate array of (outward-facing) cameras collectively spans at least 25% of the circumference of the person's wrist, wherein a camera in the array is selected by the person to record images at a given time, and wherein the selection of the camera is done by the person touching and/or swiping the touch-screen display.

In yet another example, a smart watch, watch band, or other wrist-worn electronic device with an adjustable camera can comprise: a band (or sleeve) which is configured to be worn on a person's wrist; a housing on the band (or sleeve) with a transparent convex surface (e.g. transparent dome) which extends outward from the band (or sleeve); and a rotating camera on the housing under the transparent convex surface, wherein the focal direction of the camera is changed as the camera rotates. Alternatively, a smart watch, watch band, or other wrist-worn device with a camera can comprise: a band (or sleeve) which is configured to be worn on a person's wrist; a housing on the band (or sleeve), wherein the housing further comprises a rotating turret, bezel, or ring; and a plurality of cameras evenly (e.g. equidistantly) distributed around the lateral (narrow) perimeter of rotating turret, bezel, or ring. Alternatively, a smart watch, watch band, or other wrist-worn device with a camera can comprise: a band (or sleeve) which is configured to be worn on a person's wrist; a housing on the band (or sleeve), wherein the housing further comprises a turret, bezel, or ring which is automatically rotated by an actuator; and a plurality of cameras on the lateral (narrow) perimeter of the rotating turret, bezel, or ring; wherein the turret, bezel, or ring rotates in a plane which is substantially parallel to the closest plane which is tangential to the circumference of the band (or sleeve).

In an example, a smart watch, watch band, or other wrist-worn electronic device with a camera can comprise: a band (or sleeve) which is configured to be worn on a person's wrist; a housing on the band (or sleeve), wherein the housing further comprises a rotating turret, bezel, or ring; and at least one camera on the lateral (narrow) perimeter of the rotating turret, bezel, or ring; wherein the turret, bezel, or ring rotates in a plane which is substantially parallel to the closest plane which is tangential to the circumference of the band (or sleeve). In an alternative embodiment, a smart watch, watch band, or other wrist-worn electronic device with an adjustable camera can comprise: a band (or sleeve) which is configured to be worn on a person's wrist; a housing on the band (or sleeve), wherein the housing further comprises a rotating turret, bezel, or ring; and at least one camera on the rotating turret, bezel, or ring; wherein the turret, bezel, or ring rotates in a plane which is substantially parallel to the closest plane which is tangential to the circumference of the band (or sleeve). In another example, a smart watch, watch band, or other wrist-worn device with a camera can comprise: a band (or sleeve) which is configured to be worn on a person's wrist; a housing on the band (or sleeve); a camera on the housing; and a mirror or mirror array which is moved by electromagnetic means, wherein the focal direction of the camera is changed by movement of the mirror or mirror array.

In an embodiment of this invention, a smart watch, watch band, or other wrist-worn device with a camera can comprise: a band (or sleeve) which is configured to be worn on a person's wrist; a housing on the band (or sleeve); a display on a first side of the housing; and a camera on a second side of the housing, wherein the second side is opposite the first side. Alternatively, a smart watch, watch band, or other wrist-worn device with a camera can comprise: a band (or sleeve) which is configured to be worn on a person's wrist; a housing on the band (or sleeve); a display on a side of the housing; and a camera on the same side of the housing as the display. For example, a smart watch, watch band, or other wrist-worn electronic device with an adjustable camera can comprise: a band (or sleeve) which is configured to be worn on a person's wrist; a housing on the band (or sleeve); a flip-up or pop-up component on the housing; a display on a first side of the flip-up or pop-up component; and a camera on a second side of the flip-up or pop-up component, wherein the second side is opposite the first side.

In an example, a smart watch, watch band, or other wrist-worn electronic device with a camera can comprise: a band (or sleeve) which is configured to be worn on a person's wrist; a housing on the band (or sleeve); a flip-up or pop-up component on the housing; a display on a first side of the flip-up or pop-up component; a first camera on the first side of the flip-up or pop-up component; and a second camera on a second side of the flip-up or pop-up component, wherein the second side is perpendicular to the first side. In an alternative embodiment, a smart watch, watch band, or other wrist-worn device with a camera can comprise: a band (or sleeve) which is configured to be worn on a person's wrist; a housing on the band (or sleeve); a pop-up, flip-up, or tilt-up component on the housing which extends outward from the housing when it is popped up, flipped up, or tilted up; a camera on the pop-up, flip-up, or tilt-up component; a motion and/or gesture sensor on the band (or sleeve); wherein the pop-up, flip-up, or tilt-up component is automatically extended outward from the housing when the person makes a selected motion and/or gesture as detected by the motion and/or gesture sensor. In another example, a smart watch, watch band, or other wrist-worn device with a camera can comprise: a band (or sleeve) which is configured to be worn on a person's wrist; a housing on the band (or sleeve); a pop-up, flip-up, or tilt-up component on the housing with a first configuration in which the centroid of the pop-up, flip-up, or tilt-up component is a first distance from the side of the housing which is closest to the person's wrist and a second configuration in which the centroid of the pop-up, flip-up, or tilt-up component is a second distance from the side of the housing which is closest to the person's wrist, wherein the second distance is 2 mm to 4 cm greater than the first distance; a display on a first side of the pop-up, flip-up, or tilt-up component; a camera on a second side of the pop-up, flip-up, or tilt-up component; a motion and/or gesture sensor on the band (or sleeve); and an actuator on the band (or sleeve); wherein the pop-up, flip-up, or tilt-up component is automatically moved by the actuator from its first configuration to its second configuration when the person makes a selected motion and/or gesture as detected by the motion and/or gesture sensor.

In yet another example, a smart watch, watch band, or other wrist-worn device with an adjustable camera can comprise: a band (or sleeve) which is configured to be worn on a person's wrist; a housing on the band (or sleeve); a pop-up, flip-up, or tilt-up component on the housing with a first configuration in which the centroid of the pop-up, flip-up, or tilt-up component is a first distance from the side of the housing which is closest to the person's wrist and a second configuration in which the centroid of the pop-up, flip-up, or tilt-up component is a second distance from the side of the housing which is closest to the person's wrist, wherein the second distance is 2 mm to 4 cm greater than the first distance; a touch-screen display on a first side of the pop-up, flip-up, or tilt-up component; a first camera on the first side of the pop-up, flip-up, or tilt-up component; and a second camera on a second side of the pop-up, flip-up, or tilt-up component; wherein the pop-up, flip-up, or tilt-up component is automatically popped up, flipped up, or tilted up from its first configuration to its second configuration when the person makes a selected touch or swipe motion on the touch-screen display.

In one embodiment, a smart watch, watch band, or other wrist-worn device with a camera can comprise: a band (or sleeve) which is configured to be worn on a person's wrist; a housing on the band (or sleeve); a pop-up, flip-up, or tilt-up component on the housing with a first configuration in which the centroid of the pop-up, flip-up, or tilt-up component is a first distance from the side of the housing which is closest to the person's wrist and a second configuration in which the centroid of the pop-up, flip-up, or tilt-up component is a second distance from the side of the housing which is closest to the person's wrist, wherein the second distance is 2 mm to 4 cm greater than the first distance; a display on a first side of the pop-up, flip-up, or tilt-up component; a camera on a second side of the pop-up, flip-up, or tilt-up component; and a radar-based motion and/or gesture sensor on the band (or sleeve); wherein the pop-up, flip-up, or tilt-up component is automatically popped up, flipped up, or tilted up from its first configuration to its second configuration when the person makes a selected motion and/or gesture as detected by the radar-based motion and/or gesture sensor. Alternatively, a smart watch, watch band, or other wrist-worn electronic device with a camera can comprise: a band (or sleeve) which is configured to be worn on a person's wrist; a housing on the band (or sleeve); a transparent closed-end cylinder on the housing which extends outward from the person's wrist; and a camera on the housing under the transparent closed-end cylinder, wherein the camera is automatically rotated and/or tilted relative to the housing by an actuator in order to change the camera's focal direction.

In yet another example, a smart watch, watch band, or other wrist-worn device with a camera can comprise: a band (or sleeve) which is configured to be worn on a person's wrist; a housing on the band (or sleeve); a transparent convex component on the housing which extends outward from the person's wrist; and a camera on the housing under the transparent convex component, wherein the camera is automatically rotated and/or tilted relative to the housing by an actuator in order to change the camera's focal direction. In an alternative embodiment, a smart watch, watch band, or other wrist-worn electronic device with an adjustable camera can comprise: a band (or sleeve) which is configured to be worn on a person's wrist; a housing on the band (or sleeve); a transparent convex component on the housing which extends outward from the person's wrist; and a camera on the housing under the transparent convex component, wherein the camera is automatically rotated relative to the housing by an actuator in a plane which is substantially tangential to the circumference of the band (or sleeve) in order to change the camera's focal direction in order to change the camera's focal direction. For example, a smart watch, watch band, or other wrist-worn device with a camera can comprise: a band (or sleeve) which is configured to be worn on a person's wrist; a housing on the band (or sleeve); a transparent dome on the housing which extends outward from the person's wrist; and a camera on the housing under the transparent dome, wherein the camera can be rotated relative to the housing in a plane which is substantially tangential to the circumference of the band (or sleeve) in order to change the camera's focal direction.

In an embodiment of this invention, a smart watch, watch band, or other wrist-worn device with a camera can comprise: a band (or sleeve) which is configured to be worn on a person's wrist; a housing on the band (or sleeve); a transparent portion of a sphere on the housing which extends outward from the person's wrist; and a camera under the transparent portion of a sphere, wherein the camera is rotated and/or tilted relative to the housing in order to change the camera's focal direction. Alternatively, a smart watch, watch band, or other wrist-worn device with a camera can comprise: a band (or sleeve) which is configured to be worn on a person's wrist; a housing on the band (or sleeve); and a camera which can be removed from the housing by unplugging, unsnapping, or uncoupling the camera from the housing, wherein the camera remains connected to the housing by a flexible component (such as a wire, cord, or strap) even when the camera is removed from the housing, wherein the camera is in electronic (wired or wireless) communication with the housing even when it is removed from the housing so that the camera can be used to record images even when the camera is removed from the housing. In another example, a smart watch, watch band, or other wrist-worn device with an adjustable camera can comprise: a band (or sleeve) which is configured to be worn on a person's wrist; a housing on the band (or sleeve); and a camera which can be reversibly detached from the housing by sliding, popping, or pulling the camera out of an opening on a lateral (narrow) side of housing, wherein the camera is in wireless communication with the housing when it is detached from the housing so that the camera can be used to record images even when the camera is detached from the housing.

In yet another example, a smart watch, watch band, or other wrist-worn device with a camera can comprise: a band (or sleeve) which is configured to be worn on a person's wrist; a housing on the dorsal side of the band (or sleeve); a display on a first side of the housing; and a camera on a second side of the housing, wherein the second side is opposite the first side. Alternatively, a smart watch, watch band, or other wrist-worn electronic device with a camera can comprise: a band (or sleeve) which is configured to be worn on a person's wrist; a housing on the dorsal side of the band (or sleeve); a flip-up or pop-up component on the housing; a display on a side of the flip-up or pop-up component; and a camera on the same side of the flip-up or pop-up component as the display. In another example, a smart watch, watch band, or other wrist-worn device with a camera can comprise: a band (or sleeve) which is configured to be worn on a person's wrist; a motion and/or gesture sensor on the band (or sleeve); and a plurality of (outward-facing) cameras which collectively span at least half of the circumference of the band (or sleeve), wherein the person selects which one of the plurality of (outward-facing) cameras to use at a given time by making a movement or gesture.

In one embodiment, a smart watch, watch band, or other wrist-worn electronic device with an adjustable camera can comprise: a band (or sleeve) which is configured to be worn on a person's wrist; a motion and/or gesture sensor on the band (or sleeve); and an (outward-facing) camera with a first configuration in which the camera is at a first location on the band (or sleeve) and a second configuration in which the camera is at a second location on the band (or sleeve), wherein the camera is automatically moved by an actuator from its first configuration to its second configuration based on data from the motion and/or gesture sensor. Alternatively, a smart watch, watch band, or other wrist-worn device with a camera can comprise: a band (or sleeve) which is configured to be worn on a person's wrist; a touch-screen display on the band (or sleeve); and a plurality of (outward-facing) cameras which collectively span at least half of the circumference of the band (or sleeve), wherein the person selects which one of the plurality of (outward-facing) cameras to use at a given time by touching and/or swiping the display. In an alternative embodiment, a smart watch, watch band, or other wrist-worn device with a camera can comprise: a band (or sleeve) which is configured to be worn on a person's wrist; and a camera which can be removed from the band (or sleeve), wherein the camera remains connected to the band (or sleeve) by a flexible component (such as a wire, cord, or strap) even when the camera is removed from the band (or sleeve), wherein the camera is in electronic (wired or wireless) communication with the band (or sleeve) when it is removed from the band (or sleeve) so that the camera can be used to record images even when the camera is removed from the band (or sleeve).

In an example, a smart watch, watch band, or other wrist-worn device with a camera can comprise: a band (or sleeve) which is configured to be worn on a person's wrist; and a plurality of (outward-facing) cameras distributed around at least one quarter of the circumference of the band (or sleeve), wherein angles between the polar coordinate locations of two proximal (e.g. adjacent) cameras are no greater than 45 degrees. Alternatively, a smart watch, watch band, or other wrist-worn device with an adjustable camera can comprise: a band (or sleeve) which is configured to be worn on a person's wrist; and a plurality of (outward-facing) cameras distributed around at least one quarter of the circumference of the person's wrist, wherein angles between the polar coordinate locations of two proximal (e.g. adjacent) cameras are no greater than 30 degrees. In another example, a smart watch, watch band, or other wrist-worn electronic device with a camera can comprise: a band (or sleeve) which is configured to be worn on a person's wrist; and a plurality of (outward-facing) cameras distributed around at least one half of the circumference of the band (or sleeve), wherein angles between the polar coordinate locations of two proximal (e.g. adjacent) cameras are no greater than 15 degrees.

In one embodiment, a smart watch, watch band, or other wrist-worn device with a camera can comprise: a band (or sleeve) which is configured to be worn on a person's wrist; and a plurality of (outward-facing) cameras evenly (e.g. equidistantly) distributed around at least one quarter of the circumference of the band (or sleeve), wherein angles between the polar coordinate locations of two proximal (e.g. adjacent) cameras are no greater than 45 degrees. In an alternative embodiment, a smart watch, watch band, or other wrist-worn electronic device with a camera can comprise: a band (or sleeve) which is configured to be worn on a person's wrist; and a plurality of (outward-facing) cameras evenly (e.g. equidistantly) distributed around at least one quarter of the circumference of the person's wrist, wherein angles between the polar coordinate locations of two proximal (e.g. adjacent) cameras are no greater than 30 degrees. For example, a smart watch, watch band, or other wrist-worn device with an adjustable camera can comprise: a band (or sleeve) which is configured to be worn on a person's wrist; and a plurality of (outward-facing) cameras evenly (e.g. equidistantly) distributed around at least one half of the circumference of the band (or sleeve), wherein angles between the polar coordinate locations of two proximal (e.g. adjacent) cameras are no greater than 15 degrees.

In yet another example, a smart watch, watch band, or other wrist-worn device with a camera can comprise: a band (or sleeve) which is configured to be worn on a person's wrist, wherein the band (or sleeve) further comprises a circumferential array of connectors, ports, or sockets; and a plurality of (outward-facing) cameras which can be selectively and removably attached to connectors, ports, or sockets in the array. Alternatively, a smart watch, watch band, or other wrist-worn device with a camera can comprise: a band (or sleeve) which is configured to be worn on a person's wrist, wherein the band (or sleeve) further comprises an arcuate array of connectors, ports, or sockets which spans at least three-quarters of the circumference of the person's wrist; and a plurality of (outward-facing) cameras which can be selectively and removably attached to connectors, ports, or sockets in the array. In another example, a smart watch, watch band, or other wrist-worn device with a camera can comprise: a band (or sleeve) which is configured to be worn on a person's wrist, wherein the band (or sleeve) further comprises an arcuate array of connectors, ports, or sockets which spans at least half of the circumference of the person's wrist; and a plurality of (outward-facing) cameras which can be selectively detached from and re-attached to connectors, ports, or sockets in the array.

In an embodiment of this invention, a smart watch, watch band, or other wrist-worn electronic device with an adjustable camera can comprise: a band (or sleeve) which is configured to be worn on a person's wrist; and a plurality of (outward-facing) cameras which collectively span at least one quarter of the circumference of the band (or sleeve), wherein the person selects which one of the plurality of (outward-facing) cameras to use at a given time by making a movement or gesture. In an alternative embodiment, a smart watch, watch band, or other wrist-worn device with a camera can comprise: a band (or sleeve) which is configured to be worn on a person's wrist, wherein the band (or sleeve) further comprises a (partial) ring which rotates around at least a portion of the band (or sleeve); and an (outward-facing) camera on the (partial) ring. Alternatively, a smart watch, watch band, or other wrist-worn electronic device with a camera can comprise: a band (or sleeve) which is configured to be worn on a person's wrist; and an (outward-facing) camera on the band (or sleeve), wherein the camera can be moved to different locations on the circumference of band (or sleeve).

In yet another example, a smart watch, watch band, or other wrist-worn device with a camera can comprise: a band (or sleeve) which is configured to be worn on a person's wrist, wherein the band (or sleeve) further comprises a central (partial) ring and two outer (partial) rings, wherein the central (partial) ring is closer to the center of the band (or sleeve) than the two outer (partial) rings, and wherein the central (partial) ring moves circumferentially relative to the two outer (partial) rings; and an (outward-facing) camera on the central (partial) ring. Alternatively, a smart watch, watch band, or other wrist-worn device with an adjustable camera can comprise: a band (or sleeve) which is configured to be worn on a person's wrist, wherein the band (or sleeve) further comprises an inner (partial) ring and an outer (partial) ring, wherein the outer (partial) ring moves circumferentially relative to the inner (partial) ring; and an (outward-facing) camera on the outer (partial) ring. For example, a smart watch, watch band, or other wrist-worn device with a camera can comprise: a band (or sleeve) which is configured to be worn on a person's wrist, wherein the band (or sleeve) further comprises an inner (partial) ring and an outer (partial) ring, wherein the inner (partial) ring is closer to the person's wrist than the outer (partial) ring, and wherein the outer (partial) ring is rotated or slid relative to the inner (partial) ring; and an (outward-facing) camera on the outer (partial) ring.

In an example, a smart watch, watch band, or other wrist-worn electronic device with a camera can comprise: a band (or sleeve) which is configured to be worn on a person's wrist, wherein the band (or sleeve) further comprises a proximal (partial) ring and a distal (partial) ring, wherein the proximal (partial) ring is closer to the person's elbow than the distal (partial) ring, and wherein the proximal (partial) ring is rotated or slid relative to the distal (partial) ring; and an (outward-facing) camera on the proximal (partial) ring. Alternatively, a smart watch, watch band, or other wrist-worn device with a camera can comprise: a band (or sleeve) which is configured to be worn on a person's wrist, wherein the band (or sleeve) further comprises a first portion and a second portion, wherein the second portion moves relative to the first portion; and an (outward-facing) camera on the second portion. In another example, a smart watch, watch band, or other wrist-worn electronic device with an adjustable camera can comprise: a band (or sleeve) which is configured to be worn on a person's wrist, wherein the band (or sleeve) further comprises a circumferential array of connectors, ports, or sockets; and an (outward-facing) camera which can be selectively and removably attached to a connector, port, or socket in the array.

In yet another example, a smart watch, watch band, or other wrist-worn device with a camera can comprise: a band (or sleeve) which is configured to be worn on a person's wrist, wherein the band (or sleeve) further comprises an arcuate array of connectors, ports, or sockets which spans at least three-quarters of the circumference of the person's wrist; and an (outward-facing) camera which can be selectively and removably attached to a connector, port, or socket in the array. In an alternative embodiment, a smart watch, watch band, or other wrist-worn device with an adjustable camera can comprise: a band (or sleeve) which is configured to be worn on a person's wrist, wherein the band (or sleeve) further comprises a circumferential array of connectors, ports, or sockets; and an (outward-facing) camera which can be selectively detached from and re-attached to a connector, port, or socket in the array. For example, a smart watch, watch band, or other wrist-worn device with a camera can comprise: a band (or sleeve) which is configured to be worn on a person's wrist, wherein the band (or sleeve) further comprises an arcuate array of connectors, ports, or sockets which spans at least three-quarters of the circumference of the person's wrist; and an (outward-facing) camera which can be selectively detached from and re-attached to a connector, port, or socket in the array.

In an example, a smart watch, watch band, or other wrist-worn electronic device with an adjustable camera can comprise: a band (or sleeve) which is configured to be worn on a person's wrist, wherein the band (or sleeve) has a track or channel around at least a portion of its circumference; and an (outward-facing) camera which slides circumferentially along the track or channel. Alternatively, a smart watch, watch band, or other wrist-worn device with a camera can comprise: a band (or sleeve) which is configured to be worn on a person's wrist; and an arcuate array of (outward-facing) cameras distributed around (at least a portion of) the circumference of the band (or sleeve), collectively spanning at between 25% and 50% of the circumference of the person's wrist. In an alternative embodiment, a smart watch, watch band, or other wrist-worn electronic device with a camera can comprise: a band (or sleeve) which is configured to be worn on a person's wrist; and an arcuate array of (outward-facing) cameras distributed around (at least a portion of) the circumference of the band (or sleeve), collectively spanning at between 25% and 50% of the circumference of the band (or sleeve).

In an example, a smart watch, watch band, or other wrist-worn device with a camera can comprise: a band (or sleeve) which is configured to be worn on a person's wrist; and an arcuate array of (outward-facing) cameras distributed around (at least a portion of) the circumference of the band (or sleeve), collectively spanning at between 25% and 50% of the circumference of the person's wrist, including the distal lateral side of the person's wrist. In another example, a smart watch, watch band, or other wrist-worn electronic device with a camera can comprise: a band (or sleeve) which is configured to be worn on a person's wrist; and an arcuate array of (outward-facing) cameras distributed around (at least a portion of) the circumference of the band (or sleeve), collectively spanning at between 25% and 50% of the circumference of the band (or sleeve), including the distal lateral side of the band (or sleeve). Alternatively, a smart watch, watch band, or other wrist-worn device with an adjustable camera can comprise: a band (or sleeve) which is configured to be worn on a person's wrist; and an arcuate array of (outward-facing) cameras evenly (e.g. equidistantly) distributed around (at least a portion of) the circumference of the band (or sleeve), collectively spanning at between 25% and 50% of the circumference of the person's wrist.

In one embodiment, a smart watch, watch band, or other wrist-worn device with a camera can comprise: a band (or sleeve) which is configured to be worn on a person's wrist; and an arcuate array of (outward-facing) cameras evenly (e.g. equidistantly) distributed around (at least a portion of) the circumference of the band (or sleeve), collectively spanning at between 25% and 50% of the circumference of the band (or sleeve). In another example, a smart watch, watch band, or other wrist-worn device with an adjustable camera can comprise: a band (or sleeve) which is configured to be worn on a person's wrist; and an arcuate array of (outward-facing) cameras evenly (e.g. equidistantly) distributed around (at least a portion of) the circumference of the band (or sleeve), collectively spanning at between 25% and 50% of the circumference of the person's wrist, including the distal lateral side of the person's wrist. In an alternative embodiment, a smart watch, watch band, or other wrist-worn electronic device with a camera can comprise: a band (or sleeve) which is configured to be worn on a person's wrist; and an arcuate array of (outward-facing) cameras evenly (e.g. equidistantly) distributed around (at least a portion of) the circumference of the band (or sleeve), collectively spanning at between 25% and 50% of the circumference of the band (or sleeve), including the distal lateral side of the band (or sleeve).

In yet another example, a smart watch, watch band, or other wrist-worn device with an adjustable camera can comprise: a band (or sleeve) which is configured to be worn on a person's wrist; and an arcuate array of (outward-facing) cameras evenly distributed around (at least a portion of) the circumference of the band (or sleeve), collectively spanning at between 25% and 100% of the circumference of the band (or sleeve). In another example, a smart watch, watch band, or other wrist-worn electronic device with a camera can comprise: a band (or sleeve) which is configured to be worn on a person's wrist; and an arcuate array of (outward-facing) cameras evenly distributed around (at least a portion of) the circumference of the band (or sleeve), collectively spanning at between 25% and 50% of the circumference of the band (or sleeve). Alternatively, a smart watch, watch band, or other wrist-worn device with a camera can comprise: a band (or sleeve) which is configured to be worn on a person's wrist; and an arcuate array of (outward-facing) cameras evenly distributed around (at least a portion of) the circumference of the band (or sleeve), collectively spanning at between 25% and 75% of the circumference of the band (or sleeve).

In an example, a smart watch, watch band, or other wrist-worn electronic device with a camera can comprise: a band (or sleeve) which is configured to be worn on a person's wrist; and an arcuate array of (outward-facing) cameras evenly distributed around (at least a portion of) the circumference of the band (or sleeve), collectively spanning at least 25% of the circumference of the band (or sleeve), including the distal lateral side of the band (or sleeve). For example, a smart watch, watch band, or other wrist-worn device with a camera can comprise: a band (or sleeve) which is configured to be worn on a person's wrist; and an arcuate array of (outward-facing) cameras which are centered at polar coordinate locations around (at least a portion of) the circumference of the band (or sleeve) and which collectively span at least one quarter of the circumference of the person's wrist. Alternatively, a smart watch, watch band, or other wrist-worn device with an adjustable camera can comprise: a band (or sleeve) which is configured to be worn on a person's wrist; and an arcuate array of (outward-facing) cameras which are centered at compass coordinate locations around (at least a portion of) the circumference of the band (or sleeve) and which collectively span at least half of the circumference of the person's wrist.

In yet another example, a smart watch, watch band, or other wrist-worn device with a camera can comprise: a band (or sleeve) which is configured to be worn on a person's wrist; and an arcuate array of (outward-facing) cameras which are evenly (e.g. equidistantly) distributed around (at least a portion of) the circumference of the band (or sleeve), wherein the arcuate array of (outward-facing) cameras collectively spans at least 25% of the circumference of the person's wrist, wherein a camera in the array is selected by the person to record images at a given time, and wherein the selection of the camera is done by the device recognizing a motion and/or gesture by the person. Alternatively, a smart watch, watch band, or other wrist-worn device with an adjustable camera can comprise: a band (or sleeve) which is configured to be worn on a person's wrist; and eight (outward-facing) cameras which are distributed around (at least a portion of) the circumference of the band (or sleeve) and which collectively span at least 25% of the circumference of the person's wrist. In an alternative embodiment, a smart watch, watch band, or other wrist-worn electronic device with a camera can comprise: a band (or sleeve) which is configured to be worn on a person's wrist; and eight (outward-facing) cameras which are evenly (e.g. equidistantly) distributed around (at least a portion of) the circumference of the band (or sleeve) and which collectively span at least 25% of the circumference of the person's wrist.

In one embodiment, a smart watch, watch band, or other wrist-worn device with an adjustable camera can comprise: a band (or sleeve) which is configured to be worn on a person's wrist; and five (outward-facing) cameras which are distributed around at least half of the circumference of the band (or sleeve). In another example, a smart watch, watch band, or other wrist-worn electronic device with a camera can comprise: a band (or sleeve) which is configured to be worn on a person's wrist; and four (outward-facing) cameras which are distributed around (at least a portion of) the circumference of the band (or sleeve) and which collectively span at least 25% of the circumference of the person's wrist. For example, a smart watch, watch band, or other wrist-worn device with a camera can comprise: a band (or sleeve) which is configured to be worn on a person's wrist; and four (outward-facing) cameras which are evenly (e.g. equidistantly) distributed around (at least a portion of) the circumference of the band (or sleeve) and which collectively span at least 25% of the circumference of the person's wrist.

In yet another example, a smart watch, watch band, or other wrist-worn electronic device with a camera can comprise: a band (or sleeve) which is configured to be worn on a person's wrist; and six (outward-facing) cameras which are distributed around at least half of the circumference of the band (or sleeve). Alternatively, a smart watch, watch band, or other wrist-worn device with an adjustable camera can comprise: a display at the 12 o'clock location around a person's wrist, wherein clock locations around the person's wrist are defined relative to 12 o'clock at the middle of the dorsal side and 6 o'clock at the middle of the ventral side; a first camera at the 6 o'clock location around a person's wrist; and a second camera at the 12 o'clock location around a person's wrist. In another example, a smart watch, watch band, or other wrist-worn device with a camera can comprise: a display at the 12 o'clock location around a person's wrist, wherein clock locations around the person's wrist are defined relative to 12 o'clock at the middle of the dorsal side and 6 o'clock at the middle of the ventral side; and a camera at the 1 o'clock location around a person's wrist.

In an embodiment of this invention, a smart watch, watch band, or other wrist-worn device with an adjustable camera can comprise: a display at the 12 o'clock location around a person's wrist, wherein clock locations around the person's wrist are defined relative to 12 o'clock at the middle of the dorsal side and 6 o'clock at the middle of the ventral side; and a camera at the 6 o'clock location around a person's wrist. In an alternative embodiment, a smart watch, watch band, or other wrist-worn electronic device with a camera can comprise: a display at the 9 o'clock location around a person's wrist, wherein clock locations around the person's wrist are defined relative to 12 o'clock at the middle of the dorsal side and 6 o'clock at the middle of the ventral side; and a camera at the 3 o'clock location around a person's wrist. For example, a smart watch, watch band, or other wrist-worn device with an adjustable camera can comprise: a display which is configured to be worn on a lateral side of a person's wrist; and an (outward-facing) camera which is configured to be worn within a lateral-ventral quadrant of the circumference of the person's wrist.

In an example, a smart watch, watch band, or other wrist-worn electronic device with a camera can comprise: a display which is configured to be worn on a lateral side of a person's wrist; and an (outward-facing) camera which is configured to be worn within a ventral quadrant of the circumference of the person's wrist. Alternatively, a smart watch, watch band, or other wrist-worn device with a camera can comprise: a display which is configured to be worn on a person's wrist; a motion and/or gesture sensor which is configured to be worn on the person's wrist; and an (outward-facing) camera which is configured to be worn on the person's wrist, wherein the camera has first configuration with a first focal distance and a second configuration with a second focal distance, and wherein the camera is automatically changed from its first configuration to its second configuration based on data from the motion and/or gesture sensor. In an alternative embodiment, a smart watch, watch band, or other wrist-worn electronic device with a camera can comprise: a display which is configured to be worn on a person's wrist; and a plurality of (outward-facing) cameras which are configured to be worn on the person's wrist; and wherein the person selects one of the adjustable cameras by making hand and/or finger gestures which are recognized by the device.

In an embodiment of this invention, a smart watch, watch band, or other wrist-worn device with an adjustable camera can comprise: a display which is configured to be worn on a person's wrist; and an outward-facing wide-angle camera which is configured to be worn on the narrow side of the person's wrist or upper arm in a manner similar to wearing a watch or bracelet that has been rotated approximately 90 degrees. Alternatively, a smart watch, watch band, or other wrist-worn device with a camera can comprise: a display which is configured to be worn on the dorsal side of a person's wrist; a first (outward-facing) camera which is configured to be worn on a first lateral side of the person's wrist; and a second (outward-facing) camera which is configured to be worn on a second lateral side of the person's wrist, wherein the second lateral side is opposite the first lateral side. In another example, a smart watch, watch band, or other wrist-worn device with an adjustable camera can comprise: a display which is configured to be worn on the dorsal side of a person's wrist; and an (outward-facing) camera which is configured to be worn within a lateral-dorsal quadrant of the circumference of the person's wrist.

In yet another example, a smart watch, watch band, or other wrist-worn electronic device with a camera can comprise: a display which is configured to be worn on the ventral side of a person's wrist; and an (outward-facing) camera which is configured to be worn within a ventral quadrant of the circumference of the person's wrist. Alternatively, a smart watch, watch band, or other wrist-worn device with an adjustable camera can comprise: a display which is substantially centered on the 12 o'clock location around a person's wrist, wherein clock locations around the person's wrist are defined relative to 12 o'clock at the middle of the dorsal side and 6 o'clock at the middle of the ventral side; a first camera which is substantially centered on the 2 o'clock location around a person's wrist; and a second camera which is substantially centered on the 12 o'clock location around the person's wrist. In another example, a smart watch, watch band, or other wrist-worn electronic device with a camera can comprise: a display which is substantially centered on the 12 o'clock location around a person's wrist, wherein clock locations around the person's wrist are defined relative to 12 o'clock at the middle of the dorsal side and 6 o'clock at the middle of the ventral side; and a camera which is substantially centered on the 3 o'clock location around a person's wrist.

In an example, a smart watch, watch band, or other wrist-worn device with a camera can comprise: a display which is substantially centered on the 9 o'clock location around a person's wrist, wherein clock locations around the person's wrist are defined relative to 12 o'clock at the middle of the dorsal side and 6 o'clock at the middle of the ventral side; a first camera which is substantially centered on the 2 o'clock location around a person's wrist; and a second camera which is substantially centered on the 9 o'clock location around the person's wrist. Alternatively, a smart watch, watch band, or other wrist-worn electronic device with a camera can comprise: a display which is substantially centered on the 9 o'clock location around a person's wrist, wherein clock locations around the person's wrist are defined relative to 12 o'clock at the middle of the dorsal side and 6 o'clock at the middle of the ventral side; and a camera which is substantially centered on the 1 o'clock location around a person's wrist. In another example, a smart watch, watch band, or other wrist-worn device with an adjustable camera can comprise: a first housing of which at least 75% is configured to be worn between the 10 o'clock and 2 o'clock locations around a person's wrist, wherein clock locations around the person's wrist are defined relative to 12 o'clock at the middle of the dorsal side and 6 o'clock at the middle of the ventral side; a second housing of which at least 75% is configured to be worn between 4 o'clock and 8 o'clock locations around a person's wrist; and a camera on the narrow lateral perimeter of the second housing, wherein the display functions as a viewfinder for the camera.

In yet another example, a smart watch, watch band, or other wrist-worn device with a camera can comprise: a first housing which is configured to be worn on the dorsal side of circumference of a person's wrist; a display on the first housing; a second housing which is configured to be worn on a lateral side of the circumference of the person's wrist; and a camera on the second housing. In an alternative embodiment, a smart watch, watch band, or other wrist-worn device with an adjustable camera can comprise: a first housing which is configured to be worn on the dorsal side of a person's wrist; a display on the first housing; a second housing which is configured to be worn on the ventral side of the person's wrist; and a camera on the perimeter of the second housing. For example, a smart watch, watch band, or other wrist-worn electronic device with a camera can comprise: a first housing which is configured to be worn on the dorsal side of a person's wrist; a display on the first housing; a second housing which is configured to be worn on the ventral side of the person's wrist; and a camera on the second housing, wherein the display functions as a viewfinder for the camera.

In one embodiment, a smart watch, watch band, or other wrist-worn device with an adjustable camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing which pops upward and/or outward from the housing; and a camera on the pop-up component. Alternatively, a smart watch, watch band, or other wrist-worn electronic device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing which pops upward and/or outward from the housing; and a camera on the narrow lateral perimeter of the pop-up component. In an alternative embodiment, a smart watch, watch band, or other wrist-worn device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing, wherein the pop-up component has a first configuration in which the pop-up component extends a first distance upward and/or outward from the housing, has a second configuration in which the pop-up component extends a second distance upward and/or outward from the housing, and wherein the second distance is between 1 mm and 4 cm greater than the first distance; and a camera on the side of the pop-up component which is closest to the 2 o'clock location.

In yet another example, a smart watch, watch band, or other wrist-worn electronic device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing, wherein the pop-up component has a first configuration which is recessed within the housing and a second configuration which extends upward and/or outward from the housing; and a camera on the side of the pop-up component which is closest to the 2 o'clock location. Alternatively, a smart watch, watch band, or other wrist-worn device with an adjustable camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing, wherein the pop-up component has a first configuration which is recessed within the housing and a second configuration which extends upward and/or outward from the housing; a display on the proximal side of the pop-up component; and a camera on the distal side of the pop-up component.

In an example, a smart watch, watch band, or other wrist-worn device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a flip-up component which is substantially parallel to the housing in a first configuration and substantially perpendicular to the housing in a second configuration, wherein the flip-up component is changed from its first configuration to its second configuration by pivoting, tilting, and/or rotating an edge of the flip-up component upward and/or outward from the housing; a display on a first side of the flip-up component facing toward the person when the flip-up component is in its second configuration; a first camera on the first side of the flip-up component; and a second camera on a second side of the flip-up component facing away from the person when the flip-up component is in its second configuration.

In one embodiment, a smart watch, watch band, or other wrist-worn device with an adjustable camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a flip-up component which is substantially parallel to the housing in a first configuration and is tilted at an angle between 20 and 120 degrees relative to the housing in a second configuration, wherein the flip-up component is changed from its first configuration to its second configuration by pivoting, tilting, and/or rotating upward and/or outward from the housing; a display on a first side of the flip-up component facing toward the person when the flip-up component is in its second configuration; a first camera on the first side of the flip-up component; and a second camera on a second side of the flip-up component facing away from the person when the flip-up component is in its second configuration. In another example, a smart watch, watch band, or other wrist-worn electronic device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a flip-up component which is substantially parallel to the housing in a first configuration and is tilted at an angle between 20 and 120 degrees relative to the housing in a second configuration, wherein the flip-up component is changed from its first configuration to its second configuration by pivoting, tilting, and/or rotating upward and/or outward from the housing; a display on a first side of the flip-up component; and a camera on a second side of the flip-up component, wherein the second side is opposite the first side.

In an example, a smart watch, watch band, or other wrist-worn device with an adjustable camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a flip-up component which is substantially parallel to the housing in a first configuration and is tilted at an angle between 20 and 120 degrees relative to the housing in a second configuration, wherein the flip-up component is changed from its first configuration to its second configuration by pivoting, tilting, and/or rotating upward and/or outward from the housing; a display on the flip-up component; and a camera on the flip-up component.

In yet another example, a smart watch, watch band, or other wrist-worn electronic device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a flip-up component which is substantially parallel to the housing in a first configuration and is tilted at an angle between 20 and 120 degrees relative to the housing in a second configuration, wherein the flip-up component is changed from its first configuration to its second configuration by pivoting, tilting, and/or rotating upward and/or outward from the housing; a first camera on a first side of the flip-up component; and a second camera on a second side of the flip-up component. In an alternative embodiment, a smart watch, watch band, or other wrist-worn device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a flip-up component which is substantially parallel to the housing in a first configuration and substantially perpendicular to the housing in a second configuration, wherein the flip-up component is changed from its first configuration to its second configuration by pivoting, tilting, and/or rotating the distal edge of the flip-up component upward and/or outward from the housing; and a camera on a side of the flip-up component facing away from the person when the flip-up component is in its second configuration.

In one embodiment, a smart watch, watch band, or other wrist-worn electronic device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a pop-up or lift-up component whose centroid is a first distance from the centroid of the housing in a first configuration and a second distance from the centroid of the housing in a second configuration, wherein the second distance is 1 mm to 4 cm greater than the first distance, and wherein the pop-up or lift-up component is changed from its first configuration to its second configuration by pivoting, tilting, and/or rotating an edge of the pop-up or lift-up component upward and/or outward from the housing; a display on a first side of the pop-up or lift-up component facing toward the person when the pop-up or lift-up component is in its second configuration; and a camera on a second side of the pop-up or lift-up component facing away from the person when the pop-up or lift-up component is in its second configuration.

In yet another example, a smart watch, watch band, or other wrist-worn device with an adjustable camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a pop-up or lift-up component whose centroid is a first distance from the centroid of the housing in a first configuration and a second distance from the centroid of the housing in a second configuration, wherein the second distance is 1 mm to 4 cm greater than the first distance, and wherein the pop-up or lift-up component is changed from its first configuration to its second configuration by moving upward and/or outward from the housing; and a camera on a side of the pop-up or lift-up component facing away from the person when the pop-up or lift-up component is in its second configuration. For example, a smart watch, watch band, or other wrist-worn device with a camera can comprise: a housing of which at least 75% is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a pop-up or lift-up component whose centroid is a first distance from the centroid of the housing in a first configuration and a second distance from the centroid of the housing in a second configuration, wherein the second distance is 1 mm to 4 cm greater than the first distance, and wherein the pop-up or lift-up component is changed from its first configuration to its second configuration by moving upward and/or outward from the housing; and a camera on the pop-up or lift-up component. Alternatively, a smart watch, watch band, or other wrist-worn device with an adjustable camera can comprise: a housing which is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing which pops upward and/or outward from the housing; and a camera on the pop-up component.

In an example, a smart watch, watch band, or other wrist-worn electronic device with a camera can comprise: a housing which is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing which pops upward and/or outward from the housing; and a camera on the narrow lateral perimeter of the pop-up component. Alternatively, a smart watch, watch band, or other wrist-worn device with an adjustable camera can comprise: a housing which is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing, wherein the pop-up component has a first configuration in which the pop-up component extends a first distance upward and/or outward from the housing, has a second configuration in which the pop-up component extends a second distance upward and/or outward from the housing, and wherein the second distance is between 1 mm and 4 cm greater than the first distance; and a camera on the side of the pop-up component which is closest to the 2 o'clock location. In another example, a smart watch, watch band, or other wrist-worn electronic device with a camera can comprise: a housing which is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing, wherein the pop-up component has a first configuration which is recessed within the housing and a second configuration which extends upward and/or outward from the housing; and a camera on the side of the pop-up component which is closest to the 2 o'clock location.

In an example, a smart watch, watch band, or other wrist-worn device with a camera can comprise: a housing which is configured to be worn between 10 o'clock and 2 o'clock locations around a person's wrist, wherein clock locations around the person's wrist are defined relative to 12 o'clock at the middle of the dorsal side and 6 o'clock at the middle of the ventral side; a display on the housing; a pop-up component on the housing, wherein the pop-up component has a first configuration which is recessed within the housing and a second configuration which extends upward and/or outward from the housing; a display on the proximal side of the pop-up component; and a camera on the distal side of the pop-up component. Alternatively, a smart watch, watch band, or other wrist-worn electronic device with a camera can comprise: a housing which is configured to be worn on a person's wrist; a display on the housing; a motion and/or gesture sensor (e.g. accelerometer and/or gyroscope) in the housing; and a camera which is configured to be worn on a person's wrist, wherein the camera is automatically moved based on data from the motion and/or gesture sensor so as to maintain a constant focal direction relative to the environment. For example, a smart watch, watch band, or other wrist-worn device with an adjustable camera can comprise: a housing which is configured to be worn on a person's wrist; a display on the housing; and a camera on the housing, wherein the camera is automatically moved relative to the housing in order to scan areas near the person.

In an embodiment of this invention, a smart watch, watch band, or other wrist-worn device with a camera can comprise: a housing which is configured to be worn on a person's wrist; a flip-up component on the housing, wherein the flip-up component is substantially parallel to the housing in a first configuration and is tilted relative to the housing in a second configuration, wherein the flip-up component is changed from its first configuration to its second configuration by pivoting, tilting, and/or rotating upward and/or outward from the housing; a display on the flip-up component; and a camera on the flip-up component. In an alternative embodiment, a smart watch, watch band, or other wrist-worn device with an adjustable camera can comprise: a housing which is configured to be worn on a person's wrist; a flip-up component on the housing, wherein the virtual plane which best fits the flip-up component intersects the housing at a first angle in a first configuration, intersects the housing at a second angle in a second configuration, wherein the second angle is 20 to 120 degrees greater than the first angle, and wherein the flip-up component is automatically changed from its first configuration to its second configuration by being pivoted, tilted, and/or rotated outward from the housing by a spring; a display on the flip-up component; and a camera on the flip-up component. Alternatively, a smart watch, watch band, or other wrist-worn electronic device with a camera can comprise: a housing which is configured to be worn on a person's wrist; a flip-up component on the housing, wherein the virtual plane which best fits the flip-up component intersects the housing at a first angle in a first configuration, intersects the housing at a second angle in a second configuration, wherein the second angle is 20 to 120 degrees greater than the first angle, and wherein the flip-up component is changed from its first configuration to its second configuration by pivoting, tilting, and/or rotating upward and/or outward from the housing; and a camera on the flip-up component.

In yet another example, a smart watch, watch band, or other wrist-worn device with an adjustable camera can comprise: a housing which is configured to be worn on a person's wrist; a flip-up component which is substantially parallel to the housing in a first configuration and substantially perpendicular to the housing in a second configuration, wherein the flip-up component is changed from its first configuration to its second configuration by pivoting, tilting, and/or rotating upward and/or outward from the housing; and a camera on the flip-up component. In another example, a smart watch, watch band, or other wrist-worn electronic device with a camera can comprise: a housing which is configured to be worn on a person's wrist; a flip-up component, wherein a portion of the flip-up component pivots, tilts, and/or rotates around an axis in an upward and/or outward manner from the housing; a display on the flip-up component; and a camera on the flip-up component. In an alternative embodiment, a smart watch, watch band, or other wrist-worn device with a camera can comprise: a housing which is configured to be worn on a person's wrist; a flip-up component, wherein a portion of the flip-up component pivots, tilts, and/or rotates on a flexible and/or elastic strip in an upward and/or outward manner from the housing; a display on the flip-up component; and a camera on the flip-up component.

In one embodiment, a smart watch, watch band, or other wrist-worn electronic device with a camera can comprise: a housing which is configured to be worn on a person's wrist; a motion and/or gesture sensor (e.g. accelerometer and/or gyroscope) which is configured to be worn on the person's wrist; and a camera which is configured to be worn on a person's wrist, wherein the focal direction of the camera is automatically moved based on data from the motion and/or gesture sensor. For example, a smart watch, watch band, or other wrist-worn device with an adjustable camera can comprise: a housing which is configured to be worn on a person's wrist; a pop-up component which is substantially flush with or recessed within the housing in a first configuration and extends outward from the housing in a second configuration, wherein the pop-up component is automatically changed from its first configuration to its second configuration when the person makes a (hand or finger) gesture; a display on the pop-up component; and a camera on the pop-up component. Alternatively, a smart watch, watch band, or other wrist-worn device with a camera can comprise: a housing which is configured to be worn on a person's wrist; a pop-up or lift-up component on the housing, wherein the centroid of the pop-up or lift-up component is a first distance from the housing in a first configuration, the centroid of the pop-up or lift-up component is a second distance from the housing in a second configuration, and the second distance is greater than the first distance; wherein the pop-up or lift-up component has a wide outer surface which faces away from the person's wrist, a wide inner surface which faces toward the person's wrist, and a lateral perimeter between the outer surface and the inner surface when the pop-up or lift-up component is in its first configuration; wherein the pop-up or lift-up component changes from its first configuration to its second configuration by moving upward and/or outward from the housing; a display on the wide outer surface of the pop-up or lift-up component; and a camera on the lateral perimeter of the pop-up or lift-up component.

In an example, a smart watch, watch band, or other wrist-worn device with an adjustable camera can comprise: a housing which is configured to be worn on a person's wrist; a pop-up or lift-up component on the housing, wherein the centroid of the pop-up or lift-up component is a first distance from the housing in a first configuration, the centroid of the pop-up or lift-up component is a second distance from the housing in a second configuration, and the second distance is greater than the first distance; wherein the pop-up or lift-up component has a wide outer surface which faces away from the person's wrist, a wide inner surface which faces toward the person's wrist, and a lateral perimeter between the outer surface and the inner surface when the pop-up or lift-up component is in its first configuration; wherein the pop-up or lift-up component changes from its first configuration to its second configuration by moving upward and/or outward from the housing; and a camera on the lateral perimeter of the pop-up or lift-up component. In another example, a smart watch, watch band, or other wrist-worn electronic device with a camera can comprise: a housing which is configured to be worn on a person's wrist; a pop-up or lift-up component whose centroid is a first distance from the centroid of the housing in a first configuration and a second distance from the centroid of the housing in a second configuration, wherein the second distance is 1 mm to 4 cm greater than the first distance, and wherein the pop-up or lift-up component is changed from its first configuration to its second configuration by moving upward and/or outward from the housing; and a camera on the pop-up or lift-up component.

In one embodiment, a smart watch, watch band, or other wrist-worn device with a camera can comprise: a housing which is configured to be worn on a person's wrist; and a camera on the housing, wherein the focal direction of the camera is automatically moved relative to the housing in order to scan areas near the person. In an alternative embodiment, a smart watch, watch band, or other wrist-worn electronic device with a camera can comprise: a housing which is configured to be worn on the dorsal side of a person's wrist; a flip-up component which is substantially parallel to the housing in a first configuration and substantially perpendicular to the housing in a second configuration, wherein the flip-up component is changed from its first configuration to its second configuration by pivoting, tilting, and/or rotating upward and/or outward from the housing; a display on a side the flip-up component; and a camera on an edge of the flip-up component, wherein the edge of the flip-up component is substantially perpendicular to the side of the flip-up component. Alternatively, a smart watch, watch band, or other wrist-worn device with an adjustable camera can comprise: a housing which is configured to be worn on the dorsal side of a person's wrist; a flip-up component which is substantially parallel to the housing in a first configuration and is tilted at an angle between 20 and 120 degrees relative to the housing in a second configuration, wherein the flip-up component is changed from its first configuration to its second configuration by pivoting, tilting, and/or rotating upward and/or outward from the housing; a display on the flip-up component; and a camera on the flip-up component.

In yet another example, a smart watch, watch band, or other wrist-worn electronic device with a camera can comprise: a housing which is configured to be worn on the dorsal side of a person's wrist; a flip-up component which is substantially parallel to the housing in a first configuration and is tilted at an angle between 20 and 120 degrees relative to the housing in a second configuration, wherein the flip-up component is changed from its first configuration to its second configuration by pivoting, tilting, and/or rotating upward and/or outward from the housing; and a camera on a side of the flip-up component. In another example, a smart watch, watch band, or other wrist-worn device with an adjustable camera can comprise: a housing which is configured to be worn on the dorsal side of a person's wrist; a flip-up component which is substantially parallel to the housing in a first configuration and substantially perpendicular to the housing in a second configuration, wherein the flip-up component is changed from its first configuration to its second configuration by pivoting, tilting, and/or rotating upward and/or outward from the housing; and a camera on the flip-up component. Alternatively, a smart watch, watch band, or other wrist-worn electronic device with a camera can comprise: a housing which is configured to be worn on the dorsal side of a person's wrist; a pop-up or lift-up component whose centroid is a first distance from the centroid of the housing in a first configuration and a second distance from the centroid of the housing in a second configuration, wherein the second distance is 1 mm to 4 cm greater than the first distance, and wherein the pop-up or lift-up component is changed from its first configuration to its second configuration by moving upward and/or outward from the housing; and a camera on the pop-up or lift-up component.

In an embodiment of this invention, a smart watch, watch band, or other wrist-worn device with a camera can comprise: a housing which is configured to be worn on the ventral side of a person's wrist; a flip-up component which is substantially parallel to the housing in a first configuration and substantially perpendicular to the housing in a second configuration, wherein the flip-up component is changed from its first configuration to its second configuration by pivoting, tilting, and/or rotating upward and/or outward from the housing; and a camera on the flip-up component. In another example, a smart watch, watch band, or other wrist-worn electronic device with an adjustable camera can comprise: a housing which is configured to be worn on the ventral side of a person's wrist; a rotating ring around the perimeter of the housing; and a camera on the ring, wherein the focal direction of the camera is changed as the ring rotates. Alternatively, a smart watch, watch band, or other wrist-worn device with a camera can comprise: a housing which is configured to be worn on the ventral side of a person's wrist; and a camera at the 6 o'clock position on the perimeter of the housing, wherein clock locations around the perimeter of the housing are defined relative to 3 o'clock being closest to the person's middle finger and 9 o'clock being closest to the person's elbow.

In yet another example, a smart watch, watch band, or other wrist-worn device with an adjustable camera can comprise: a housing with a display which is configured to be on a person's wrist; and an (outward-facing) camera within the 1-2 o'clock positions on the perimeter of the housing, wherein clock locations around the perimeter of the housing are defined relative to 3 o'clock being closest to the person's middle finger and 9 o'clock being closest to the person's elbow. In an alternative embodiment, a smart watch, watch band, or other wrist-worn device with a camera can comprise: a housing with a display which is configured to be worn on a person's wrist; and an (outward-facing) camera on a side of the housing. For example, a smart watch, watch band, or other wrist-worn device with a camera can comprise: a touch-screen display which is configured to be worn on a person's wrist; and a plurality of (outward-facing) cameras which are configured to be worn on the person's wrist; and wherein the person selects one of the adjustable cameras for imaging.

In one embodiment, a smart watch, watch band, or other wrist-worn device with an adjustable camera can comprise: a watch and/or wrist band (or sleeve) which is worn on a person's wrist; a display on the band (or sleeve); and two opposite-facing cameras on the band (or sleeve). Alternatively, a smart watch, watch band, or other wrist-worn device with a camera can comprise: a wedge-shaped housing which is configured to be worn on the dorsal side of a person's wrist; a display on a first side of the wedge-shaped housing; and a camera on a second side of the wedge-shaped housing. In another example, a smart watch, watch band, or other wrist-worn device with an adjustable camera can comprise: an (outward-facing) camera which is configured to be worn on a person's wrist; a display which is configured to be worn on the person's wrist; and a wearable sensor worn on the person's wrist which is selected from the group consisting of accelerometer, inclinometer, motion and/or gesture sensor, sound sensor, smell sensor, blood pressure sensor, heart rate sensor, EEG sensor, ECG sensor, EMG sensor, electrochemical sensor, gastric activity sensor, GPS sensor, location sensor, image sensor, optical sensor, piezoelectric sensor, respiration sensor, strain gauge, electrogoniometer, chewing sensor, swallow sensor, temperature sensor, and pressure sensor; wherein the camera is automatically activated to take pictures based on data from the wearable sensor.

In yet another example, a smart watch, watch band, or other wrist-worn device with a camera can comprise: an (outward-facing) camera which is configured to be worn on a person's wrist, wherein images captured by the camera are analyzed by gesture recognition or identification; and a display which is configured to be worn on the person's wrist. In an alternative embodiment, a smart watch, watch band, or other wrist-worn device with a camera can comprise: an (outward-facing) camera which is configured to be worn within the 4-5 o'clock locations around a person's wrist; a display which is configured to be worn at the 6 o'clock location on the circumference of a person's wrist; wherein clock locations around the person's wrist are defined relative to 12 o'clock at the middle of the dorsal side and 6 o'clock at the middle of the ventral side. In another example, a smart watch, watch band, or other wrist-worn device with a camera can comprise: an (outward-facing) camera which is configured to be worn within distal lateral-ventral quadrant locations on the circumference of a person's wrist; a display which is configured to be worn within proximal dorsal-lateral quadrant locations on the circumference of a person's wrist.

In an example, a smart watch, watch band, or other wrist-worn device with a camera can comprise: an (outward-facing) camera which is configured to be worn within the 4-5 o'clock locations around a person's wrist; a display which is configured to be worn within the 10-11 o'clock locations around a person's wrist; wherein clock locations around the person's wrist are defined relative to 12 o'clock at the middle of the dorsal side and 6 o'clock at the middle of the ventral side. Alternatively, a smart watch, watch band, or other wrist-worn device with a camera can comprise: an outward-facing wide-angle camera which is configured to be worn on the anterior (e.g. ventral) surface of a person's wrist or upper arm in a manner similar to wearing a watch or bracelet with a housing that has been rotated approximately 180 degrees around the circumference of the person's wrist. In another example, a smart watch, watch band, or other wrist-worn device with a camera can comprise: two cameras attached to a wrist band (or sleeve) on opposite (narrow) sides of the person's wrist; and a display which is configured to be worn on the person's wrist, wherein the display can selectively act as a view finder for one or both of the cameras. In an alternative embodiment, a smart watch, watch band, or other wrist-worn device with a camera can comprise: two cameras which are configured to be worn on the narrow sides of a person's wrist, between the dorsal and ventral surfaces of the wrist; and a display which is configured to be worn on the person's wrist.

I claim:

1. A smart watch, watch band, or other wrist-worn device with a camera comprising:
a display which is centered on the 12 o'clock location on a person's wrist, wherein clock locations around the person's wrist are defined relative to 12 o'clock being at the middle of the dorsal side and 6 o'clock being at the middle of the ventral side as viewed in a finger-to-elbow direction; and
an outward-facing camera on a location other than the 12 o'clock location.

2. The smart watch, watch band, or other wrist-worn device in claim 1 wherein the camera is between the 2 o'clock and 4 o'clock locations on the person's wrist.

3. The smart watch, watch band, or other wrist-worn device in claim 1 wherein the camera is centered on the 3 o'clock location on a person's wrist.

4. The smart watch, watch band, or other wrist-worn device in claim 1 wherein the camera is between the 5 o'clock and 7 o'clock locations on the person's wrist.

5. The smart watch, watch band, or other wrist-worn device in claim 1 wherein the camera is centered on the 6 o'clock location on a person's wrist.

6. A smart watch, watch band, or other wrist-worn device with a camera comprising:
a display which is configured to be worn on a person's wrist;
a band which is configured to be worn on the person's wrist; and
an arcuate array of cameras which are distributed around at least a portion of a circumference of the band, wherein the arcuate array of cameras collectively spans at least 25% of the circumference of the person's wrist, and wherein a selected camera in the array is selected by the person to record images at a given time.

7. The smart watch, watch band, or other wrist-worn device in claim 6 wherein the arcuate array of cameras is a circumferential or semi-circumferential array of cameras around the circumference of the band.

8. The smart watch, watch band, or other wrist-worn device in claim 6 wherein cameras are located at different locations around the circumference of the band.

9. The smart watch, watch band, or other wrist-worn device in claim 6 wherein the device further comprises a motion sensor and wherein selection of a camera is done by the person moving the band which is detected by the motion sensor.

10. The smart watch, watch band, or other wrist-worn device in claim 6 wherein the device further comprises a gesture sensor and wherein selection of a camera is done by the person making a gesture which is detected by the gesture sensor.

11. The smart watch, watch band, or other wrist-worn device in claim 6 wherein the device further comprises a touch screen and wherein selection of a camera is done by the person touching and/or swiping the touch screen.

12. The smart watch, watch band, or other wrist-worn device in claim 6 wherein the device further comprises a ring or bezel and wherein selection of a camera is done by the person rotating the ring or bezel.

13. The smart watch, watch band, or other wrist-worn device in claim 6 wherein the arcuate array of cameras further comprises at least three cameras at three different locations, respectively, around the circumference of the band.

14. The smart watch, watch band, or other wrist-worn device in claim 6 wherein the cameras are evenly distributed around at least a portion of the circumference of the band.

15. A smart watch, watch band, or other wrist-worn device with a camera comprising:
a display which is configured to be worn on a person's wrist;
a band which is configured to be worn on the person's wrist; and
a camera which is moved around at least a portion of the circumference of the band in order to capture images from different angles.

16. The smart watch, watch band, or other wrist-worn device in claim 15 wherein the camera can be moved around at least 25% of the circumference of the band.

17. The smart watch, watch band, or other wrist-worn device in claim 15 wherein the camera can be moved around at least 50% of the circumference of the band.

18. The smart watch, watch band, or other wrist-worn device in claim 15 wherein the device further comprises an actuator which automatically moves the camera around the band.

19. The smart watch, watch band, or other wrist-worn device in claim 15 wherein the device further comprises a ring which rotates around at least a portion of the circumference of the band and wherein the camera is on the ring.

20. The smart watch, watch band, or other wrist-worn device in claim 15 wherein the device further comprises a track or channel around at least a portion of the circumference of the band and wherein the camera is moved along the track or channel.
